(19) United States
(12) Patent Application Publication
(10) Pub. No.: US 2024/0386442 A1
(43) Pub. Date: Nov. 21, 2024

(54) APPARATUS, ARTICLES OF MANUFACTURE, AND METHODS FOR DATA COLLECTION BALANCING FOR SUSTAINABLE STORAGE

(71) Applicant: Intel Corporation, Santa Clara, CA (US)

(72) Inventors: Stanley MO, Portland, OR (US); Hassnaa MOUSTAFA, San Jose, CA (US); Rita WOUHAYBI, Portland, OR (US); Eve SCHOOLER, Portola Valley, CA (US); Asaad SAID, Chandler, AZ (US)

(21) Appl. No.: 18/571,149

(22) PCT Filed: Apr. 1, 2022
(86) PCT No.: PCT/US2022/023107

§ 371 Date: Dec. 15, 2023

Related U.S. Application Data
(60) Provisional application No. 63/248,312, filed on Sep. 24, 2021.

(51) Int. Cl. G06Q 30/018; G06F 16/215; G06F 16/23

(52) U.S. Cl. CPC G06Q 30/018; G06F 16/215; G06F 16/2365

(57) ABSTRACT

Methods, apparatus, systems, and articles of manufacture are disclosed for data collection balancing for sustainable storage. An example apparatus includes at least one memory, machine executable instructions, and processor circuitry to at least one of execute or instantiate the machine executable instructions to orchestrate resources in an edge environment based on data ingested from a data source, execute a machine learning model based on the data to generate outputs, the outputs including at least one of a first value representative of data criticality or a second value representative of data quality of the data, reduce resource requirements associated with the resources of the edge environment based on the outputs to effectuate green data management of the edge environment, and cause an operation at a node of the edge environment based on at least one of the data or the outputs, the node associated with the data.

### RELATED APPLICATION

This patent claims the benefit of U.S. Provisional Patent Application No. 63/248,312, which was filed on Sep. 24, 2021. U.S. Provisional Patent Application No. 63/248,312 is hereby incorporated herein by reference in its entirety. Priority to U.S. Provisional Patent Application No. 63/248,312 is hereby claimed.

### FIELD OF THE DISCLOSURE

This disclosure relates generally to data management and, more particularly, to apparatus, articles of manufacture, and methods for data collection balancing for sustainable storage.

### BACKGROUND

Data management systems gather data and/or otherwise monitor many different complex activities and processes. The gathering of sufficient and relevant data to verify that a specific activity, tool, or task is performing as expected (or identifying a problem with the activity, tool, or task) can be intensive. As analytics efforts within data management systems increase, the need to quickly determine whether to process and/or store data associated with complex actions or processes will increase as well.

### BRIEF DESCRIPTION OF THE DRAWINGS

FIG. 1 illustrates an overview of an Edge cloud configuration for Edge computing.

FIG. 2 illustrates operational layers among endpoints, an Edge cloud, and cloud computing environments.

FIG. 3 illustrates an example approach for networking and services in an Edge computing system.

FIG. 4 illustrates deployment of a virtual Edge configuration in an Edge computing system operated among multiple Edge nodes and multiple tenants.

FIG. 5 is a schematic diagram of an example infrastructure processing unit (IPU).

FIG. 6 is a block diagram of an example adaptive data management (ADM) system to implement adaptive data management in a network environment.

FIG. 7 is a flowchart representative of example machine readable instructions and/or example operations that may be executed and/or instantiated by processor circuitry to generate an example recommendation to integrate a hardware, software, and/or firmware feature in a semiconductor-based device (e.g., a silicon-based device).

FIG. 8 is an illustration of an example edge network environment including an example edge gateway and an example edge switch that may implement the example ADM system of FIG. 6.

FIG. 9 is a block diagram of a portion of the example ADM system of FIG. 6 to implement examples disclosed herein.

FIG. 10 is a block diagram of example sustainable storage circuitry to implement examples disclosed herein.

FIG. 11 is an illustration of a first example graph model and a second example graph model for depicting groups of related data and metadata connected linked via strength vectors.

FIG. 12 is an illustration of a first example system to identify optimal network routing paths.

FIG. 13 is an illustration of a second example system to effectuate contextual optimized data locality.

FIG. 14 is a flowchart representative of example machine readable instructions and/or example operations that may be executed by example processor circuitry to implement the example sustainable storage circuitry of FIG. 10 to implement an example data assessment and learning phase at an example processing node.

FIG. 15 is a flowchart representative of example machine readable instructions and/or example operations that may be executed by example processor circuitry to implement the example sustainable storage circuitry of FIG. 10 to implement a first and second example data assessment and learning phase at an example processing node.

FIG. 16 is a flowchart representative of example machine readable instructions and/or example operations that may be executed by example processor circuitry to implement the example sustainable storage circuitry of FIG. 10 to effectuate data collection balancing for sustainable storage.

FIG. 17 is a flowchart representative of example machine readable instructions and/or example operations that may be executed by example processor circuitry to implement the example sustainable storage circuitry of FIG. 10 to ingest data from a data source.

FIG. 18 is a flowchart representative of example machine readable instructions and/or example operations that may be executed by example processor circuitry to implement the example sustainable storage circuitry of FIG. 10 to orchestrate resources in an edge environment based on data.

FIG. 19 is a flowchart representative of example machine readable instructions and/or example operations that may be executed by example processor circuitry to implement the example sustainable storage circuitry of FIG. 10 to execute a machine learning model with resources to generate outputs including at least one of a first value representative of data criticality or a second value representative of data quality of the data.

FIG. 20 is a flowchart representative of example machine readable instructions and/or example operations that may be executed by example processor circuitry to implement the example sustainable storage circuitry of FIG. 10 to execute a machine learning model to generate outputs representative of data criticality and data quality.

FIG. 21 is a flowchart representative of example machine readable instructions and/or example operations that may be executed by example processor circuitry to implement the example sustainable storage circuitry of FIG. 10 to determine a value of data criticality based on at least one of training data or ingested data.

FIG. 22 is a flowchart representative of example machine readable instructions and/or example operations that may be executed by example processor circuitry to implement the example sustainable storage circuitry of FIG. 10 to determine a value of data quality based on at least one of training data or ingested data.

FIG. 23 is a flowchart representative of example machine readable instructions and/or example operations that may be executed by example processor circuitry to implement the example sustainable storage circuitry of FIG. 10 to reduce resource requirements of an edge environment to effectuate green data management based on outputs.

FIG. 24 is a flowchart representative of example machine readable instructions and/or example operations that may be executed by example processor circuitry to implement the example sustainable storage circuitry of FIG. 10 to cause operation(s) at node(s) of an edge environment based on data.

FIG. 25 is a block diagram of an example processing platform including processor circuitry structured to execute the example machine readable instructions and/or the example operations of FIGS. 7 and/or 14-24 to implement the example ADM system of FIG. 6.

FIG. 26 is a block diagram of an example processing platform including processor circuitry structured to execute the example machine readable instructions and/or the example operations of FIGS. 7 and/or 14-24 to implement the example sustainable storage circuitry of FIG. 10.

FIG. 27 is a block diagram of an example implementation of the processor circuitry of FIGS. 25 and/or 26.

FIG. 28 is a block diagram of another example implementation of the processor circuitry of FIGS. 25 and/or 26.

FIG. 29 is a block diagram of an example software distribution platform (e.g., one or more servers) to distribute software (e.g., software corresponding to the example machine readable instructions of FIGS. 7 and/or 14-24) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more artificial intelligence hardware accelerators, one or more DSPs, etc., and/or a combination thereof) and application programming interface(s) (API(s)) that may assign computing task(s) to whichever one(s) of the multiple types of the processing circuitry is/are best suited to execute the computing task(s).

Network environments today have many different complex activities and processes, and the gathering of sufficient and relevant data to verify that a specific activity, tool, or task is performing as expected (or identifying a problem with the activity, tool, or task) can be intensive. As edge analytics efforts increase, the need to quickly verify the state and/or sequence of complex actions or processes will increase as well. This will enable faster and more effective decisions and actions an organization can make in their complex environments.

By some estimates, 175 zettabytes (ZB) (or 175 trillion gigabytes) of data will be generated around the globe by 2025. More than 50% of this data will be generated at edge devices (e.g., approximately 90 ZB). This is a significant data size to be uploaded to the cloud. Such an upload presents many challenges that may require network reliability with higher bandwidth and lower latency. Resources (e.g., compute, storage, network, etc., resources) and their corresponding power consumption is detrimental to the environment and a reduction in such resources may be desired. In some example applications, latency is an important Quality-of-Service (QOS) consideration/parameter that may require real-time performance. Some such applications may include autonomous driving cars, surgical robots, factory automation, live events (e.g., media broadcasting, education classes, business meetings, etc.), and the like. Some such applications may place many demands on the network by nodes and data traffic or constraints in the network latency and bandwidth itself. In some examples, data generated by Internet-of-Things (IoT) edge devices and autonomous driving cars may create network congestions that impact the overall grid and accessing data.

In some examples, data criticality and data quality of retained data is important for the efficacy and/or the higher accuracy of the resulting insights of any data analytics platform. For example, data criticality of data may refer to a measure of importance, significance, and/or value of the data (or portion(s) thereof) to achieve a desired result or output. In some examples, data quality of data may refer to a measure of completeness and/or comprehensiveness of the data (or portion(s) thereof) from which a desired result or output may be achieved. In some examples, data quality of data may refer to a measure of how well the data comports with intentions of a policy to achieve green goals of reduced environment impact.

In some examples, a measure of data criticality for data can be based on at least one of a potential consequence or concern (e.g., a consequence or concern of violation of a regulatory requirement, occurrence of adverse or undesirable events, increase in environment impacts, etc., and/or any combination(s) thereof) if the data is not processed or stored, a latency requirement associated with the data, a number of nodes in the edge environment that are associated with the data, a purpose of a workload associated with the data, a size of the workload, a priority of the data, a size (e.g., a data size) of the workload that needs or requests storage, or a regulatory requirement associated with the data. In some examples, data criticality of data may refer to a measure of how important the data is to satisfy intentions of a policy to achieve green goals of reduced environment impact.

In some examples, a measure of data quality for data can be based on at least one of an accuracy of the data, a completeness of the data, a consistency of the data, a currency of the data, a redundancy of the data in the edge environment, a timeliness of the data, or a validity of the data. In some examples, determinations of the data criticality and/or the data quality can be utilized for data collection balancing for sustainable storage.

Example proactive data management and analytics systems and/or adaptive data management (ADM) techniques disclosed herein may monitor data traffic (e.g., size, bandwidth, latency, etc.) across different nodes, and then highlight or otherwise identify the congested nodes. For example, management may refer to causing a result to occur to achieve a desired goal, target, or objective. In some examples, management may be implemented by information in any form that may be ingested, processed, interpreted and/or otherwise manipulated by processor circuitry to produce a result. The produced result may itself be data. For example, management may itself be data that is representative of an action, activity, operation, etc., to be carried out at one or more nodes.

In some examples, data management (e.g., adaptive data management, data traffic management, etc.) may refer to decision making that achieves a goal, objective, or target. In some examples, the decision making can be an output (e.g., a data output, a numerical output, a dimensionless output, etc.) of a computing task or workload. For example, the output can be data that, when generated, may affect (e.g., directly affect) a node that generated the data. In some examples, the node that generated the data may be affected by being invoked to carry out and/or execute an activity, action, operation, etc., based on the generated data. For example, a node implemented by an electronic control unit (ECU) in a vehicle may generate an output representative of a decision for the vehicle to change lanes on a highway, and the output may be generated based on vehicle data (e.g., speed data, position or location data of the vehicle, position or location data of surrounding vehicle(s), etc.) associated with the vehicle. In some examples, the node implemented by the ECU may perform data management by generating the output based on ingested data (e.g., the vehicle data) to cause (e.g., directly cause) the vehicle to carry out and/or execute an operation in connection with the vehicle.

In some examples, the output can be data that, when generated, may affect (e.g., indirectly affect) a different node than the node that generated the node. For example, a first node performing data management may generate an output (e.g., a decision, a determination, etc.) based on ingested data and transmit the output to a second node to cause the second node to be affected. In some examples, the second node may be affected by being invoked to carry out and/or execute an activity, action, operation, etc., based on the received output. By way of example, the first node may be implemented by a first ECU in a first vehicle and the second node may be implemented by a second ECU in a second vehicle. The first node may generate an output representative of a decision for the first vehicle to change a speed of the first vehicle, and the output may be generated based on first vehicle data (e.g., speed data of the first vehicle, position or location data of the first vehicle, position or location data of the second vehicle, etc.) associated with the first vehicle. The first node may transmit the output to the second node to cause the second vehicle to carry out an operation, such as change lanes to avoid the first vehicle, change speed in response to the change in speed of the first vehicle, etc. The first node implemented by the first ECU may perform data management by generating the output based on ingested data (e.g., the vehicle data of the first vehicle) to cause (e.g., indirectly cause) the second vehicle to carry out and/or execute an operation.

In some examples, an example ADM system as disclosed herein may process data locally at the edges/nodes where things happened, then send the relevant data to a server, data center, etc., for further usage. In some examples, the ADM system as disclosed herein may implement load balancing based on at least one of data criticality or priority. In some examples, the ADM system may implement a “sink node” model, schema, technique, etc., where one(s) of the nodes can have a “logical sync node” receiving the data and decide what to do with it, whether to communicate to the external world, upload somewhere, keep locally, or do not keep at all. Example use-cases that may benefit from the concept of “smart data traffic” as disclosed herein may include traffic management in roads, identification of road hazards and accidents, anomaly detection in data, etc.

In some disclosed examples, the ADM system may carry out data analysis and balancing to prevent data excess and overload of storage systems. In some examples, the ADM system may utilize Artificial Intelligence/Machine Learning (AI/ML) modeling techniques and/or data graph techniques to map, associate, and/or otherwise correlate relevant datasets to one another. For example, continued access to data may strengthen certain links and chains associated with the data. In some examples, not as useful or infrequently accessed data may be discarded, deleted, isolated, and/or archived.

In some disclosed examples, the ADM system may utilize AI/ML techniques to learn data quality/data criticality on captured or ingested data for an observation period and tie with location and objects types for improved correlation determinations. In some examples, the ADM system may evaluate (e.g., continuously evaluate) data to establish a ground truth (e.g., a normalcy, a baseline pattern, etc.) over time for use in subsequent comparisons for anomaly or deviation detection. For example, the ADM system may utilize the ground truth to determine whether an event is a periodic normalcy (e.g., a cyclic event) or an aberration that requires attention.

In some disclosed examples, the ADM system may identify areas and objects of interest during the learning phase of the AI/ML approaches as disclosed herein. In some examples, the ADM system may utilize symbolic representation of events/objects to reduce storage size, establish ground truth(s) of fixed objects, and/or focus only on transient objects or events. For example, the ADM system may replace data, such as sensor or video data (or portion(s) thereof), with placeholder data, filler data, etc., that may be indicative of the sensor or video data (or portion(s) thereof) as having been ingested, stored, processed, and/or utilized.

In some disclosed examples, the ADM system may identify and/or remove duplicate or uninteresting data, retain and focus (e.g., increase attention to) on relevant and critical data, identify what is interesting and changes with respect to what is static or relatively unchanging, and know when to change the baselines/ground truths with respect to the occurrence of transient events/objects.

In some disclosed examples, the ADM system may implement topically optimized data locality. For example, the ADM system may multi-pass process raw sensor data (e.g., video data) and generate bounding boxes for people, fixtures and equipment, etc. In some examples, the ADM system may send a subset of data to relevant nodes (e.g., Human Resources (HR), security, Information Technology (IT), etc., associated with an environment) where additional processing may be executed on their respective objects and events of interest and stored in their local data pools. In some examples, the ADM system may assemble metadata from multiple pools to recreate portions of a scene or event or the entire scene or event if needed.

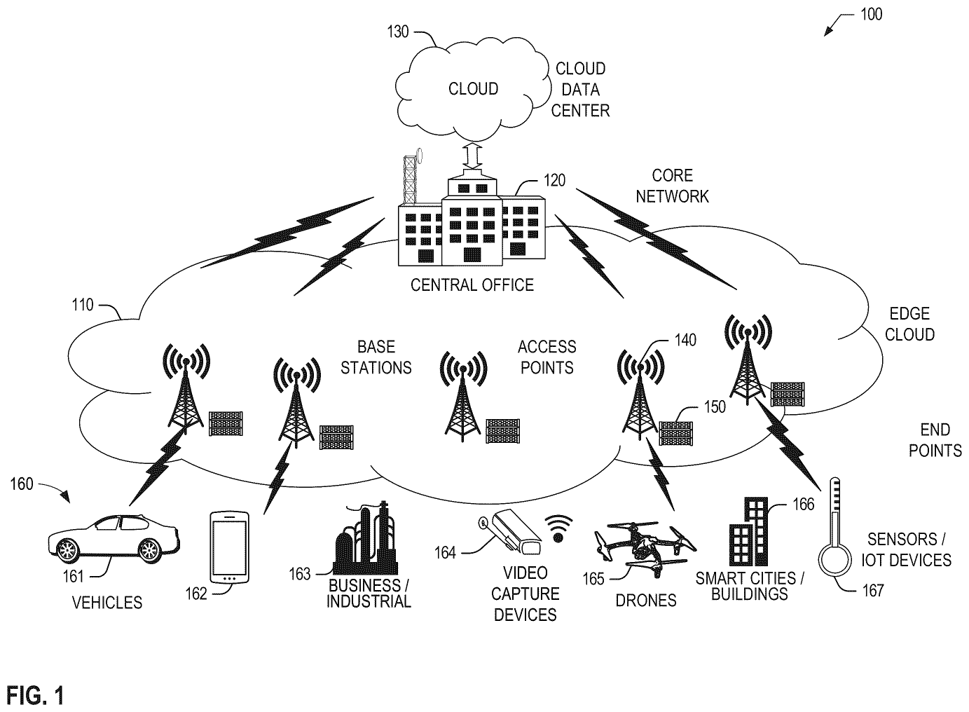

FIG. 1 is a block diagram 100 showing an overview of a configuration for Edge computing, which includes a layer of processing referred to in many of the following examples as an “Edge cloud”. For example, the block diagram 100 may implement an example adaptive data management system (also referred to herein as a smart data management system) as disclosed herein. As shown, the Edge cloud 110 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

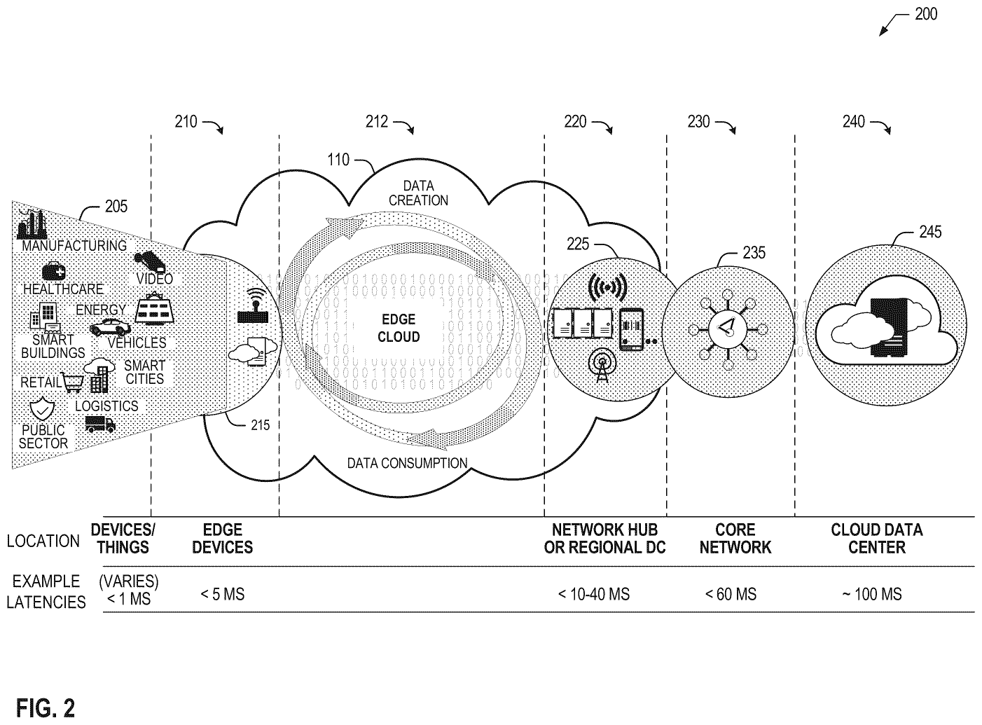

FIG. 2 illustrates operational layers among endpoints, an Edge cloud, and cloud computing environments. For example, FIG. 2 may implement an example adaptive data management system as disclosed herein. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance (e.g., distance between I/O interfaces such as PCIe or NICs) and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QOS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

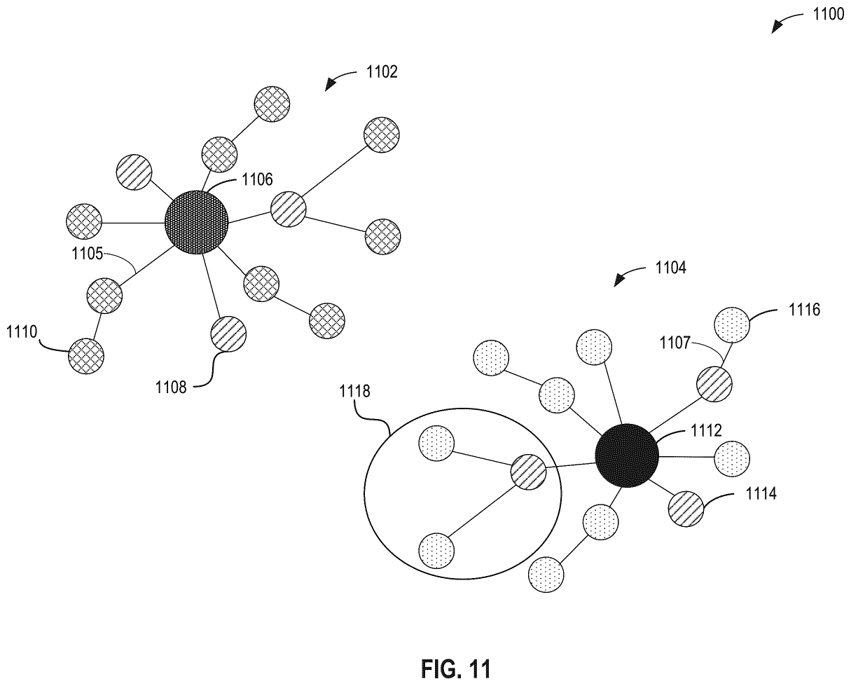

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing or electronic device is described in conjunction with FIGS. 11, 21, 38, 53, and/or 66. The Edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines (VMs), one or more containers, etc. Such virtual computing environments provide an execution environment in which one or more applications and/or other software, code, or scripts may execute while being isolated from one or more other applications, software, code, or scripts.

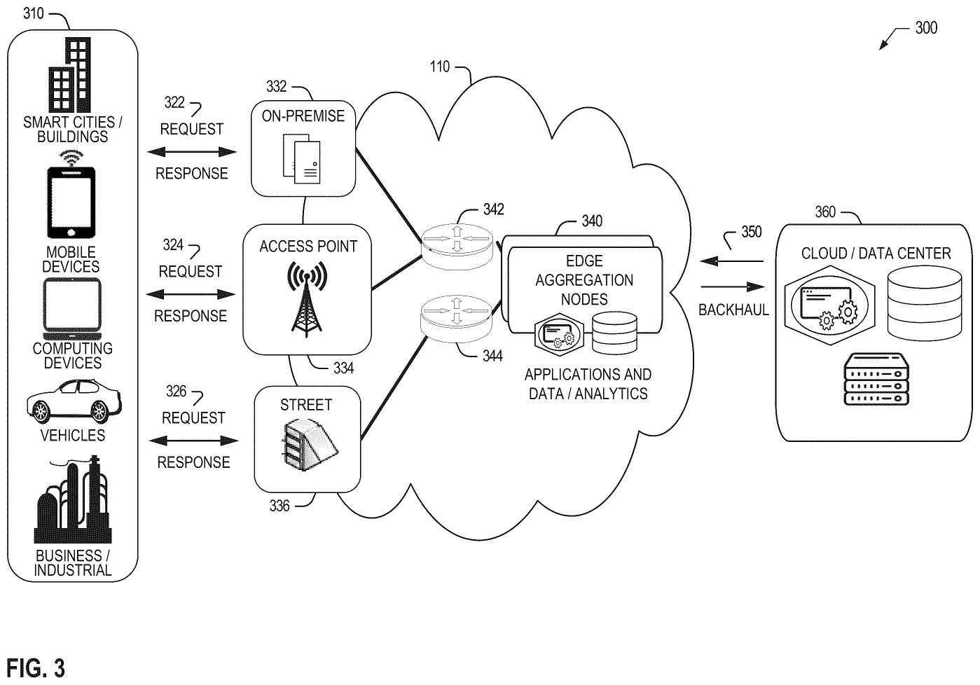

In FIG. 3, various client endpoints 310 (in the form of mobile devices, computers, autonomous vehicles, business computing equipment, industrial processing equipment) exchange requests and responses that are specific to the type of endpoint network aggregation. For example, FIG. 3 may implement an example adaptive data management system as disclosed herein. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

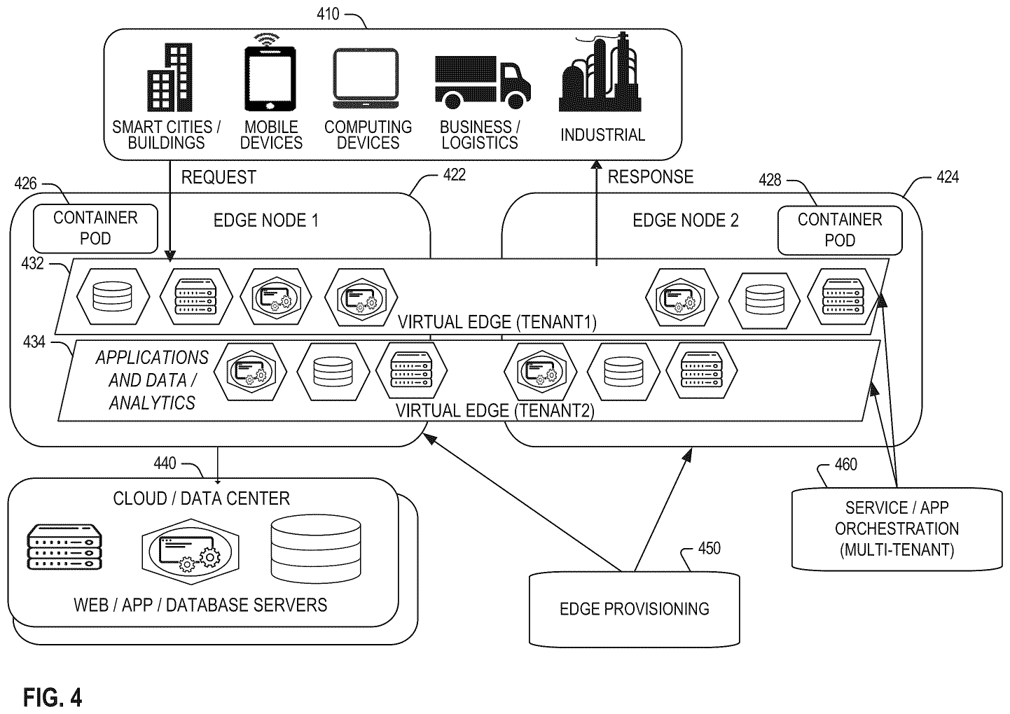

FIG. 4 illustrates deployment and orchestration for virtualized and container-based Edge configurations across an Edge computing system operated among multiple Edge nodes and multiple tenants (e.g., users, providers) which use such Edge nodes. For example, FIG. 4 may implement an example adaptive data management system as disclosed herein. Specifically, FIG. 4 depicts coordination of a first Edge node 422 and a second Edge node 424 in an Edge computing system 400, to fulfill requests and responses for various client endpoints 410 (e.g., smart cities/building systems, mobile devices, computing devices, business/logistics systems, industrial systems, etc.), which access various virtual Edge instances. Here, the virtual Edge instances 432, 434 provide Edge compute capabilities and processing in an Edge cloud, with access to a cloud/data center 440 for higher-latency requests for websites, applications, database servers, etc. However, the Edge cloud enables coordination of processing among multiple Edge nodes for multiple tenants or entities.

In the example of FIG. 4, these virtual Edge instances include: a first virtual Edge 432, offered to a first tenant (Tenant 1), which offers a first combination of Edge storage, computing, and services; and a second virtual Edge 434, offered to a second tenant (Tenant 2), which offers a second combination of Edge storage, computing, and services. The virtual Edge instances 432, 434 are distributed among the Edge nodes 422, 424, and may include scenarios in which a request and response are fulfilled from the same or different Edge nodes. The configuration of the Edge nodes 422, 424 to operate in a distributed yet coordinated fashion occurs based on Edge provisioning functions 450. The functionality of the Edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (ROT) or tenant specific RoT. A ROT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective Edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual Edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), GPU, XPU, interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, servlets, servers, or other computation abstraction that may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous Edge node. As part of migration of a container, a pod controller at a source Edge node may obtain a migration key from a target Edge node pod controller where the migration key is used to wrap the container-specific keys. When the container/pod is migrated to the target Edge node, the unwrapping key is exposed to the pod controller that then decrypts the wrapped keys. The keys may now be used to perform operations on container specific data. The migration functions may be gated by properly attested Edge nodes and pod managers (as described above).

In further examples, an Edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an Edge computing system may be configured to fulfill requests and responses for various client endpoints from multiple virtual Edge instances (and, from a cloud or remote data center). The use of these virtual Edge instances may support multiple tenants and multiple applications (e.g., augmented reality (AR)/virtual reality (VR), enterprise applications, content delivery, gaming, compute offload, etc.) simultaneously. Further, there may be multiple types of applications within the virtual Edge instances (e.g., normal applications; latency sensitive applications; latency-critical applications; user plane applications; networking applications; etc.). The virtual Edge instances may also be spanned across systems of multiple owners at different geographic locations (or, respective computing systems and resources which are co-owned or co-managed by multiple owners).

For instance, each Edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various Edge node resources (e.g., storage, compute, services, depicted with hexagons) provided for the respective Edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, the pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different Edge node that does satisfy it. Alternatively, the first pod may be allowed to execute and a different shared pod controller is installed and invoked prior to the second pod executing.

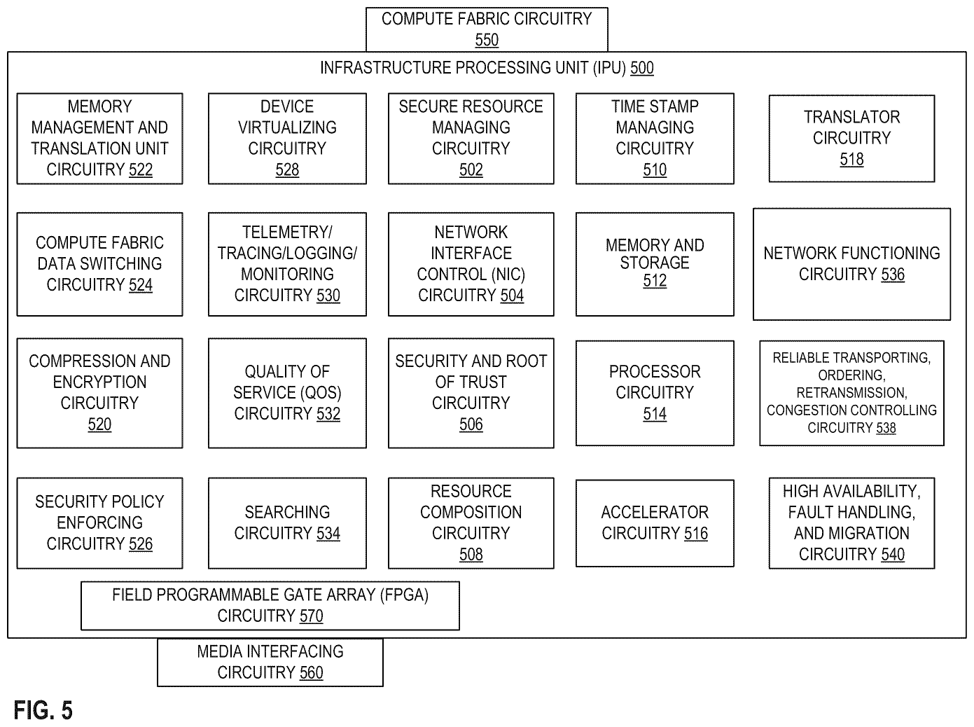

FIG. 5 depicts an example of an infrastructure processing unit (IPU) 500. In some examples, the IPU 500 can effectuate and/or otherwise facilitate proactive and/or adaptive data management and analytics as described herein. Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QOS), security, telemetry measurement, event logging, initiating and managing data flows, data placement, or job scheduling of resources on an XPU, storage, memory, or CPU.

In the illustrated example of FIG. 5, the IPU 500 includes or otherwise accesses secure resource managing circuitry 502, network interface controller (NIC) circuitry 504, security and root of trust circuitry 506, resource composition circuitry 508, time stamp managing circuitry 510, memory and storage 512, processing circuitry 514, accelerator circuitry 516, and/or translator circuitry 518. Any number and/or combination of other structure(s) can be used such as but not limited to compression and encryption circuitry 520, memory management and translation unit circuitry 522, compute fabric data switching circuitry 524, security policy enforcing circuitry 526, device virtualizing circuitry 528, telemetry, tracing, logging and monitoring circuitry 530, quality of service circuitry 532, searching circuitry 534, network functioning circuitry (e.g., routing, firewall, load balancing, network address translating (NAT), etc.) 536, reliable transporting, ordering, retransmission, congestion controlling circuitry 538, and high availability, fault handling and migration circuitry 540 shown in FIG. 5. Different examples can use one or more structures (components) of the example IPU 500 together or separately. For example, compression and encryption circuitry 520 can be used as a separate service or chained as part of a data flow with vSwitch and packet encryption.

In some examples, the IPU 500 includes a field programmable gate array (FPGA) 570 structured to receive commands from an CPU, XPU, or application via an API and perform commands/tasks on behalf of the CPU, including workload management and offload or accelerator operations. The illustrated example of FIG. 5 may include any number of FPGAs configured and/or otherwise structured to perform any operations of any IPU described herein.

Example compute fabric circuitry 550 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 560 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU 500, IPU 500 is a root of a system (e.g., rack of servers or data center) and manages compute resources (e.g., CPU, xPU, storage, memory, other IPUs, and so forth) in the IPU 500 and outside of the IPU 500. Different operations of an IPU are described below.

In some examples, the IPU 500 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 500 is selected to perform a workload, secure resource managing circuitry 502 offloads work to a CPU, xPU, or other device and the IPU 500 accelerates connectivity of distributed runtimes, reduce latency, CPU and increases reliability.

In some examples, secure resource managing circuitry 502 runs a service mesh to decide what resource is to execute workload, and provide for L7 (application layer) and remote procedure call (RPC) traffic to bypass kernel altogether so that a user space application can communicate directly with the example IPU 500 (e.g., the IPU 500 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-OF, or CXL.

In some cases, the example IPU 500 dynamically selects itself to run a given workload (e.g., microservice) within a composable infrastructure including an IPU, xPU, CPU, storage, memory, and other devices in a node.

In some examples, communications transit through media interfacing circuitry 560 of the example IPU 500 through a NIC/smartNIC (for cross node communications) or loopback back to a local service on the same host. Communications through the example media interfacing circuitry 560 of the example IPU 500 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 500 prioritizes its processing to minimize the stalling of the requesting application. In some examples, the IPU 500 schedules the prioritized message request issuing the event to execute a SQL query database and the example IPU constructs microservices that issue SQL queries and the queries are sent to the appropriate devices or services.

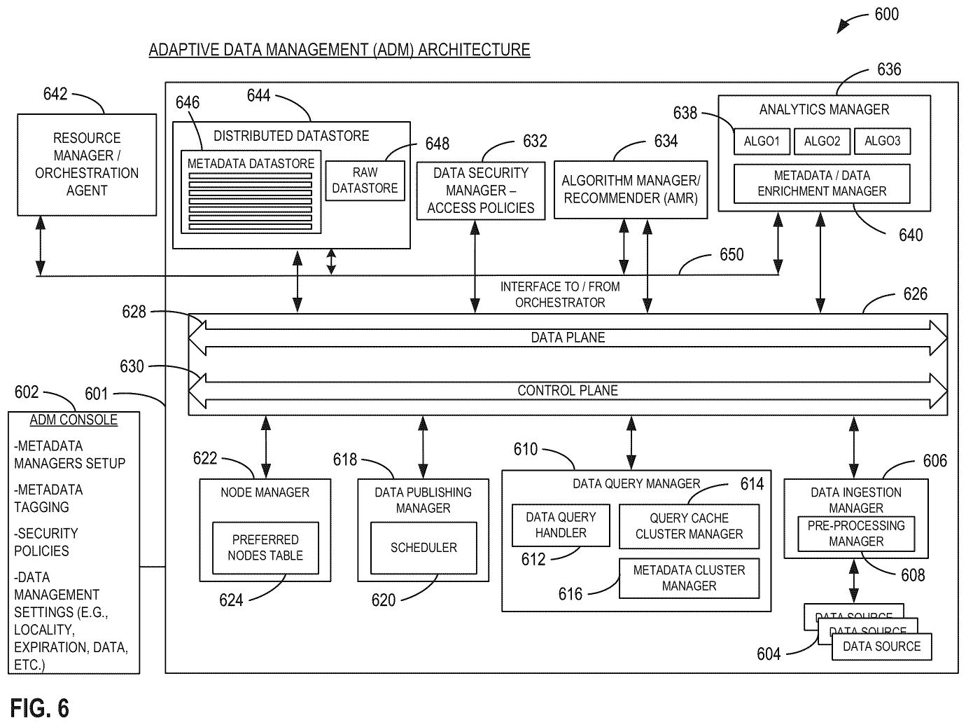

FIG. 6 is a block diagram of an example adaptive data management (ADM) system 600 to implement adaptive data management in a network environment. In some examples, the ADM system 600 can effectuate and/or otherwise implement proactive data management in the network environment. The ADM system 600 of FIG. 6 may be instantiated (e.g., creating an instance of, bring into being for any length of time, materialize, implement, etc.) by processor circuitry such as a CPU executing instructions. Additionally or alternatively, the ADM system 600 of FIG. 6 may be instantiated by an ASIC or an FPGA structured to perform operations corresponding to the instructions. It should be understood that some or all of the ADM system 600 of FIG. 6 may, thus, be instantiated at the same or different times. Some or all of the ADM system 600 of FIG. 6 may be instantiated, for example, in one or more threads executing concurrently on hardware and/or in series on hardware. Moreover, in some examples, some or all of the ADM system 600 of FIG. 6 may be implemented by one or more VMs and/or containers executing on the processor circuitry.

In some examples, the ADM system 600 is implemented using an example logical entity 601. For example, the logical entity 601 can be implemented using a node (e.g., a client compute node), such as any type of endpoint component, device, appliance, or other thing capable of communicating as a producer or consumer of data. In some examples, the logical entity 601 can be implemented by, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a sensor, a personal video recorder, a headset (e.g., an augmented reality (AR) headset, a virtual reality (VR) headset, etc.) or other wearable device, or any other type of computing device. In some examples, the logical entity 601 can be implemented using one or more nodes (e.g., client compute nodes), one or more servers, one or more personal computers, etc., and/or any combination(s) thereof. For example, a first portion of the logical entity 601 can be implemented using a first client compute node and a second portion of the logical entity 601 can be implemented using a second client compute node. Any other combinations are contemplated. Additionally and/or alternatively, the logical entity 601 can include and/or otherwise implement the ADM console 602 and/or the resource manager/orchestration agent 642. For example, the logical entity 601 can include and/or otherwise implement the resource manager/orchestration agent 642 to orchestrate resource(s) of the logical entity 601, and/or, more generally, the ADM system 600, and/or, more generally, an edge environment associated with the logical entity 601 and/or the ADM system 600.

In the illustrated example of FIG. 6, the ADM system 600 includes an example ADM console 602, example data sources 604, and an example data ingestion manager 606, which includes an example pre-processing manager 608. The ADM system 600 includes an example data query manager 610, which includes an example data query handler 612, an example query cache cluster manager 614, and an example metadata cluster manager 616. The ADM system 600 includes an example data publishing manager 618, which includes an example scheduler 620. The ADM system 600 includes an example node manager 622, which includes an example preferred nodes table 624. The ADM system 600 includes an example network plane 626, which includes an example data plane 628 and an example control plane 630. The ADM system 600 includes an example data security manager 632, an example algorithm manager and/or recommender (AMR) 634, and an example analytics manager 636, which includes example algorithms 638 (identified by ALGO1, ALGO2, ALGO3), and an example metadata/data enrichment manager 640. The ADM system 600 includes an example resource manager and/or orchestration agent 642. The ADM system 600 includes an example distributed datastore 644, which includes an example metadata datastore 646, and an example raw datastore 648.

In the illustrated example, the ADM system 600 includes the ADM console 102 to setup and/or otherwise configure portion(s) of the ADM system 600 (e.g., the data ingestion manager 606, the node manager 622, etc.). For example, the ADM console 602 can configure the metadata/data enrichment manager 640. In some examples, the ADM console 602 may effectuate and/or otherwise execute metadata tagging by adding, removing, and/or modifying metadata. In some examples, the ADM console 602 can enforce and/or otherwise implement security policies. For example, the ADM console 602 can add, remove, and/or modify access policies generated, managed, and/or otherwise handled by the data security manager 632. In some examples, the ADM console 602 can configure data management settings (e.g., locality, expiration date, etc., of data) associated with data that is generated, accessed, and/or stored by the ADM system 600. In some examples, the ADM console 602 can be implemented using one or more user experience (UX) and/or user interface (UI) (e.g., graphical user interface (GUI)) consoles, displays, interfaces, etc.

In the illustrated example, the ADM system 600 includes the data ingestion manager 606 to ingest, receive, and/or otherwise obtain data from one(s) of the data sources 604. For example, the data sources 604 can be implemented using any hardware, software, and/or firmware as described herein (e.g., hardware, software, and/or firmware of an autonomous guided vehicle (AGV), a server, an IoT device, an Edge appliance, etc.). In some examples, the data ingestion manager 606 includes the pre-processing manager 608 to pre-process data obtained from the data sources 604. For example, the data ingestion manager 606 can extract portion(s) of the data, convert portion(s) of the data from a first data format to a second data format, compress or decompress the data, decrypt or encrypt the data, etc., and/or any combination(s) thereof.

In the illustrated example, the ADM system 600 includes the data query manager 610 to queue and/or otherwise process data search requests from users and/or applications. For example, the data query handler 612 can queue and/or otherwise process the data search requests. In some examples, the data query handler 612 can generate and/or return results associated with the data search results to the requester (e.g., the requesting user, the requesting device, the requesting application/service, etc.). In some examples, the data query manager 610 can utilize the existence of metadata tables extracted from data files (e.g., media, alpha-numeric, spatial, etc., data files) that have been pre-generated by the metadata/data enrichment manager 640. In some examples, the data query manager 610 can be implemented using a search and match of topical terms to metadata tags. In some examples, the data query manager 610 can be implemented using a search and match of weighted topics and phrases with Boolean operations to perform complex contextual matches, prioritizations, and sequences of topics mapping.

In some examples, the data query manager 610 manages multiple metadata context resulting from metadata generating engines, sub-metadata tables specific to user/applications with unique context, permissions, etc. In some examples, the data query manager 610 can scan a metadata file (e.g., a metadata array, table, etc.), for primary search and recommendation of most appropriate data file links associated with portion(s) of the metadata file. For example, the data query manager 610 can include the metadata cluster manager 616 to scan the metadata file and/or return a number of excerpts (e.g., a user selectable number of excerpts, portions, etc.) for final selection and output. In some examples, the data query manager 610 can check selections for permission level appropriateness. For example, different departments, regions, etc., of an environment can have security and access control. In some examples, the data query manager 610 can cross-reference the selections with the security and access control to determine whether a requester has access to the selections. In some examples, the data query manager 610 can link a user/application to a returned and/or otherwise identified data source file. In some examples, the data query manager 610 and a metadata database (e.g., the metadata datastore 646) need not be co-resident.

In some examples, the data query manager 610 can include the query cache cluster manager 614 to execute and/or otherwise effectuate selective caching. For example, the query cache cluster manager 614 can activate and/or otherwise enable caching for frequently requested and/or accessed topics, most recently used search terms with user selected and preferred data source file links, data source file linkages that have a high correlation to one another (e.g., occurs frequently), etc., and/or any combination(s) thereof.

In some examples, the data query manager 610 facilitates capacity scaling for data and/or resource demand volume and for serving local organizations, personnel, teams, etc. For example, the data query manager 610 can launch and/or otherwise instantiate additional instances of the data query manager 610 near and/or otherwise proximate to demand sources (e.g., a department server, an individual personal computer, etc.) that may be associated with the data sources 604.

Advantageously, in some examples, a locality of the metadata datastore 646 to the data query manager 610 can reduce network traffic and latency to ensure that even if a file (e.g., a data file) is unavailable, the existence of the file may be confirmed. In some examples, the data query manager 610 can enable and/or otherwise effectuate synchronization with other components of the ADM system 600 more frequently for metadata (e.g., metadata files, tables, etc.) of the metadata datastore 646 that is/are accessed most frequently or undergo significant changes (e.g., usually another feature of frequent use or recent capture). In some examples, the data query manager 610 can achieve interactive and/or programmatic access to portion(s) of the ADM system 600.

In the illustrated example, the ADM system 600 includes the data publishing manager 618 to implement publish-subscribe messaging. For example, a subscriber (e.g., a data subscriber, a device subscriber, etc.) can coordinate with the scheduler 620 to subscribe to alerts, changes, updates, etc., of data of the metadata datastore 646, the raw datastore 648, and/or data generated by one(s) of the data sources 604. In some examples, the data publishing manager 618 can publish data of interest to the appropriate subscribers.

In the illustrated example, the ADM system 600 includes the node manager 622 to enable edge nodes to maintain lists (e.g., a friends list, a neighboring nodes list, a trusted or verified node list, etc.) on the network. In some examples, the list(s) can include(s) the preferred nodes table 624. For example, the preferred nodes table 624 can be implemented using a routing table in networking examples. In some examples, the node manager 622 can maintain the table/list/index as a dynamic and/or evolving table/list/index by considering previous interactions and/or transactions between neighboring nodes. For example, the node manager 622 can control the table/list/index to rate neighboring nodes based on the context of data requested, the frequency of data requested, the Quality-of-Service (QOS) of past interactions, etc., and/or any combination(s) thereof. In some examples, the table/list/index can exist in the distributed datastore 644, which may be quickly accessible upon a request from the data query manager 610.

In the illustrated example, the ADM system 600 includes the network plane 626 to facilitate the transmission, distribution, and/or otherwise propagation of data within a network environment. In some examples, the network plane 626 can be implemented by one or more networks. For example, the network plane 626 can be implemented by the Internet. However, the network plane 626 can be implemented using any suitable wired and/or wireless network(s) including, for example, one or more data buses, one or more Local Area Networks (LANs), one or more wireless LANs (WLANs), one or more cellular networks, one or more private networks, one or more public networks, one or more fiber networks, one or more satellite networks, one or more terrestrial networks, one or more non-terrestrial networks, etc., and/or any combination(s) thereof. In the illustrated example, component(s) of the ADM system 600 can provide, deliver, propagate, etc., data in the ADM system 600 by way of the data plane 628. In the illustrated example, component(s) of the ADM system 600 can provide, deliver, propagate, etc., controls, commands, directions, instructions, etc., in the ADM system 600 by way of the control plane 630.

In the illustrated example, the ADM system 600 includes the data security manager 632 to control (e.g., add, remove, modify, etc.) one(s) of the access policies. For example, the data security manager 632 can control the access policies rather than the node/platform level security components and/or a user who may be authenticated to access the network. In some examples, the data security manager 632 can be accessed through the ADM console 602.

In some examples, the data security manager 632 assigns initial security/access levels to data files, data streams, etc., based on user provided policy or explicit settings. In some examples, the data security manager 632 can facilitate autonomous control of access policies, where content may inherit security levels from other similar data files based on metadata, data topics, etc. In some examples, the data security manager 632 can ensure compatible security level data match for the user/application/service level security with appropriate data levels. In some examples, the data security manager 632 can define the scope of data availability (e.g., geographic, topical, personnel, security level, etc.). In some examples, the data security manager 632 can log audits for a query log (e.g., requests, copies, moves, successes/fails, reasons for the requests, successes, fails, etc., etc.) maintained by the data query manager 610. In some examples, the data security manager 632 can ensure data/metadata from high security areas are not copied/moved to lower-level security environments. In some examples, the data security manager 632 can enforce top secret level access to confidential areas or non-top secret level access to unsecured servers. In some examples, the data security manager 632 can monitor with the data query manager 610 the data request traffic for potential irregularities. In some examples, the data security manager 632 can implement and/or otherwise provide encryption services, keys as a service, etc., and/or any combination(s) thereof for improved security of the ADM system 600.

In the illustrated example, the ADM system 600 includes the AMR 634 to monitor the data on the data plane 628 and/or in the distributed datastore 644 (e.g., when invoked or triggered to run analytics) and/or upon a gap in the existing algorithms 638 of the analytics manager 636. In some examples, the AMR 634 can interface with the resource manager 642 by using an example interface 650. For example, the resource manager 642 can implement an orchestration agent that receives a request for new one(s) of the algorithms 638 to act on of data of interest. For example, if a node that was previously monitoring a video stream and now has some additional time series data, the AMR 634 can request the resource manager/orchestrator agent 642 for a new one of the algorithms 638 to update the analytics manager 636 to run insights on both modalities.

In some examples, the analytics manager 636 includes a metadata agent (e.g., a metadata agent that can be implemented by the metadata/data enrichment manager 640) that may request analytics to be executed by the AMR 634 for generating metadata from source streams/files. In some examples, the AMR 634 can instantiate one(s) of the algorithms 638 to generate the analytics. In some examples, the analytics may be generated by an Artificial Intelligence/Machine Learning (AI/ML) model (e.g., a neural network (NN)) for classification, neural natural language processing (NNLP) to parse documentation, etc., and/or any combination(s) thereof.

In some examples, in the data or user domain, an application or a direct user request may request an analytics container (e.g., an analytics container that may be instantiated and/or implemented by the analytics manager 636) with appropriate configuration(s) and optimization(s) for the requested task. In some examples, certain one(s) of the algorithms 638 or AI/ML models may be preferred over time as a function of accuracy and performance and priorities may be assigned to the one(s) of the algorithms 638 for utilization in the ADM system 600.

In some examples, the resource manager/orchestration agent 642 can orchestrate new one(s) of the algorithms 638 either from a centralized algorithm library based on example algorithm ratings, scores, etc., if available, or through a pointer or other reference to a local datastore (e.g., if available in a library) of the analytics manager 636 for faster access or the distributed datastore 644.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, one(s) of the algorithms 638 may be trained with data to recognize patterns and/or associations and follow such patterns and/or associations when processing input data such that other input(s) result in output(s) consistent with the recognized patterns and/or associations. In some examples, an association can be implemented using a data association. For example, the association may itself be data. For example, the association can be implemented using an address (e.g., a storage or memory address), a pointer, a reference, etc., or any other data connection or linkage that may be stored in a mass storage device, memory, etc.

Many different types of machine-learning models and/or machine-learning architectures exist. In some examples, the analytics manager 636 may generate one(s) of the algorithms 638 as neural network model(s). In some examples, the analytics manager 636 can generate one(s) of the algorithms 638 as lightweight models (e.g., lightweight neural network models). In some examples, the resource manager/orchestration agent 642 may obtain and/or generate one(s) of the algorithms 638. Using a neural network model enables the analytics manager 636 to execute AI/ML workload(s). In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the analytics manager 636 may compile and/or otherwise generate one(s) of the algorithm(s) 638 as lightweight machine-learning models.

In general, implementing an AI/ML system involves two phases, a learning/training phase and an inference phase. In the learning/training phase, a training algorithm is used to train the one(s) of the algorithms 638 to operate in accordance with patterns and/or associations based on, for example, training data. In general, the one(s) of the algorithms 638 include(s) internal parameters (e.g., indices, raw data, metadata, insights, models, weights, etc.) that guide how input data is transformed into output data, such as through a series of nodes and connections within the one(s) of the algorithms 638 to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of AI/ML model and/or the expected output. For example, the analytics manager 636 may invoke supervised training to use inputs and corresponding expected (e.g., labeled) outputs to select parameters (e.g., by iterating over combinations of select parameters) for the one(s) of the algorithms 638 that reduce model error. As used herein, “labeling” refers to an expected output of the machine learning model (e.g., a classification, an expected output value, etc.). Alternatively, the analytics manager 636 may invoke unsupervised training (e.g., used in deep learning, a subset of machine learning, etc.) that involves inferring patterns from inputs to select parameters for the one(s) of the algorithms 638 (e.g., without the benefit of expected (e.g., labeled) outputs).

In some examples, the analytics manager 636 trains the one(s) of the algorithms 638 using unsupervised clustering of operating observables. For example, the operating observables may include data from the data sources 604, metadata in the metadata datastore 646, data in the raw datastore 648, etc., and/or combination(s) thereof. However, the analytics manager 636 may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the analytics manager 636 may train the one(s) of the algorithms 638 until the level of error is no longer reducing. In some examples, the analytics manager 636 may train the one(s) of the algorithms 638 locally on the analytics manager 636 and/or remotely at an external computing system (e.g., on external computing device(s) in communication with the resource manager/orchestration agent 642) communicatively coupled to the analytics manager 636. In some examples, the analytics manager 636 trains the one(s) of the algorithms 638 using hyperparameters that control how the learning is performed (e.g., a learning rate, a number of layers to be used in the machine learning model, etc.). In some examples, the analytics manager 636 may use hyperparameters that control model performance and training speed such as the learning rate and regularization parameter(s). The analytics manager 636 may select such hyperparameters by, for example, trial and error to reach an optimal model performance. In some examples, the analytics manager 636 Bayesian hyperparameter optimization to determine an optimal and/or otherwise improved or more efficient network architecture to avoid model overfitting and improve the overall applicability of the one(s) of the algorithms 638. Alternatively, the analytics manager 636 may use any other type of optimization. In some examples, the analytics manager 636 may perform re-training. The analytics manager 636 may execute such re-training in response to override(s) by a user of the ADM system 600, a receipt of new training data, change(s) to node(s), change(s) observed and/or otherwise identified by node(s), etc.

In some examples, the analytics manager 636 facilitates the training of the one(s) of the algorithms 638 using training data. In some examples, the analytics manager 636 utilizes training data that originates from locally generated data, such as one(s) of the data from the data sources 604, metadata in the metadata datastore 646, data in the raw datastore 648, etc., and/or combination(s) thereof. In some examples, the analytics manager 636 utilizes training data that originates from externally generated data, such as data from the data sources 604, data from the resource manager/orchestration agent 642, etc., and/or combination(s) thereof. In some examples where supervised training is used, the analytics manager 636 may label the training data (e.g., label training data or portion(s) thereof with appropriate metadata). Labeling is applied to the training data by a user manually or by an automated data pre-processing system. In some examples, the analytics manager 636 may pre-process the training data. In some examples, the analytics manager 636 sub-divides the training data into a first portion of data for training the one(s) of the algorithms 638, and a second portion of data for validating the one(s) of the algorithms 638.

Once training is complete, the analytics manager 636 may deploy the one(s) of the algorithms 638 for use as an executable construct that processes an input and provides an output based on the network of nodes and connections defined in the one(s) of the algorithms 638. The analytics manager 636 may store the one(s) of the algorithms 638 in the analytics manager 636. In some examples, the analytics manager 636 may invoke the interface 650 to transmit the one(s) of the algorithms 638 to one(s) of the external computing systems in communication with the resource manager/orchestration agent 642. In some examples, in response to transmitting the one(s) of the algorithms 638 to the one(s) of the external computing systems, the one(s) of the external computing systems may execute the one(s) of the algorithms 638 to execute AI/ML workloads with at least one of improved efficiency or performance.

Once trained, the deployed one(s) of the algorithms 638 may be operated in an inference phase to process data. In the inference phase, data to be analyzed (e.g., live data) is input to the one(s) of the algorithms 638, and the one(s) of the algorithms 638 execute(s) to create an output. This inference phase can be thought of as the AI “thinking” to generate the output based on what it learned from the training (e.g., by executing the one(s) of the algorithms 638 to apply the learned patterns and/or associations to the live data). In some examples, input data undergoes pre-processing before being used as an input to the one(s) of the algorithms 638. Moreover, in some examples, the output data may undergo post-processing after it is generated by the one(s) of the algorithms 638 to transform the output into a useful result (e.g., a display of data, a detection, tracking, and/or classification of an object, an instruction to be executed by a machine, etc.).

In some examples, output of the deployed one(s) of the algorithms 638 may be captured and provided as feedback. By analyzing the feedback, an accuracy of the deployed one(s) of the algorithm(s) 638 can be determined. If the feedback indicates that the accuracy of the deployed model is less than a threshold or other criterion, training of an updated model can be triggered using the feedback and an updated training data set, hyperparameters, etc., to generate an updated, deployed model.

In the illustrated example, the ADM system 600 includes the metadata/data enrichment manager 640 to schedule and/or execute metadata creation and/or post-processing routines intended to extract context and meaning from the source data stream/data files to enhance source data files to decrease noise and/or clarify/focus subjects or topics of interest. In some examples, the metadata/data enrichment manager 640 includes a metadata or enhancement request routine, an online metadata agent, and/or an offline metadata agent. In some examples, the metadata or enhancement request routine can be configured and/or otherwise instantiated to take inputs from a user or process/application to articulate the types of metadata/enhancement and determine what operations may be done in real time and what must be done offline based on a complexity of the request, type of data, available processing resources, priority/urgency of the operation, and the like. In some examples, the metadata/data enrichment manager 640 can enrich metadata by adding and/or otherwise including new metadata in response to ingesting data from an environment. In some examples, the metadata/data enrichment manager 640 can enrich metadata by removing and/or otherwise deleting portion(s) of the metadata that is/are determined to be irrelevant (or not as relevant as once determined) or not useful for determining output(s) with a high likelihood of accuracy, relevancy, etc., and/or any combination(s) thereof.

In some examples, the online metadata agent can access existing metadata or enhancement functionality within a node or launch a selected algorithm package to perform real time metadata/enhancement actions on the data stream and create a source-file linked metadata record that may be passed to the data query manager 610 for incorporation and synchronization with other authorized and/or relevant instances of the data query manager 610. In the example of source file enhancement, the original file may be archived and linked with appropriate metadata record while the modified file is returned to the requestor.

In some examples, the offline metadata agent can be implemented as the real time agent instantiated on the server/file storage that runs metadata/enhancement routines offline due to resource availability, complexity of operations, and/or lower priority setting. Subsequent behavior may be similar to the online metadata once post-processing has been completed.

In some examples, the metadata/data enrichment manager 640 evaluates metadata/enhancement requests and priority. In some examples, the metadata/data enrichment manager 640 can select appropriate operations for base metadata and enhancement operations. In some examples, the metadata/data enrichment manager 640 can invoke and/or otherwise provoke the AMR 634 to heuristically suggest proper algorithm(s) for advanced data operations and/or recommend algorithm combinations (e.g., algorithm recipes) from prior operations that may be preferred by different customers or observed to operate best on certain hardware.

In some examples, the metadata/data enrichment manager 640 can identify real-time operations from post-processed operations and confirm with the user allowing the user to modify. In some examples, the metadata/data enrichment manager 640 can launch modules (e.g., AI, NNLP, analytics, statistics, etc.) to generate metadata (e.g., generate association(s) of data portion(s) and metadata) and/or enhance existing data (e.g., hyper-resolution or false image enhancements) on local node or supporting compute platform(s). In some examples, the metadata/data enrichment manager 640 can manage archiving of sources, appending metadata records requested or provided by the data query manager 610 (with source links), etc. In some examples, a single instance of the metadata/data enrichment manager 640 can manage multiple metadata/enhancement operations.

In the illustrated example, the ADM system 600 includes the distributed datastore 644 to record data. For example, the distributed datastore 644 can include the metadata datastore 646 to record and/or otherwise store metadata. In some examples, the distributed datastore 644 can include the raw datastore 648 to record raw and/or otherwise unprocessed data. The distributed datastore 644 can be implemented by one or more volatile memories (e.g., a Synchronous Dynamic Random Access Memory (SDRAM), Dynamic Random Access Memory (DRAM), RAMBUS Dynamic Random Access Memory (RDRAM), etc.), one or more non-volatile memories (e.g., flash memory), and/or combination(s) thereof. The distributed datastore 644 may additionally or alternatively be implemented by one or more double data rate (DDR) memories, such as DDR, DDR2, DDR3, DDR4, DDR5, mobile DDR (mDDR), etc. The distributed datastore 644 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example the distributed datastore 644 is illustrated as a single datastore, the distributed datastore 644 may be implemented by any number and/or type(s) of datastores. Furthermore, the data stored in the distributed datastore 644 may be in any data format such as, for example, binary data, comma delimited data, tab delimited data, structured query language (SQL) structures, etc.

In some examples, the metadata datastore 646, the raw datastore 648, and/or, more generally, the distributed datastore 644 may implement one or more databases. The term “database” as used herein means an organized body of related data, regardless of the manner in which the data or the organized body thereof is represented. For example, the organized body of related data may be in the form of one or more of a table, a map, a grid, a packet, a datagram, a frame, a model (e.g., an AI/ML model, a data graph model, etc.), a file, an e-mail, a message, a document, a report, a list or in any other form.

As used herein, “data” is information in any form that may be ingested, processed, interpreted and/or otherwise manipulated by processor circuitry to produce a result. The produced result may itself be data.

As used herein “threshold” is expressed as data such as a numerical value represented in any form, that may be used by processor circuitry as a reference for a comparison operation.

As used herein, a “model” is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data.

While an example manner of implementing the ADM system 600 is illustrated in FIG. 6, one or more of the elements, processes, and/or devices illustrated in FIG. 6 may be combined, divided, re-arranged, omitted, eliminated, and/or implemented in any other way. Further, the logical entity 601, the ADM console 602, the data sources 604, the data ingestion manager 606, the pre-processing manager 608, the data query manager 610, the data query handler 612, the query cache cluster manager 614, the metadata cluster manager 616, the data publishing manager 618, the scheduler 620, the node manager 622, the preferred nodes table 624, the network plane 626, the data plane 628, the control plane 630, the data security manager 632, the AMR 634, the analytics manager 636, the algorithms 638, the metadata/data enrichment manager 640, the resource manager 642, the distributed datastore 644, the metadata datastore 646, the raw datastore 648, the interface 650, and/or, more generally, the ADM system 600 of FIG. 6, may be implemented by hardware alone or by hardware in combination with software and/or firmware. Thus, for example, any of the logical entity 601, the ADM console 602, the data sources 604, the data ingestion manager 606, the pre-processing manager 608, the data query manager 610, the data query handler 612, the query cache cluster manager 614, the metadata cluster manager 616, the data publishing manager 618, the scheduler 620, the node manager 622, the preferred nodes table 624, the network plane 626, the data plane 628, the control plane 630, the data security manager 632, the AMR 634, the analytics manager 636, the algorithms 638, the metadata/data enrichment manager 640, the resource manager 642, the distributed datastore 644, the metadata datastore 646, the raw datastore 648, the interface 650, and/or, more generally, the ADM system 600, could be implemented by processor circuitry, analog circuit(s), digital circuit(s), logic circuit(s), programmable processor(s), programmable microcontroller(s), GPU(s), DSP(s), ASIC(s), programmable logic device(s) (PLD(s)), and/or field programmable logic device(s) (FPLD(s)) such as Field Programmable Gate Arrays (FPGAs). Further still, the ADM system 600 of FIG. 6 may include one or more elements, processes, and/or devices in addition to, or instead of, those illustrated in FIG. 6, and/or may include more than one of any or all of the illustrated elements, processes and devices.

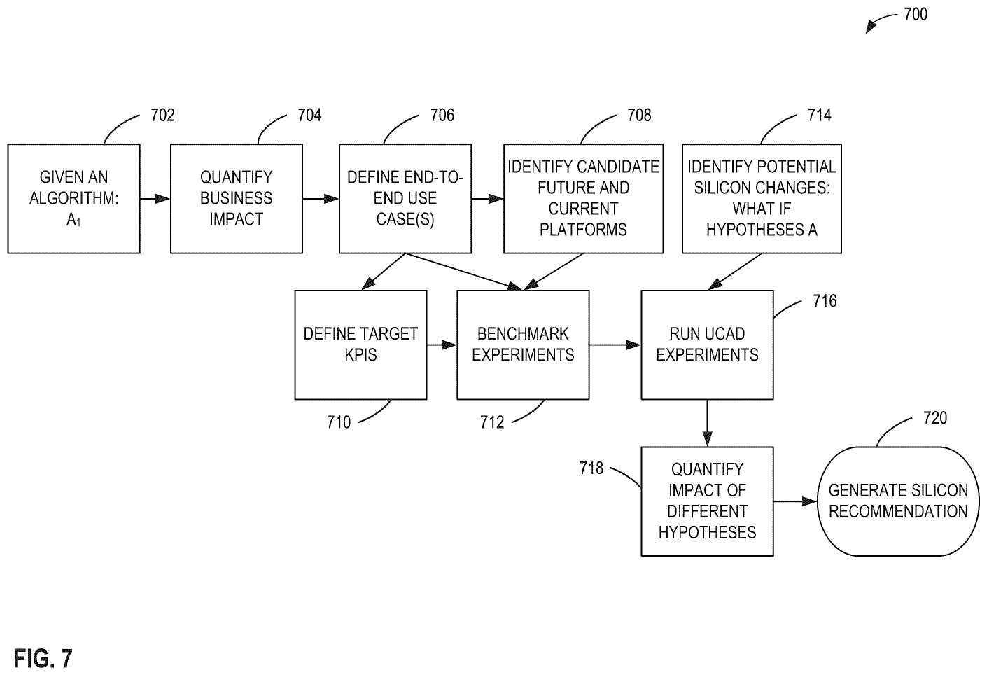

FIG. 7 is a flowchart representative of example machine readable instructions and/or example operations 700 that may be executed and/or instantiated by processor circuitry to generate an example recommendation to integrate a hardware, software, and/or firmware feature in a semiconductor-based device (e.g., a silicon-based device). For example, the machine readable instructions and/or the operations 700 of FIG. 7 can be executed by the ADM system 600 of FIG. 6, or portion(s) thereof, or any other hardware, software, and/or firmware described herein.

The example machine readable instructions and/or the example operations 700 of FIG. 7 begin at block 702, at which a candidate algorithm (e.g., an AI/ML algorithm) is identified. At block 704, a business impact of the candidate algorithm may be quantified. At block 706, end-to-end use case(s) that may utilize the candidate algorithm are defined. At block 708, current and future candidate platforms that may be utilized for the end-to-end use case(s) may be identified. At block 710, target key performance indicators (KPIs) may be defined and technical benchmarking may be implemented at block 712. At block 714, potential changes to a semiconductor-based device may be identified and Use-Case Analysis and Decomposition (UCAD) experiments may be conducted at block 716. At block 718, an impact of different hypotheses are quantified, which may result in generating a semiconductor-device based recommendation at block 720. For example, a recommendation to change (e.g., add, remove, and/or modify) hardware, software, and/or firmware associated with a semiconductor-based device may be generated at block 720. In some examples, the semiconductor-based device may be manufactured based on the recommendation. In some examples, the manufactured semiconductor-based device may execute and/or otherwise implement the candidate algorithm identified at block 702 using hardware, software, and/or firmware of the manufactured semiconductor-based device.

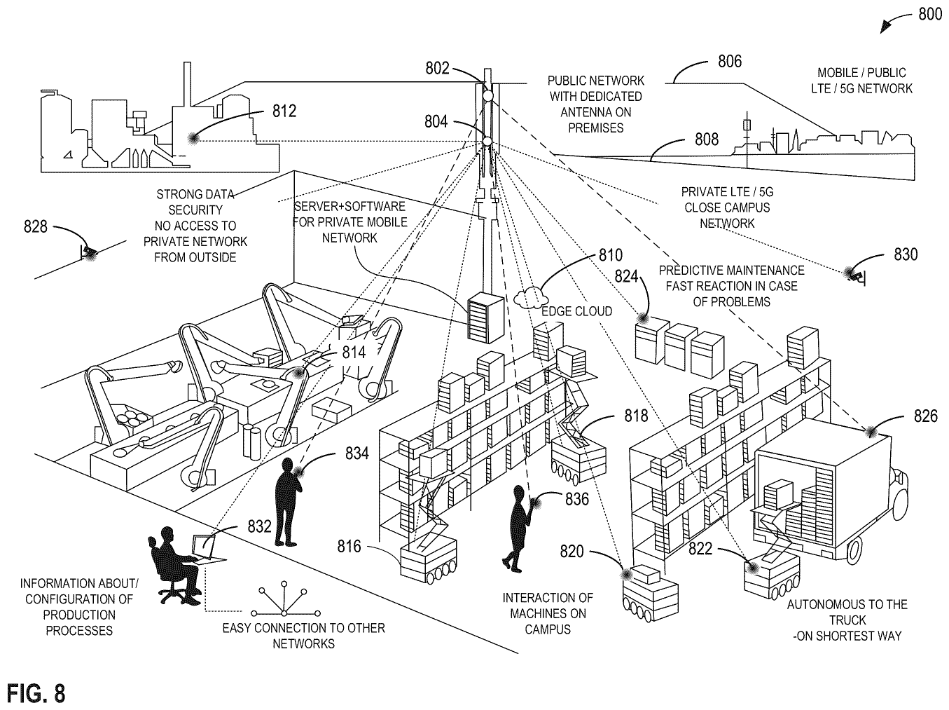

FIG. 8 is an illustration of an example edge network environment 800 including an example edge gateway 802 and an example edge switch 804 that may implement the ADM system 600 of FIG. 6. In some examples, the edge gateway 802 and/or the edge switch 804 may implement resources of the edge devices layer 210 of FIG. 2. In some examples the edge gateway 802 and/or the edge switch 804 may implement the access point or base station 140 of FIG. 1, the local processing hub 150 of FIG. 1, and/or the nodes 215 of FIG. 2. For example, the edge gateway 802 and/or the edge switch 804 may implement the edge devices layer 210 of FIG. 2.

The edge network environment 800 of the illustrated example includes an example public network 806, an example private network 808, and an example edge cloud 810. In this example, the public network 806 may implement a telephone service provider (TSP) network (e.g., a Long-Term Evolution (LTE) network, a 5G/6G network, a Telco network, etc.). For example, the public network 806 may implement the network access layer 220 of FIG. 2, the core network 230 of FIG. 2, and/or the cloud data center layer 240 of FIG. 2. In this example, the private network 808 may implement an enterprise network (e.g., a close campus network, a private LTE network, a private 5G/6G network, etc.). For example, the private network 808 may implement the endpoint layer 200 of FIG. 2 and/or the edge devices layer 210 of FIG. 2. In some examples, the edge cloud 810 may be implemented by one or more hardware, software, and/or firmware resources. For example, the edge cloud 810 may be implemented by one or more computer servers. In this example, the edge cloud 810 may implement an enterprise edge cloud. For example, the edge cloud 810 may implement the edge cloud 110 of FIGS. 1, 2, and/or 3.

In the illustrated example of FIG. 8, the edge network environment 800 may implement a smart factory (e.g., a smart industrial factory), a process control environment, etc. For example, the edge network environment 800 may implement one(s) of the computational use cases 205 of FIG. 2, such as a manufacturing, smart building, logistics, vehicle, and/or video computational use cases.

The edge network environment 800 of the illustrated example includes an example process control system 812, example robots (e.g., collaborative robots, robot arms, etc.) 814, a first example industrial machine (e.g., an autonomous industrial machine) 816, a second example industrial machine 818, a third example industrial machine 820, a fourth example industrial machine 822, an example predictive maintenance system 824, an example vehicle (e.g., a truck, an autonomous truck, an autonomous vehicle, etc.) 826, a first example monitoring sensor 828, a second example monitoring sensor 830, and example endpoint devices 832, 834, 836. In some examples, the process control system 812 may include one or more industrial machines such as a silo, a smokestack, a conveyor belt, a mixer, a pump, etc., and/or a combination thereof. For example, the process control system 812 may implement the business and industrial equipment 163 of FIG. 1, the smart cities and building devices 166 of FIG. 1, etc.

In some examples, the robots 814 may implement hydraulic and/or electromechanical robots that may be configured to execute manufacturing tasks (e.g., lifting equipment, assembling components, etc.), industrial tasks, etc. For example, the robots 814 may implement the business and industrial equipment 163 of FIG. 1, the smart cities and building devices 166 of FIG. 1, etc. In some examples, the industrial machines 816, 818, 820, 822 are autonomous machines, such as AGVs, autonomous forklifts, scissor lifts, etc. For example, the industrial machines 816, 818, 820 may implement the business and industrial equipment 163 of FIG. 1, the drones 165 of FIG. 1, the smart cities and building devices 166 of FIG. 1, etc. In some examples, the predictive maintenance system 824 may implement one or more computing devices, servers, etc., that identify maintenance alerts, fault predictions, etc., associated with equipment of the edge network environment 800 based on sensor data (e.g., prognostic health data). For example, the predictive maintenance system 824 may implement the business and industrial equipment 163 of FIG. 1, the smart cities and building devices 166 of FIG. 1, the sensors and IoT devices 167 of FIG. 1, etc.

In some examples, the vehicle 826 may implement one of the autonomous vehicles 161 of FIG. 1. In some examples, the first monitoring sensor 828 and/or the second monitoring sensor 830 are video cameras. For example, the first monitoring sensor 828 and/or the second monitoring sensor 830 may implement the business and industrial equipment 163 of FIG. 1, the video capture devices 164 of FIG. 1, the smart cities and building devices 166 of FIG. 1, the sensors and IoT devices 167 of FIG. 1, etc. Alternatively, the first monitoring sensor 828 and/or the second monitoring sensor 830 may implement a thermal camera (e.g., an infrared camera), an air pollution sensor, a carbon dioxide sensor, a temperature sensor, a humidity sensor, a motion sensor, an air pressure sensor, etc., or any other type of sensor. For example, the first monitoring sensor 828 and/or the second monitoring sensor 830 can be sensor(s) that monitor environment impacts (e.g., gas emissions, power consumption, temperature, etc.) associated with the edge network environment 800 and/or associated system(s), component(s), portion(s) thereof.

In this example, the endpoint devices 832, 834, 836 include a first example endpoint device 832, a second example endpoint device 834, and a third example endpoint device 836. In some examples, one(s) of the endpoint devices 832, 834, 836 may implement consumer computing devices, user equipment, etc. For example, one or more of the endpoint devices 832, 834, 836 may implement the user equipment 162 of FIG. 1. In some examples, one or more of the endpoint devices 832, 834, 836 may be implemented by a smartphone, a tablet computer, a desktop computer, a laptop computer, a wearable device (e.g., a headset or headset display, an augmented reality (AR) headset, a smartwatch, smart glasses, etc.), etc.

In the illustrated example of FIG. 8, the edge gateway 802 may facilitate communication, data transfers, etc., between different networks, such as communication from a source service, a source appliance, etc., of the public network 806 to a target service, a target appliance, etc., of the private network 808. For example, the edge gateway 802 may receive a data stream including one or more data packets from a source (e.g., a data source), a producer (e.g., a data producer), etc. In some examples, the edge gateway 802 may receive the data stream from the vehicle 826, the second endpoint device 834, the third endpoint device 836, etc., to be transmitted to a target service, a target appliance, etc., which may be implemented by the cloud data center 130 of FIG. 1, the cloud data center 245 of FIG. 2, the cloud or data center 360 of FIG. 3, etc.

In some examples, the edge gateway 802 may facilitate communication, data transfers, etc., between a source service, a source appliance, etc., of the private network 808 to a target service, a target appliance, etc., of the public network 806. For example, the edge gateway 802 may receive a data stream including one or more data packets from a source (e.g., a data source), a producer (e.g., a data producer), etc., which may be implemented by the cloud data center 130 of FIG. 1, the cloud data center 245 of FIG. 2, the cloud or data center 360 of FIG. 3, etc. In some examples, the edge gateway 802 may receive the data stream from the cloud data center 130 of FIG. 1, the cloud data center 245 of FIG. 2, the cloud or data center 360 of FIG. 3, etc., to be transmitted to the vehicle 826, the second endpoint device 834, the third endpoint device 836, etc.

In the illustrated example of FIG. 8, the edge switch 804 may facilitate communication, data transfers, etc., between different sources and targets within a network, such as communication from a source service, a source appliance, etc., of the private network 808 to a target service, a target appliance, etc., of the private network 808. For example, the edge switch 804 may receive a data stream from the edge gateway 802, the edge cloud 810, the process control system 812, one(s) of the robots 814, one(s) of the industrial machines 816, 818, 820, 822, the predictive maintenance system 824 (or sensor(s) thereof), the first monitoring sensor 828, the second monitoring sensor 830, the first endpoint device 832, the second endpoint device 834, the third endpoint device 836, etc. In some examples, the edge switch 804 may transmit the data stream to a destination within the private network 808. For example, the edge switch 804 may transmit the data stream to at least one of the edge gateway 802, the edge cloud 810, the process control system 812, one(s) of the robots 814, one(s) of the industrial machines 816, 818, 820, 822, the predictive maintenance system 824 (or sensor(s) thereof), the vehicle 826, the first monitoring sensor 828, the second monitoring sensor 830, the first endpoint device 832, the second endpoint device 834, or the third endpoint device 836.

In some examples, the edge gateway 802 and/or the edge switch 804 may implement adaptive data management based on global observability at the edge, which may be implemented by the edge network environment 800 or portion(s) thereof. In some examples, the edge network environment 800 may implement a large number and/or different types of applications, such as machine vision applications implemented by the robots 814, autonomous driving applications implemented by the vehicle 826, etc. In some examples, the data generated by the private network 808 is relatively diverse because of the vast range of data sources, such as sensors, controllers, services, and/or user input that may be processed and analyzed to identify anomalies and trends in the data. For example, the edge gateway 802 and/or the edge switch 804 may facilitate the transmission of data including sensor data or measurements, video feeds, still images, predictive maintenance alerts or control commands, robotic control commands, etc., and/or a combination thereof.

In some examples, the edge gateway 802 and/or the edge switch 804 may transfer data to components of the ADM system 600 of FIG. 6 to execute one(s) of the algorithms 638 to implement ADM as disclosed herein. In some examples, the edge gateway 802 and/or the edge switch 804 may execute the one(s) of the algorithms 638 to implement ADM as disclosed herein. In some examples, there are a plurality of the edge gateways 802 and/or a plurality of the edge switches 804 in the edge network environment 800. The algorithms 638 may be executed in multiple places of the edge network environment 800 (e.g., by ones of the edge gateways 802, the edge switches 804, etc., or any other device(s)). In some examples, the different ones of the edge gateways 802, the edge switches 804, etc., may have more or less observability based on the data that they process and/or otherwise encounter. Accordingly, two different ones of the devices of FIG. 8 may develop, train, and/or otherwise generate different one(s) of the algorithms 638 based on the data processed by each of the different ones of the devices. For example, a first one of the edge switches 804 may observe 10% of the edge network environment 800 and a second one of the edge switches 804 may observe 90% of the edge network environment 800, which may become the basis for the differences in data outputs generated by the algorithms 638 executed by the first and second one of the devices. In some examples, the first one of the devices may transmit and/or otherwise propagate data outputs from its execution of the algorithms 638 to the second one of the devices. In some examples, the second one of the devices may transmit and/or otherwise propagate model outputs from its execution of the algorithms 638 to the first one of the devices for cross-training and/or cross-correlation of the algorithms 638.

In some examples, data generated by the private network 808 may be immense. In some examples, a data source, such as the process control system 812, one(s) of the robots 814, one(s) of the industrial machines 816, 818, 820, 822, the predictive maintenance system 824 (or sensor(s) thereof), the vehicle 826, the first monitoring sensor 828, the second monitoring sensor 830, the first endpoint device 832, the second endpoint device 834, and/or the third endpoint device 836, may have insufficient computing resources (e.g., one or more processors, one or more accelerators, one or more memories, one or more mass storage discs, etc.) to analyze the data generated by the data source. In some examples, the data source may be unable to identify redundant data, less important or less significant data, etc., due to insufficient computing resources and therefore may flood the private network 808 with a significant quantity of data at relatively short intervals. Advantageously, the edge gateway 802, the edge switch 804, and/or, more generally, the ADM system 600 of FIG. 6, may implement ADM as disclosed herein to effectuate data collection balancing for sustainable storage. For example, the edge gateway 802, the edge switch 804, and/or, more generally, the ADM system 600 of FIG. 6, can effectuate green data management by identifying redundant or non-critical (e.g., non-relevant, not useful, etc.) data for deletion, reducing a quantity of resources (e.g., compute, storage, network, etc., resources) required to process data in the edge network environment 800, etc., and/or otherwise reduce power consumption in connection with a compute or network environment, such as the edge network environment 800. For example, the edge gateway 802, the edge switch 804, and/or, more generally, the ADM system 600 of FIG. 6, can identify intentions of a policy (e.g., an SLA, a QoS policy, etc.) to achieve green goals, objectives, or targets and select operations to be carried out by node(s) of the edge network environment 800 to achieve and/or otherwise satisfy the identified intentions of the policy.

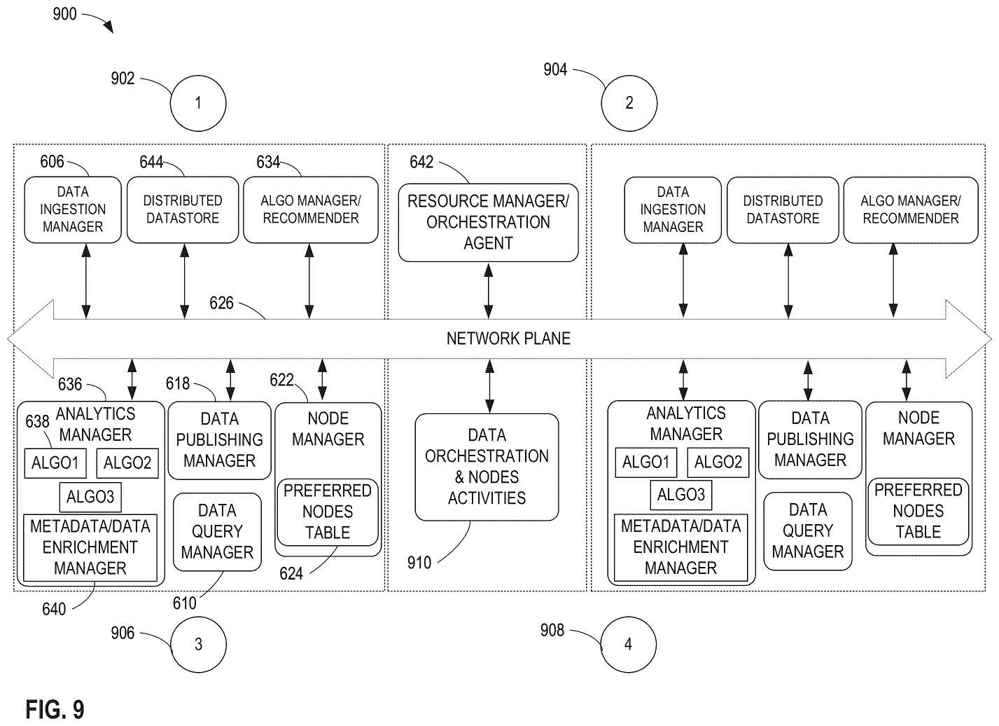

FIG. 9 is a block diagram of an example portion 900 of the example ADM system 600 of FIG. 6 to effectuate data collection balancing for sustainable storage. The portion 900 of the illustrated example is a system including the data ingestion manager 606, the data query manager 610, the data publishing manager 618, the node manager 622, the preferred nodes table 624, the network plane 626, the AMR 634, the analytics manager 636, the algorithms 638, the metadata/data enrichment manager 640, the resource manager/orchestration agent 642, and the distributed datastore 644 of FIG. 6.

In the illustrated example, the portion 900 of the ADM system 600 can implement a first example operation 902 (identified by a circle that encloses “1”), a second example operation 904 (identified by a circle that encloses “2”), a third example operation 906 (identified by a circle that encloses “3”), and a fourth example operation 908 (identified by a circle that encloses “4”). During the first operation 902, the data ingestion manager 606 may capture data from the data sources 604. The data ingestion manager 606 may pre-process the data by metadata tagging with data management settings (e.g., a locality or location of the data, expiration date, a source of the data, a type of the data, etc.). The AMR 634 may monitor the data on the network plane 626 and/or invoke the distributed datastore 644 to execute analytics using a model (e.g., an AI/ML model, a data graph model, etc.). The AMR 634 may synchronize with the resource manager/orchestration agent 642 to identify new one(s) of the algorithms 638 that may be executed and/or instantiated at a node. For example, the AMR 634 can provide metadata associated with ingested data to the resource manager/orchestration agent 642. In some examples, the resource manager/orchestration agent 642 can identify an AI/ML model that corresponds to the metadata and provide the AI/ML model to the AMR 634 for execution and/or instantiation at the node to execute a workload associated with the ingested data or data to be subsequently ingested.

During the second operation 904, the resource manager/orchestration agent 642 can identify criteria for global decisions (e.g., decisions, policies or policy determinations, etc., that may be applicable to a substantial or entire portion of an environment), provide guidance on the criteria, and/or execute resource management and/or orchestration of resources (e.g., hardware, software, and/or firmware resources) of the ADM system 600. In some examples, the resource manager/orchestration agent 642 can orchestrate resources and allocate different one(s) of the algorithms 638, select preferred node(s) of the preferred nodes table 624 to monitor, etc., and/or combination(s) thereof. In some examples, the resource manager/orchestration agent 642 can orchestrate a new one of the algorithms 638 to be provided from an algorithm library based on algorithm ratings, scores, etc., if available, or point to a local datastore (if available locally) for faster access.

During the third operation 906, the analytics manager 636 monitors data from the data sources 604 for further processing. For example, the analytics manager 636 can learn data quality and/or data criticality for an observation period and associate with at least one of location, action recognition, type, data, size, owner, classification tags, frequency of appearance, etc., and/or combination(s) thereof. In some examples, the analytics manager 636 can utilize symbolic representation of events, objects, etc., to reduce storage size. For example, the analytics manager 636 may replace data, such as sensor or video data (or portion(s) thereof), with placeholder data, filler data, etc., that may be indicative of the sensor or video data (or portion(s) thereof) having been ingested, stored, processed, and/or utilized. Advantageously, the reduction in storage size can effectuate green data management by reducing a quantity of resources to implement the ADM system 600, power consumption, etc. In some examples, the analytics manager 636 can continuously evaluate ingested data and/or stored data to establish a ground truth (e.g., a normalcy data usage, a baseline, etc.) over time. In some examples, the analytics manager 636 can update node activities and publish data to data subscribers. For example, the analytics manager 636 can provide determinations, insights, outputs, etc., to a node and cause the node to carry out, perform, and/or otherwise execute an action or activity at the node based on the determinations, insights, outputs, etc. For example, the analytics manager 636 can provide an output, such as a detection of an animal in front of an autonomous vehicle, and cause an action to be performed at the node, which can include avoidance detection of the animal based on the detection.

During the fourth operation 908, the portion 900 of the ADM system 600, and/or, more generally, the ADM system 600, can implement example data orchestration and nodes activities 910. Example activities, actions, operations, tasks, etc., can include green or environmentally-aware data management by aggregating data based on filtering and/or correlation of data. Example activities, operations, tasks, etc., can include identifying and removing duplicate data, retaining relevant and/or critical data, etc., to implement context-aware data management. Example activities, actions, operations, tasks, etc., can include energy efficient data collection to check active, idle nodes, and/or sink nodes. Example activities, actions, operations, tasks, etc., can include enabling real-time heatmaps on areas having special/meaningful data for different categories of events. Example activities, actions, operations, tasks, etc., can include topically optimized data locality to implement privacy policies at local nodes, conform to regulatory requirements (e.g., state or local, country, government, etc., regulations, ordinances, laws, etc.), and/or operate with improved compute efficiency by reducing an amount of data to be uploaded to a higher or upper tier of a network (e.g., an edge layer, a cloud or data center layer, etc.).

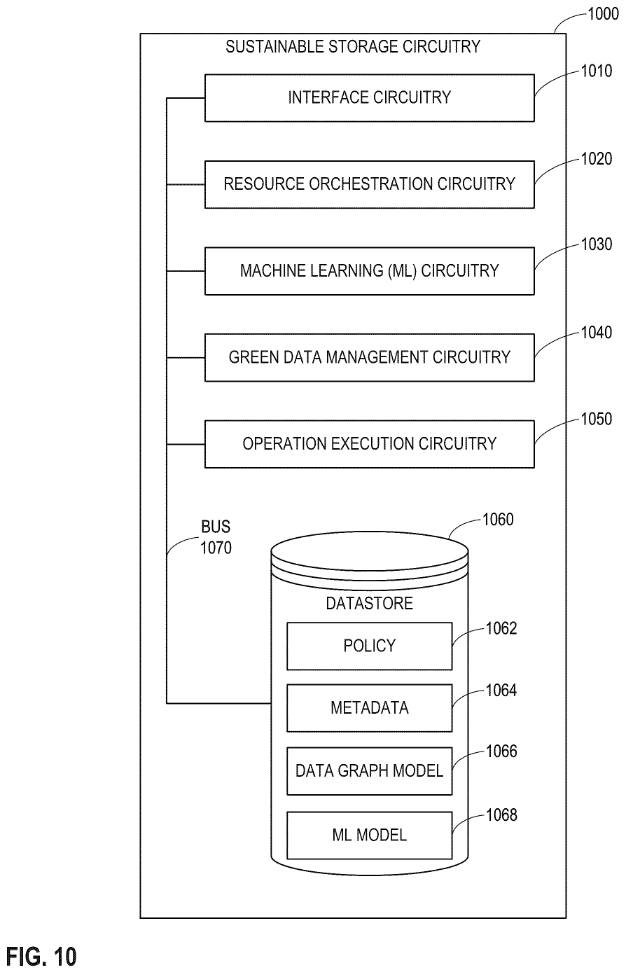

FIG. 10 is a block diagram of sustainable storage circuitry 1000 to effectuate data collection balancing for sustainable storage. Alternatively, the sustainable storage circuitry 1000 can be referred to as sustainable circuitry, green management circuitry, green data circuitry, green data management circuitry, green data management output circuitry, and/or environment impact circuitry. The sustainable storage circuitry 1000 of FIG. 10 may be instantiated (e.g., creating an instance of, bring into being for any length of time, materialize, implement, etc.) by processor circuitry such as a central processing unit executing instructions. Additionally or alternatively, the sustainable storage circuitry 1000 of FIG. 10 may be instantiated (e.g., creating an instance of, bring into being for any length of time, materialize, implement, etc.) by an ASIC or an FPGA structured to perform operations corresponding to the instructions. It should be understood that some or all of the sustainable storage circuitry 1000 of FIG. 10 may, thus, be instantiated at the same or different times. Some or all of the sustainable storage circuitry 1000 may be instantiated, for example, in one or more threads executing concurrently on hardware and/or in series on hardware. Moreover, in some examples, some or all of the sustainable storage circuitry 1000 of FIG. 10 may be implemented by one or more virtual machines and/or containers executing on the microprocessor.

In some examples, the sustainable storage circuitry 1000 can be implemented by and/or otherwise included in one(s) of the endpoint data sources 160 of FIG. 1. In some examples, the sustainable storage circuitry 1000 can be implemented by and/or otherwise included in the edge cloud 110, the central office 120, the cloud data center 130, the access point or base station 140, and/or the local processing hub 150 of FIG. 1.

In some examples, the sustainable storage circuitry 1000 can execute and/or otherwise implement green data management to reduce environment impacts (e.g., power consumption, electronic waste, electromagnetic pollution, etc.) of edge environments. For example, the sustainable storage circuitry 1000 can generate output(s) representative of reducing electronic waste and/or improvements in recycling efforts. In some examples, the sustainable circuitry 1000 can generate output(s) representative of reducing electronic waste by alerting personnel (e.g., IT personnel, supply chain personnel, etc.) that additional resources (e.g., compute, storage, security, acceleration, etc., resources) are not needed or necessary because excess resource capacity is identified (e.g., identified based on the ingested data or current utilization of resource(s), etc.). In some examples, the sustainable storage circuitry 1000 can generate output(s) representative of improving recycling efforts by alerting personnel (e.g., IT personnel, supply chain personnel, etc.) that there are excess resources (e.g., compute, storage, security, acceleration, etc., resources), energy inefficient resources, obsolete resources, etc., in an environment that can be identified for recycling through sustainable processes that reduce environment impacts. For example, the sustainable storage circuitry 1000 can identify a hardware resource, such as one or more CPUs in a server of the edge network environment 800, that is energy inefficient and can be replaced with an energy efficient resource.

In some examples, the sustainable storage circuitry 1000 can be a portion or a part of a larger system, environment, or collection of hardware, software, and/or firmware that can effectuate green data management. For example, the sustainable storage circuitry 1000 can effectuate green data management by generating output(s) that reduce (e.g., directly reduce) environment impacts. In some examples, the sustainable storage circuitry 1000 can effectuate green data management by generating output(s) that, when ingested as input(s) by other hardware, software, and/or firmware, can cause the other hardware, software, and/or firmware to reduce environment impacts. For example, the sustainable storage circuitry 1000 can effectuate green data management either directly or indirectly (e.g., through other hardware, software, and/or firmware). The sustainable storage circuitry 1000 of the illustrated example includes example interface circuitry 1010, example resource orchestration circuitry 1020, example machine learning (ML) circuitry 1030, example green data management circuitry 1040, example operation execution circuitry 1050, an example datastore 1060, and an example bus 1070. The datastore 1060 of the illustrated example includes an example policy 1062, example metadata 1064, an example data graph model 1066, and an example ML model 1068.

In the illustrated example of FIG. 10, the interface circuitry 1010, the resource orchestration circuitry 1020, the ML circuitry 1030, the green data management circuitry 1040, the operation execution circuitry 1050, and the datastore 1060 are in communication with one(s) of each other via the bus 1070. For example, the bus 1070 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 1070 can be implemented by any other type of computing or electrical bus.

The sustainable storage circuitry 1000 of the illustrated example includes the interface circuitry 1010 to receive and/or ingest data that is generated and/or otherwise produced in an environment, such as the edge network environment 800 of FIG. 8. In some examples, the interface circuitry 1010 can implement the pre-processing manager 608, and/or, more generally, the data ingestion manager 606 of FIG. 6.

In some examples, the interface circuitry 1010 ingests data from a data source, such as the data sources 604 of FIG. 6. In some examples, the interface circuitry 1010 ingests data from a data source at a node, such as the logical entity 601 of FIG. 1. In some examples, the interface circuitry 1010 tags portion(s) of the data with metadata. For example, the interface circuitry 1010 can generate metadata and associate the metadata with corresponding portion(s) of the data. In some examples, the interface circuitry 1010 queries an orchestrator for an ML model, such as one(s) of the algorithms 638, the ML model 1068, etc., that is associated with the metadata. For example, the interface circuitry 1010 can provide metadata to the resource manager/orchestration agent 642 of FIG. 6 and query the resource manager/orchestration agent 642 for one(s) of the algorithms 638 that is/are associated with the metadata.

The sustainable storage circuitry 1000 of the illustrated example includes the resource orchestration circuitry 1020 to orchestrate resources in an edge environment based on data. In some examples, the resource orchestration circuitry 1020 can implement the resource manager/orchestration agent 642 of FIG. 6.

In some examples, the resource orchestration circuitry 1020 obtains an orchestration policy indicative of at least one of a quantity or a type of workload(s) to be executed in an edge environment. For example, the policy 1062 can be an orchestration policy created, defined, and/or otherwise generated by an organization (e.g., a business entity or company, a hospital, a government or other regulatory department, a university, etc.). In some examples, the resource orchestration circuitry 1020 can generate the orchestration policy to include a quantity and/or type(s) of workloads to be executed by resources associated with the organization. For example, the resource orchestration circuitry 1020, and/or, more generally, the organization, can instantiate the edge network environment 800 to execute workloads (e.g., acceleration, compute, network, storage, etc., workloads). In some examples, the resource orchestration circuitry 1020, and/or, more generally, the organization, can generate the policy 1062 to be an orchestration policy that includes data, information, parameters, etc., that define type(s) of the workloads and/or an expected number of workloads to be executed during a time period (e.g., a number of workloads to be executed per hour, day, week, month, year, etc.). In some examples, the resource orchestration circuitry 1020, and/or, more generally, the organization, can generate the policy 1062 to determine a number and/or type of resources (e.g., hardware, software, and/or firmware resources) to execute the quantity and/or type(s) of workloads. In some examples, the resource orchestration circuitry 1020, and/or, more generally, the organization, can generate the policy 1062 to define quality-of-service requirements (e.g., latency, throughput, etc., requirements), regulatory requirements, service level agreements (SLAs), etc., and/or any combination(s) thereof, that is/are to be satisfied to effectively run the organization.

In some examples, the resource orchestration circuitry 1020 can determine that the types of workloads include acceleration workloads such as AI/ML workloads, image or video processing, AR/VR processing, etc. In some examples, the resource orchestration circuitry 1020 can determine that the types of workloads include compute workloads such as sensor data processing workloads, productivity software (e.g., database, word processing, slide presentation, spreadsheet generation, etc., software), etc. In some examples, the resource orchestration circuitry 1020 can determine that the types of workloads include network workloads such as receiving/transmitting data in a network, virtual resource migration (e.g., moving data or applications from a first VM or container to a second VM or container, etc.). In some examples, the resource orchestration circuitry 1020 can determine that the types of workloads include storage workloads such as storing data in a datastore (e.g., the distributed datastore 644), a database, etc.

In some examples, the resource orchestration circuitry 1020 instantiates resources in an edge environment to execute workload(s) based on an orchestration policy. For example, the resource orchestration circuitry 1020 can allocate and/or otherwise deploy acceleration, compute, network, security, storage, etc., resources to execute workloads in the edge network environment 800. In some examples, the resource orchestration circuitry 1020 generates a topology associated with the resources to at least one of execute a workload or route data in the edge environment with the resources. For example, the resource orchestration circuitry 1020 can generate a network topology associated with a plurality of resources by creating connections (e.g., communication connections, network connections, etc.) between one(s) of the plurality of the resources to one(s) of each other.

In some examples, the resource orchestration circuitry 1020 identifies one or more nodes as preferred nodes in an edge environment based on a topology. For example, the resource orchestration circuitry 1020 can identify one or more nodes as preferred nodes in the preferred nodes table 624 of FIG. 6. In some examples, the resource orchestration circuitry 1020 can identify the one or more nodes as preferred nodes to execute a workload in connection with adjacent, neighboring, and/or otherwise surrounding nodes. For example, the resource orchestration circuitry 1020 can cause resources of the one or more nodes to execute workload(s) For example, the resource orchestration circuitry 1020 can identify the edge cloud 810 of FIG. 8 as a preferred node, which can cause the edge cloud 810 to execute an AI/ML workload (e.g., offload the AI/ML workload from a sensor, other node(s), etc.) based on video data obtained from the first monitoring sensor 828 and/or the second monitoring sensor 830. In some examples, the resource orchestration circuitry 1020 deploys ML model(s), such as one(s) of the algorithms 638 and/or the ML model 1068, at a node to determine at least one of a first value of data criticality or a second value of data quality of data ingested at the node (or a different node), stored in the distributed datastore 644 or locally at the node (or a group of nodes that may include the node).

The sustainable storage circuitry 1000 of the illustrated example includes the ML circuitry 1030 to execute a ML model. In some examples, the ML circuitry 1030 executes the ML model 1068 with resources (e.g., acceleration, compute, storage, network, security, etc., resources, software resources, firmware resources, etc.) to generate outputs including at least one of a first value representative of data criticality or a second value representative of data quality of data (e.g., ingested and/or stored at a node).

In some examples, the ML circuitry 1030 executes the ML model 1068 in a training phase or an inference phase. For example, during a training phase, the ML circuitry 1030 can obtain training data associated with an observation period. In some examples, during the training phase, the ML circuitry 1030 can execute the ML model 1068 using the training data to generate outputs representative of baseline data for data criticality and/or data quality.

In some examples, the ML circuitry 1030 determines to execute the ML model 1068 during an inference phase. For example, the ML circuitry 1030 can provide ingested data, or portion(s) thereof, to the ML model 1068 as inputs (e.g., data inputs, model inputs, etc.) to generate outputs (e.g., data outputs, model outputs, etc.), which can be decisions, determinations, insights, etc. For example, the ML circuitry 1030 can execute the ML model 1068 with ingested data to generate an output, which can be indicative and/or otherwise representative of a decision or determination to update baseline data based on the ingested data. In some examples, the ML circuitry 1030 can determine to update portion(s) of baseline data, such as change, update, and/or otherwise adjust metadata associated with baseline data. For example, the ML circuitry 1030 can update metadata associated with baseline data by changing a first value of data criticality, a second value of data quality, etc., that can be included in the metadata.

In some examples, the ML circuitry 1030 can tag ingested data to undergo green data management operations. For example, the ML circuitry 1030, in response to a determination not to update baseline data in view of an output of the ML model 1068 based on ingested data, can determine to annotate, assign, and/or otherwise tag the ingested data for one or more green data management operations. In some examples, the ML circuitry 1030 can add metadata to the ingested data that, in response to being added, can invoke the green data management circuitry 1040 to process the ingested data. For example, the green data management circuitry 1040 can discard the ingested data, or portion(s) thereof, to reduce storage resources needed to effectuate the ADM system 600 of FIG. 6, the edge network environment 800 of FIG. 8, etc.

In some examples, the ML circuitry 1030 determines a value of data criticality based on at least one of training data or ingested data. For example, the ML circuitry 1030 can execute the ML model 1068 to determine a value of data criticality based on training data (e.g., using training data during a training phase) or inference data (e.g., using ingested data during an inference phase). In some examples, the ML circuitry 1030 can execute the ML model 1068 with one or more inputs, such as at least one of identification(s) of potential consequence(s) if the data is not processed or stored, identification(s) of a service level agreement associated with the data (e.g., a service level agreement defining bandwidth requirements, latency requirements, throughput requirements, etc.), a determination of a number of nodes in the edge network environment 800 that are associated with the data, identification(s) of a purpose of a workload associated with the data, determination(s) of a priority of the data (e.g., QoS or SLA requirements indicative of data priority for the transmission, handling, and/or otherwise processing of the data), or identification(s) of regulatory requirement(s) (e.g., local, state, country, and/or international ordinances, regulations, statutes, laws, treaties, etc.) associated with the data. In some examples, the ML circuitry 1030 can execute the ML model 1068 with the one or more inputs to determine a value of data criticality.

In some examples, the ML circuitry 1030 determines a value of data quality based on at least one of training data or ingested data. For example, the ML circuitry 1030 can execute the ML model 1068 to determine a value of data quality based on training data (e.g., using training data during a training phase) or inference data (e.g., using ingested data during an inference phase). In some examples, the ML circuitry 1030 can execute the ML model 1068 with one or more inputs, such as an accuracy of the data, a completeness of the data, a consistency of the data, a currency of the data, a redundancy of the data in the edge network environment 800, a timeliness of the data, or a validity of the data. For example, the ML circuitry 1030 can execute the ML model 1068 with the one or more inputs to generate an output, which can include a determination of a value of data quality based on the one or more inputs.

In some examples, the ML circuitry 1030 can execute the ML model 1068 to determine an accuracy of data (e.g., ingested or stored data at a node). For example, the ML circuitry 1030 can determine an accuracy of the data based on whether the data reflects actual, real-world scenarios or events. In some examples, the ML circuitry 1030 can compare the data to baseline data or other ground truth data to determine an accuracy of the data.

In some examples, the ML circuitry 1030 can execute the ML model 1068 to determine a completeness of data (e.g., ingested or stored data at a node). For example, the ML circuitry 1030 can determine a completeness of the data based on a measure of an ability of the data to effectively deliver all of the required values that are available.

In some examples, the ML circuitry 1030 can execute the ML model 1068 to determine a consistency of data (e.g., ingested or stored data at a node). For example, the ML circuitry 1030 can determine a consistency of the data based on a measure of uniformity of data as the data moves across devices, networks, applications, etc. In some examples, the ML circuitry 1030 can determine the consistency of the data based on whether values of the data are the same or different (e.g., conflict) in different locations. For example, the ML circuitry 1030 can determine that ingested data is not consistent because a first value of a parameter ingested at a node disagrees and/or otherwise is different from a second value of the parameter previously ingested at the node. In some examples, the ML circuitry 1030 can determine that the ingested data is consistent because the first value of the parameter is the same or within a defined tolerance or difference of the second value of the parameter.

In some examples, the ML circuitry 1030 can execute the ML model 1068 to determine a currency of data (e.g., ingested or stored data at a node). For example, the ML circuitry 1030 can determine a currency of the data based on whether the data is stale or newly ingested. In some examples, the ML circuitry 1030 can determine that the data is not current based on a timestamp associated with the data and that the data is to be either discarded (e.g., the timestamp is greater than or older than a threshold) or stored (e.g., the timestamp is less than or newer than a threshold).

In some examples, the ML circuitry 1030 can execute the ML model 1068 to determine a redundancy of data (e.g., ingested or stored data at a node). For example, the ML circuitry 1030 can determine a redundancy of the data based on uniqueness. For example, the ML circuitry 1030 can determine that the data is not unique (e.g., there are duplicates or overlaps of values of the data across data sets) or unique (e.g., there are no duplicates or overlaps of values of the data across data sets).

In some examples, the ML circuitry 1030 can execute the ML model 1068 to determine a timeliness of data (e.g., ingested or stored data at a node). For example, the ML circuitry 1030 can determine a timeliness of the data based on whether the data is available when it is required. For example, the ML circuitry 1030 can determine that the data is made available for ingestion in substantially real time to ensure that the data is readily available and accessible for ingestion and processing. For example, data associated with an autonomous guided vehicle operation can have a substantially high level of timeliness (e.g., data is to be generated and/or ingested immediately) while data associated with a storage backup can have lesser level of timeliness (e.g., data is to be updated every hour, day, week, etc.).

In some examples, the ML circuitry 1030 can execute the ML model 1068 to determine a validity of data (e.g., ingested or stored data at a node). For example, the ML circuitry 1030 can determine a validity of the data based on whether the data is collected according to defined data collection rules, policies, etc., and whether the data conforms to the right (or expected) format and/or falls within the right (or expected) range.

The sustainable storage circuitry 1000 of the illustrated example includes the green data management circuitry 1040 to reduce resource requirements of an environment (e.g., the edge network environment 800) to effectuate green data management based on outputs from the ML model 1068. In some examples, the green data management circuitry 1040 carries out green data management by aggregating data at node(s) based on at least one of filtering or correlation using data graph model(s). For example, the green data management circuitry 1040 can aggregate, combine, and/or otherwise merge data stored at one or more nodes by instantiating and/or generating the data graph model 1066. In some examples, the green data management circuitry 1040 can reduce the quantity of data by replacing portion(s) of the data itself with metadata that can be expressed by the data graph model 1066.

In some examples, the green data management circuitry 1040 can effectuate green data management by replacing and/or substituting data (or portion(s) thereof) with a compressed or reduced data footprint representation. For example, the green data management circuitry 1040 can achieve (e.g., directly achieve) a green data management result at a node by replacing data at the node with symbolic, placeholder, or filler data to reduce an environment (or environmental) footprint of the original data. By way of example, the green data management circuitry 1040 can replace first data having a first data size (or first data footprint with an associated first environment footprint), such as sensor or video data (or portion(s) thereof), with second data having a second data size (or second data footprint with an associated second environment footprint). In some examples, the second data size can be less than the first data size. In some examples, the second data footprint (e.g., a count, number, or quantity of storage resources) can be less than the first data footprint (e.g., a count, number, or quantity of storage resources). In some examples, the second environment footprint (e.g., power consumption, electromagnetic pollution, trapped carbon, etc.) is less than the first environment footprint (e.g., power consumption, electromagnetic pollution, trapped carbon, etc.). In some examples, the second data can be placeholder data, filler data, etc. For example, the second data may be data symbols, identifiers, metadata, etc., indicative of the first data (or portion(s) thereof) as having been ingested, stored, processed, and/or utilized in an environment.

In some examples, the green data management circuitry 1040 removes duplicate data based on the data graph model 1066. For example, the green data management circuitry 1040 can compare first metadata associated with ingested data to second metadata associated with data of the data graph model 1066. In some examples, in response to a determination that the first metadata matches (e.g., completely matches, partially matches, etc.) the second metadata, the green data management circuitry 1040 can update the data graph model 1066 and/or discard the ingested data. For example, the green data management circuitry 1040 can increase or decrease a length of a vector (e.g., a strength vector) of the data graph model 1066. In some examples, the green data management circuitry 1040 can increase or decrease an angle of the vector of the data graph model 1066.

In some examples, the green data management circuitry 1040 can retain relevant and critical data based on the data graph model 1066. For example, the green data management circuitry 1040 can determine that first metadata associated with ingested data does not match second metadata associated with the data graph model 1066. In some examples, in response to a determination that the first metadata does not match the second metadata, the green data management circuitry 1040 can store the ingested data because the ingested data has not been stored before, is unique data, etc., and/or any combination(s) thereof.

In some examples, the green data management circuitry 1040 identifies a resource utilization of a node. For example, the green data management circuitry 1040 can determine an acceleration utilization (e.g., a percentage or number of acceleration resources of a node that are utilized) compute utilization (e.g., a percentage or number of compute resources of a node that are utilized), a storage utilization (e.g., a percentage or number of storage resources of a node that are utilized), a network utilization (e.g., a percentage or number of network interface resources of a node that are utilized), etc., and/or any combination(s) thereof. In some examples, in response to a determination that a utilization of a node is below a threshold (e.g., a compute utilization of 10% of a node is below a threshold of 40% compute utilization), the green data management circuitry 1040 can identify the node to be transitioned to a reduced power state (e.g., a sleep state, a power off state, a disabled state, etc.). For example, the green data management circuitry 1040 can offload workloads from the node to a different node and instruct the node to power down because the node is being underutilized in an effort to reduce power consumption of a system.

In some examples, in response to a determination that a utilization of a node is above a threshold (e.g., a network utilization of 90% of a node is above a threshold of 75% network utilization), the green data management circuitry 1040 can reduce the utilization through at least one of a reduction in redundant data processing or a rerouting of data processing to underutilized nodes. For example, the green data management circuitry 1040 can instruct the node (e.g., the logical entity 601, a node associated with the edge network environment 800, etc.) to discard ingested data that has metadata associated with data already stored or previously processed by the node. In some examples, the node can reduce resources needed to process the ingested data by discarding the ingested data in response to a determination that the ingested data is irrelevant data, redundant data, and/or the like. In some examples, the green data management circuitry 1040 can reroute newly ingested data to a different underutilized node (e.g., a node associated with the logical entity 601, a preferred node in the preferred nodes table 624, etc.) to achieve reduced utilization of the overutilized node.

In some examples, green data management circuitry 1040 can effectuate green data management by directly and/or indirectly causing a node to achieve a green data management result or output, such as transitioning to a reduced environment impact state. For example, green data management may refer to decision making or result determination that achieves a goal, target, or outcome to reduce environment impacts of network environments (e.g., the edge network environment 800 of FIG. 8). Advantageously, by achieving reduction(s) in environment impacts, the green data management circuitry 1040 can execute workload(s) (e.g., computing and/or electronic workload(s)) based on environment sustainability principles, such as operating with net zero (or approximately net zero) environment impact.

In some examples, the green data management circuitry 1040 can effectuate green data management by directly causing a node to achieve reduced environment impact. For example, the green data management circuitry 1040 can generate an output, such as an output from the ML model 1068, that is representative of an action, operation, task, etc., that, when carried out by a node, causes the node to reduce an environment impact of the node. For example, the green data management circuitry 1040 can generate the output to be representative of an action by a node to transition to a reduced power state. In some examples, the green data management circuitry 1040 can generate the output to be representative of an operation by the node to identify resource intensive workload(s) that can be deferred for execution during off-peak times for electric demand usage. In some examples, the green data management circuitry 1040 can generate the output to be representative of a task for the first industrial machine 816 to complete in a first area so that the second industrial machine 818 in a second area does not waste resources (e.g., compute resources, energy resources, etc.) to move from the second area to the first area to perform the task. In some examples, the green data management circuitry 1040 can generate the output to be an input for the resource orchestration circuitry 1020 to orchestrate and/or otherwise control deployment or operation of resources in the edge network environment 800.

In some examples, the green data management circuitry 1040 can facilitate green data management by indirectly causing a node to achieve reduced environment impact. In some examples, the green data management circuitry 1040 can facilitate green data management by ingesting and/or processing data that may be provided as input(s) to one or more intervening operations, processes, routines, etc., that lead to a green result or outcome. For example, the green data management circuitry 1040 can generate an output, such as an output from the ML model 1068, that is representative of an input (e.g., a data input, a numerical input, a dimensionless input, a parameter, a consideration, etc.) to a decision making process or routine of a node to generate an output. By way of example, the green data management circuitry 1040 can ingest temperature data of an area of the edge network environment 800 from the first monitoring sensor 828. The green data management circuitry 1040 can provide the temperature data as input(s) (e.g., data input(s)) to the predictive maintenance system 824. The predictive maintenance system 824 may utilize the temperature data as input(s) to a predictive fault monitoring model. The predictive maintenance system 824 may determine, based on an output from the predictive fault monitoring model, that a heating, ventilation, and air conditioning (HVAC) system associated with the area of the edge network environment 800 is operating beyond typical thresholds and is thereby causing increased environment impact. The predictive maintenance system 824 may identify operations of the edge network environment 800, such as operations of the robots 814, that may be deferred or rescheduled for a different time of day (e.g., rescheduled from daytime to nighttime) to reduce a load of the HVAC system and thereby achieve reduced environment impact. By way of this example, the green data management circuitry 1040 may facilitate the achievement of a green result or outcome (e.g., a beneficial result or outcome with respect to the environment) by indirectly causing the predictive maintenance system 824 to take an action based on ingested data by the green data management circuitry 1040.

In some examples, the green data management circuitry 1040 effectuates green data management by achieving favorable results or outcomes with respect to the environment, which may be referred to as green results or outcomes (e.g., green data management results or outcomes). For example, the green data management circuitry 1040, and/or, more generally, the sustainable storage circuitry 1000, may perform a decision making or result determination process that yields and/or otherwise leads to outputs that, when processed directly and/or indirectly, causes improvements in environment impacts. For example, environment impacts can include a reduction in power consumption, a reduction in resources (e.g., a reduction in compute, storage, network, etc., resources), an efficient utilization of resources (e.g., reducing resource utilization at peak energy demand times and increasing resource utilization at off-peak energy demand times, etc.), etc., and/or any combination(s) thereof. In some examples, the green data management circuitry 1040, and/or, more generally, the sustainable storage circuitry 1000, may effectuate green data management by operating in a first state (e.g., a first state of resource(s)) that has a reduced environment impact while achieving the same, improved, or substantially similar results that a second state of operation (e.g., a second state of resource(s)) yields, and the second state of operation has an increased environment impact with respect to the first state of operation. For example, the green data management circuitry 1040 can effectuate and/or otherwise put into effect or force green data management by satisfying the policy 1062 with reduced environment impact, such as with reduced power consumption, reduced number of needed resources, improved utilization of resources, consistent utilization of resources (e.g., reschedule tasks at overloaded nodes from peak times to off-peak times), etc., and/or any combination(s) thereof.

The sustainable storage circuitry 1000 of the illustrated example includes the operation execution circuitry 1050 to cause operation(s) at node(s) of an edge environment based on data (e.g., data ingested, processed, and/or stored at one or more nodes). In some examples, the operation execution circuitry 1050 can invoke the ML circuitry 1030 to execute the ML model 1068 to generate output(s) based on input, such as ingested data (e.g., sensor data or any other type of data generated or produced in a network environment). For example, the output(s) can include at least one of first output(s) representative of object detection (e.g., a detection of a person, animal, device, object, etc.), second output(s) representative of object classification (e.g., an identification and/or a classification of a type and/or description of a person, animal, device, object, etc.), third output(s) representative of object tracking (e.g., maintain an object identifier in addition to a motion and/or velocity vector that defines a path of motion of a person, animal, device, object, etc.), fourth output(s) representative of key performance indicators (KPIs) or other parameters or metrics, or fifth output(s) representative of parameters or metrics associated with an environment based on the policy 1062. In some examples, the operation execution circuitry 1050 can generate a command, direction, an instruction, etc., that, when obtained by a node, causes the node to carry out an operation at the node based on at least one of the first output(s), the second output(s), the third output(s), the fourth output(s), or the fifth output(s). For example, the operation execution circuitry 1050 can command an autonomous guided vehicle to avoid an object in response to a detection of the object based on sensor data of the autonomous guided vehicle or a different node associated with the autonomous guided vehicle. In some examples, the operation execution circuitry 1050 generates an alert and transmits the alert to the node or different node(s) to cause the operation(s) to be executed.

The sustainable storage circuitry 1000 of the illustrated example includes the datastore 1060 to record data, such as the policy 1062, the metadata 1064, the data graph model 1066, the ML model 1068, and/or the like. In some examples, the ML model 1068 is a neural network model. Additionally and/or alternatively, the ML model 1068 may be any other type of AI/ML model. In some examples, the policy 1062 is representative of, corresponds to, and/or otherwise includes intents (or intentions), goals, objectives, targets, etc. For example, the policy 1062 can be generated by an ML model, such as the ML model 1608, or by a user (e.g., an IT manager, an HR manager, a developer, a system architect, etc.) to carry out intentions on how data is to be ingested, stored, and/or otherwise processed to achieve reduced environment impacts. In some examples, the policy 1062 can include data (e.g., data objects, metadata, etc.) that, when analyzed by the sustainable storage circuitry 1000, can carry out operations to effectuate, facilitate, and/or otherwise carry out green data management in accordance with the intentions or desires of the creator of the policy 1062.

In some examples, the interface circuitry 1010 can determine that an intention of the policy 1062 includes techniques or processes to ingest data from the data sources 604 with reduced environment impact (e.g., tag the ingested data with metadata to indicate that the ingested data is duplicative or not needed for storage, etc.). In some examples, the resource orchestration circuitry 1020 can identify an intention of the policy 1062 as representative of how the resource orchestration circuitry 1020 is to orchestrate and/or otherwise instantiate resources in the edge network environment 800 to achieve green data management (e.g., reduce a count of resources to be deployed in the edge network environment 800 to satisfy an SLA with reduced environment impacts, etc.). In some examples, the ML circuitry 1030 can provide intentions or desires of the policy 1062 as input(s) to the ML model 1068 to generate output(s), which can include actions, determinations, etc., to cause nodes in the edge network environment 800 to operate with reduced environment impact. In some examples, the green data management circuitry 1040 can extract intentions from the policy 1062 from which the green data management circuitry 1040 can determine how to reduce environment impact of a system (e.g., reduce storage resources, replace sensor data with symbolic or placeholder data, reduce power consumption, reschedule workloads for off-peak energy demand times, etc.), such as the edge network environment 800.

In some examples, the operation execution circuitry 1050 can identify intentions of the policy 1062 for achievements in green data management, and identify operations that can be carried out to result in the achievements. For example, the operation execution circuitry 1050 can identify an operation out of a plurality of possible or potential operations with each of the plurality of the possible or potential operations having a particular environment impact. In some examples, the operation execution circuitry 1050 can determine that the identified operation has a particular environment impact that is less than a threshold (e.g., an environment impact threshold) while one(s) of the others have an environment impact that is greater than a threshold (e.g., an environment impact threshold). For example, the operation execution circuitry 1050 can identify an operation to be carried out by a node to achieve an intention of the policy 1062 to have an environment impact that is less than and/or approximately to an environment impact threshold. Advantageously, the operation execution circuitry 1050 can select an operation out of a plurality of possible operations to be carried out by a node to achieve an intention of the policy 1062 to achieve green goals, targets, or objectives.

In some examples, the resource orchestration policy 1020 can determine an intent of the policy 1062 to reduce environment impact, the intent associated with a threshold value of environment impact. In some examples, the ML circuitry 1030 can execute the ML model 1068 with the intent as data input(s) to generate data output(s), which can include a value of environment impact associated with an operation. In some examples, the operation execution circuitry 1050 can, in response to a determination that the value satisfies the threshold value (e.g., the value is less than the threshold value and thereby satisfies it in this example), selecting the operation to be performed at one or more nodes.

In some examples, the datastore 1060 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 1060 may additionally or alternatively be implemented by one or more double data rate (DDR) memories, such as DDR, DDR2, DDR3, DDR4, DDR5, mobile DDR (mDDR), DDR SDRAM, etc. The datastore 1060 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 1060 is illustrated as a single datastore, the datastore 1060 may be implemented by any number and/or type(s) of databases. Furthermore, the data stored in the datastore 1060 may be in any data format such as, for example, binary data, comma delimited data, tab delimited data, structured query language (SQL) structures, etc. In some examples, the datastore 1060 can implement one or more databases of data. The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

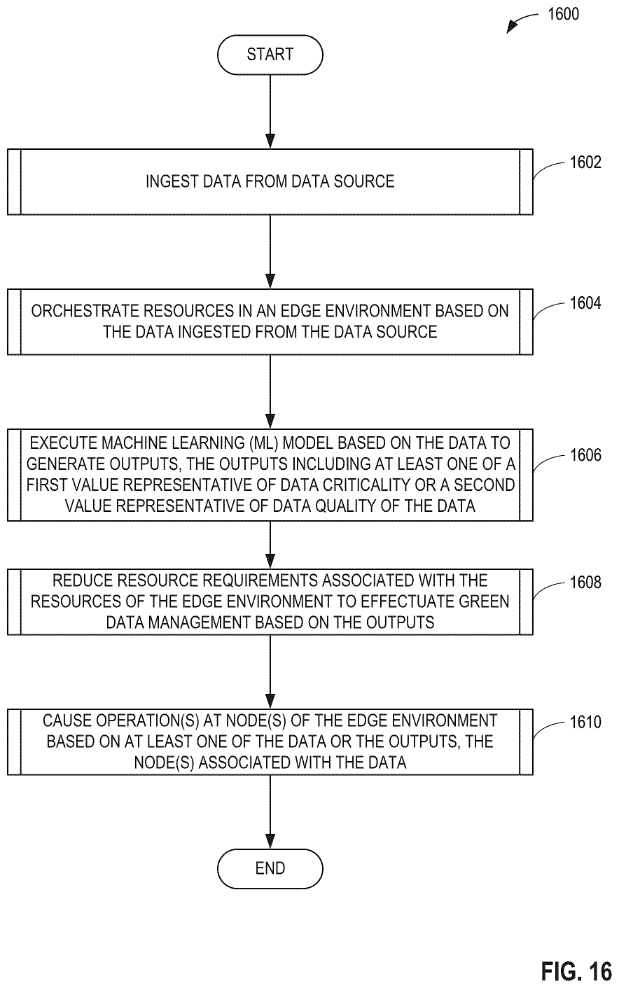

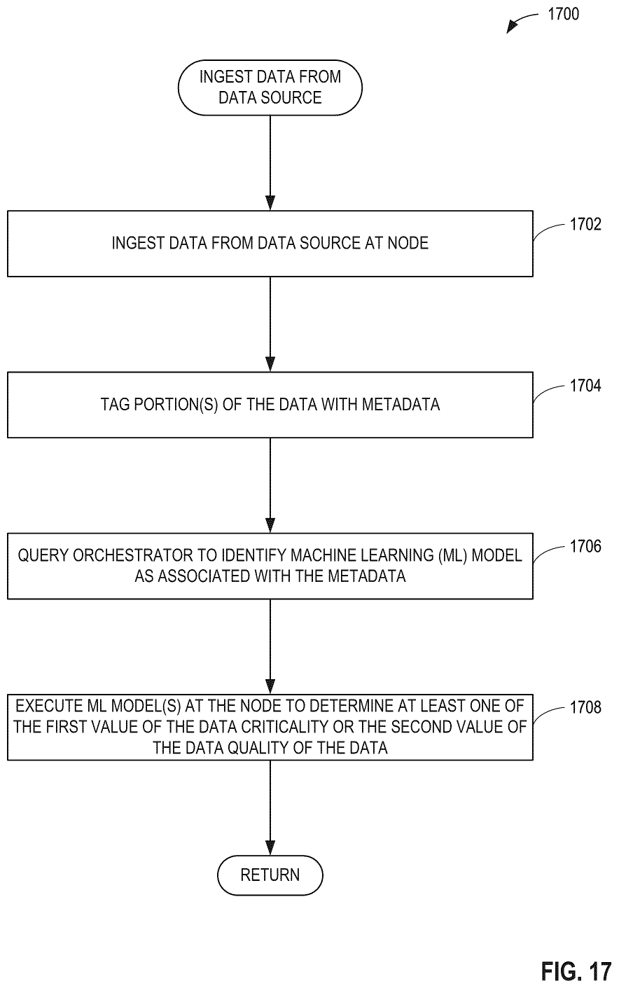

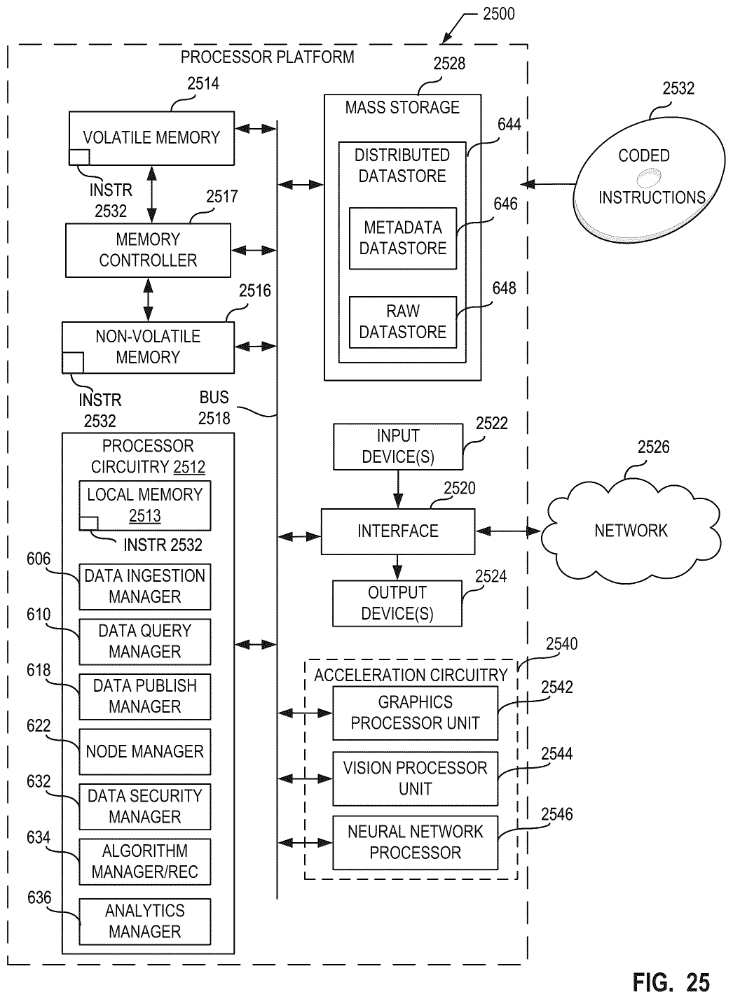

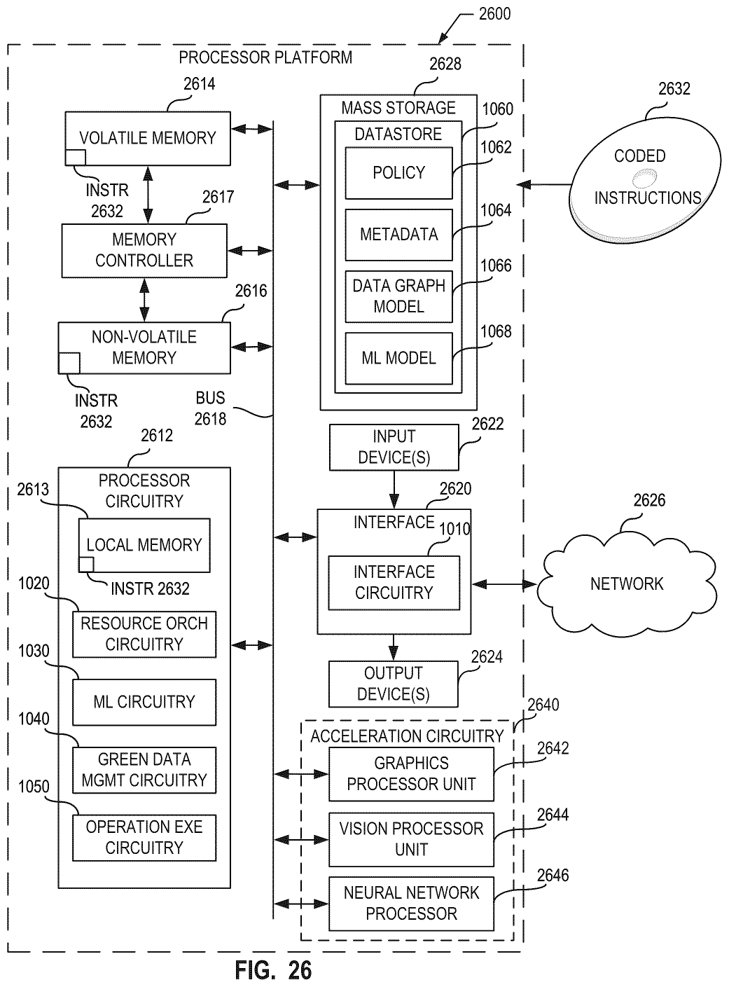

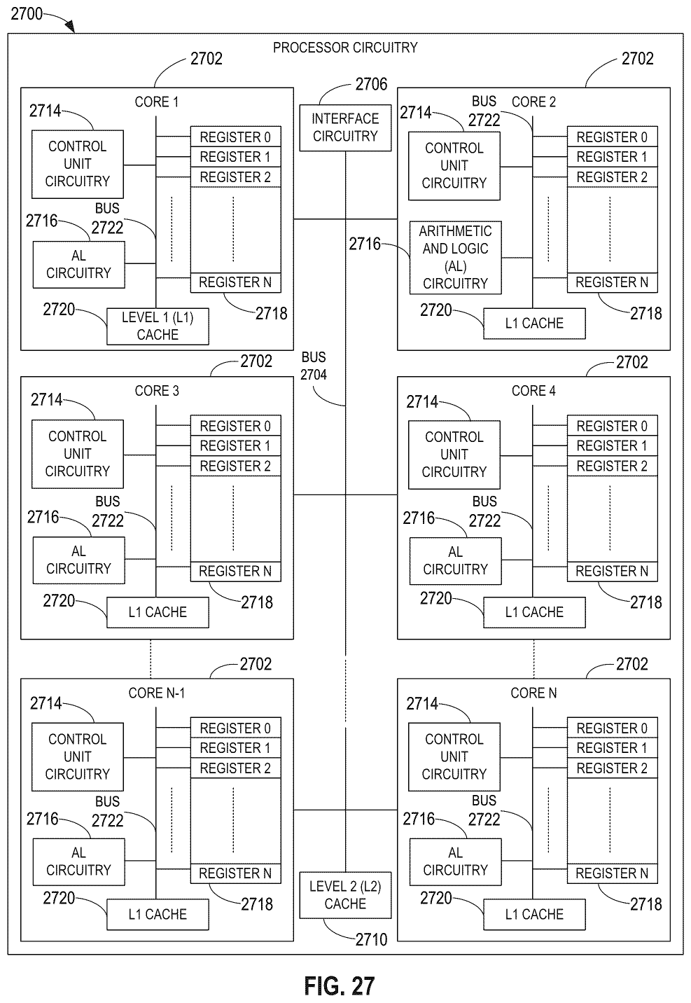

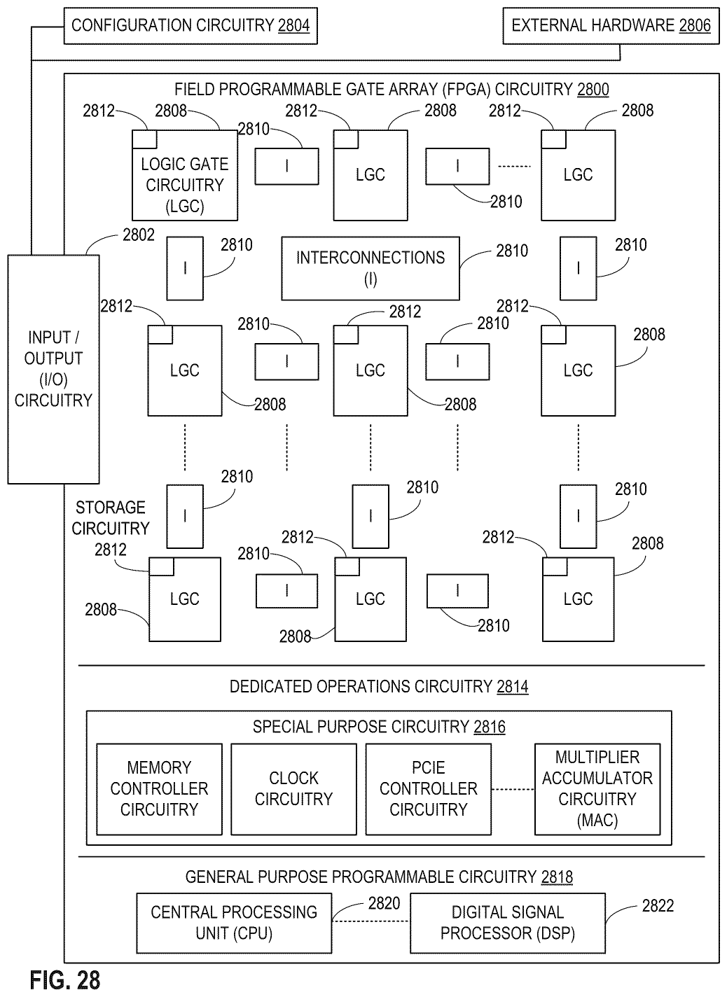

In some examples, the apparatus includes means for ingesting data from a data source. For example, the means for ingesting may be implemented by the interface circuitry 1010. In some examples, the interface circuitry 1010 may be instantiated by processor circuitry such as the example processor circuitry 2512 of FIG. 25 and/or the example processor circuitry 2612 of FIG. 26. For instance, the interface circuitry 1010 may be instantiated by the example general purpose processor circuitry 2700 of FIG. 27 executing machine executable instructions such as that implemented by at least blocks 1602 of FIG. 16 and/or blocks 1702, 1704, 1706 of FIG. 17. In some examples, the interface circuitry 1010 may be instantiated by hardware logic circuitry, which may be implemented by an ASIC, XPU, or the FPGA circuitry 2800 of FIG. 28 structured to perform operations corresponding to the machine readable instructions. Additionally or alternatively, the interface circuitry 1010 may be instantiated by any other combination of hardware, software, and/or firmware. For example, the interface circuitry 1010 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for ingesting is to ingest data from multiple ones (e.g., a plurality of ones) of data sources at one or more nodes, the multiple ones of the data sources including a data source. In some examples, the means for ingesting is to tag a portion of the data with metadata. In some examples, the means for ingesting is to query an orchestrator to identify a machine learning model as associated with metadata. In some examples, the means for ingesting is to execute the machine learning model at the one or more nodes to determine at least one of a first value of data criticality or a second value of data quality of the data.

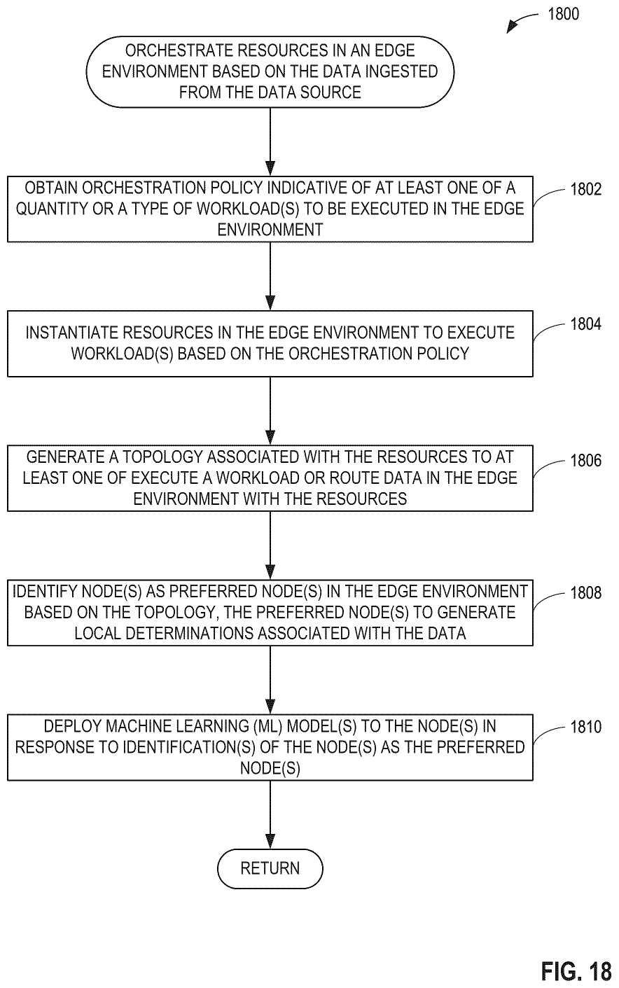

In some examples, the apparatus includes means for orchestrating resources in an edge environment based on data ingested from one or more data sources. For example, the means for orchestrating may be implemented by the resource orchestration circuitry 1020. In some examples, the resource orchestration circuitry 1020 may be instantiated by processor circuitry such as the example processor circuitry 2512 of FIG. 25 and/or the example processor circuitry 2612 of FIG. 26. For instance, the resource orchestration circuitry 1020 may be instantiated by the example general purpose processor circuitry 2700 of FIG. 27 executing machine executable instructions such as that implemented by at least block 1604 of FIG. 16 and/or blocks 1802, 1804, 1806, 1808, 1810 of FIG. 18. In some examples, the resource orchestration circuitry 1020 may be instantiated by hardware logic circuitry, which may be implemented by an ASIC, XPU, or the FPGA circuitry 2800 of FIG. 28 structured to perform operations corresponding to the machine readable instructions. Additionally or alternatively, the resource orchestration circuitry 1020 may be instantiated by any other combination of hardware, software, and/or firmware. For example, the resource orchestration circuitry 1020 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for orchestrating is to obtain an orchestration policy indicative of at least one of a quantity or a type of workloads to be executed in an edge environment. In some examples, the means for orchestrating is to instantiate resources in the edge environment to execute a workload based on the orchestration policy, the resources including at least one of compute resources or network resources. In some examples, the means for orchestrating is to generate a topology associated with the resources to at least one of execute the workload with one or more of the compute resources or route data in the edge environment with one or more of the network resources. In some examples, the means for orchestrating is to identify one or more nodes as one or more preferred nodes in the edge environment based on the topology, the one or more preferred nodes to generate local determinations associated with the data. In some examples, the means for orchestrating is to deploy a machine learning model to the one or more nodes in response to an identification of the one or more nodes as the one or more preferred nodes.

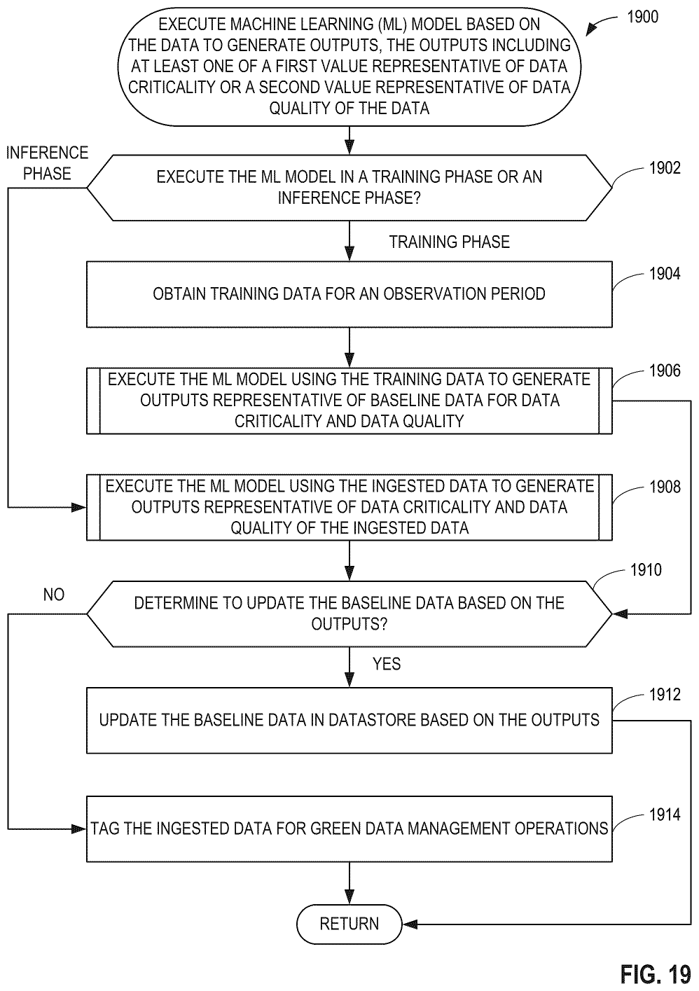

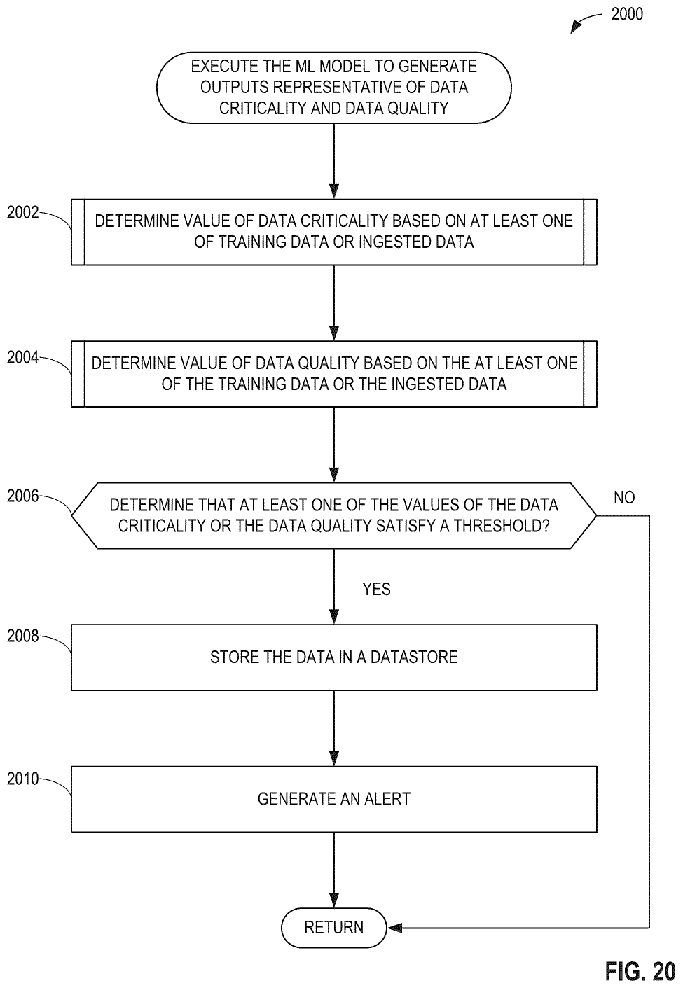

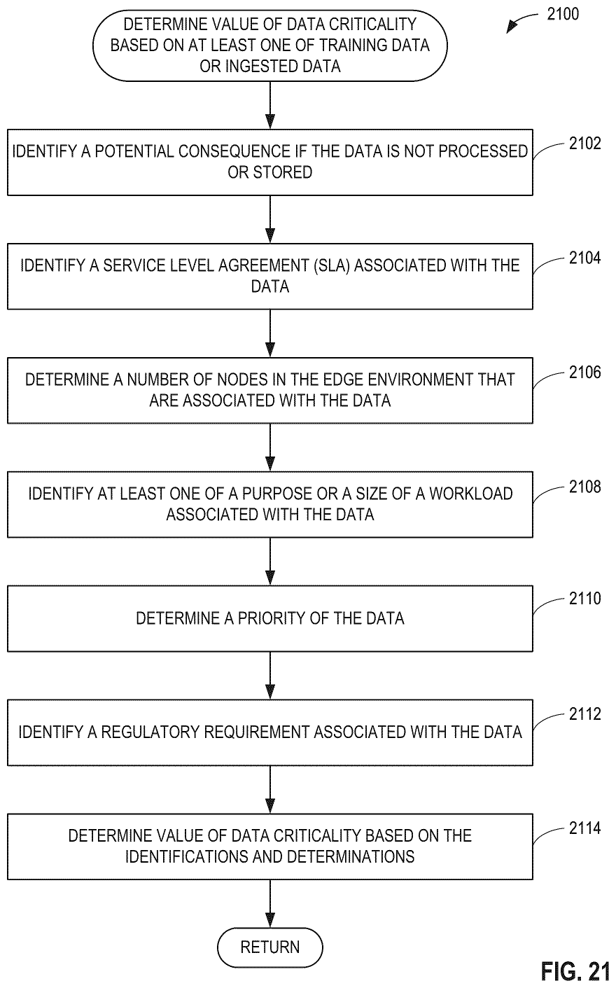

In some examples, the apparatus includes means for executing a machine learning (ML) model based on data to generate outputs. In some examples, the outputs include at least one of a first value representative of data criticality or a second value representative of data quality of the data. For example, the means for executing may be implemented by the ML circuitry 1030. In some examples, the ML circuitry 1030 may be instantiated by processor circuitry such as the example processor circuitry 2512 of FIG. 25 and/or the example processor circuitry 2612 of FIG. 26. For instance, the ML circuitry 1030 may be instantiated by the example general purpose processor circuitry 2700 of FIG. 27 executing machine executable instructions such as that implemented by at least block 1606 of FIG. 16, block 1708 of FIG. 17, blocks 1902, 1904, 1906, 1908, 1910, 1912, 1914 of FIG. 19, blocks 2002, 2004, 2006, 2008, 2010 of FIG. 20, blocks 2102, 2104, 2106, 2108, 2110, 2112, 2114 of FIG. 21, and/or blocks 2202, 2204, 2206, 2208, 2210, 2212, 2214. In some examples, the ML circuitry 1030 may be instantiated by hardware logic circuitry, which may be implemented by an ASIC, XPU, or the FPGA circuitry 2800 of FIG. 28 structured to perform operations corresponding to the machine readable instructions. Additionally or alternatively, the ML circuitry 1030 may be instantiated by any other combination of hardware, software, and/or firmware. For example, the ML circuitry 1030 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for executing is to determine at least one of a potential consequence if data is not processed or stored, a latency requirement associated with the data, a number of nodes in an edge environment that are associated with the data, a purpose of a workload associated with the data, a size of the workload, a priority of the data, or a regulatory requirement associated with the data. In some examples, the means for executing is to execute a machine learning model to determine a first value of data criticality of the data based on the at least one of the potential consequence, the latency requirement, the number of nodes, the purpose, the priority, or the regulatory requirement.

In some examples, the means for executing is to determine at least one of an accuracy of data, a completeness of the data, a consistency of the data, a currency of the data, a redundancy of the data in an edge environment, a timeliness of the data, or a validity of the data. In some examples, the means for executing is to execute a machine learning model to determine a second value of data quality of the data based on at least one of the accuracy, the completeness, the consistency, the currency, the redundancy, the timeliness, or the validity. In some examples, the means for executing is to, in response to a determination that at least one of the first value or the second value satisfies a threshold, update baseline data or ground truth data stored in a datastore based on the data. In some examples, the means for executing is to, in response to a determination that the first value and the second value do not satisfy a threshold, tag the data for a green data management operation to effectuate green data management, the green data management operation including at least one of a discard of one or more portions of the data or a replacement of the one or more portions of the data with a symbolic representation (e.g., a placeholder representation, a filler representation, etc.) to reduce resource requirements associated with the one or more portions of the data.

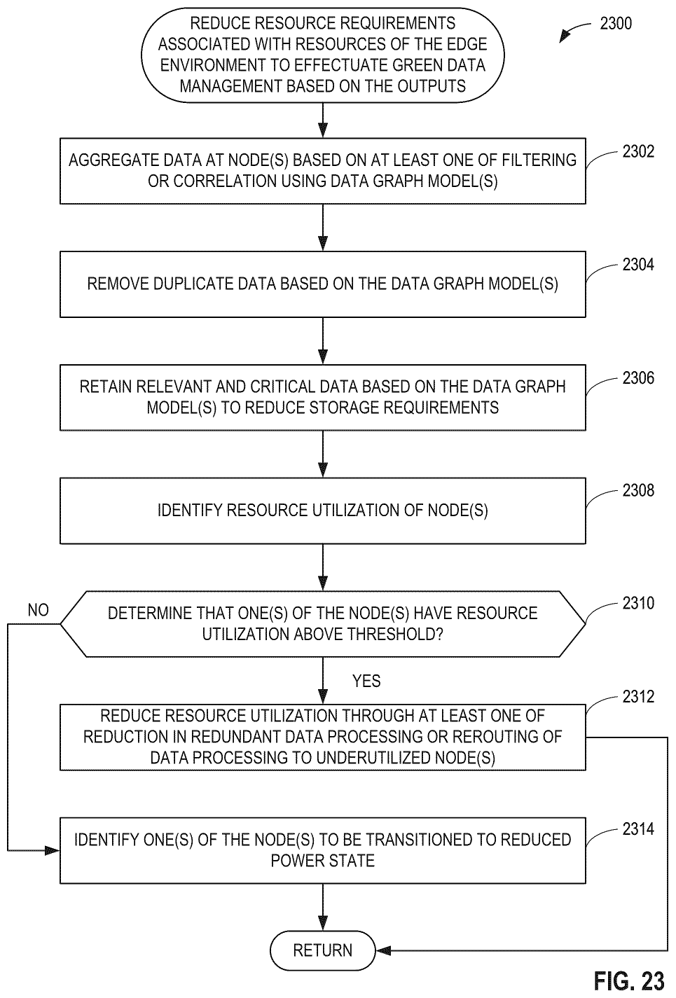

In some examples, the apparatus includes means for reducing resource requirements associated with resources of an edge environment to effectuate green data management based on the outputs. For example, the means for reducing may be implemented by the green data management circuitry 1040. In some examples, the green data management circuitry 1040 may be instantiated by processor circuitry such as the example processor circuitry 2512 of FIG. 25 and/or the example processor circuitry 2612 of FIG. 26. For instance, the green data management circuitry 1040 may be instantiated by the example general purpose processor circuitry 2700 of FIG. 27 executing machine executable instructions such as that implemented by at least block 1608 of FIG. 16 and/or blocks 2302, 2304, 2306, 2308, 2310, 2312, 2314 of FIG. 23. In some examples, the green data management circuitry 1040 may be instantiated by hardware logic circuitry, which may be implemented by an ASIC, XPU, or the FPGA circuitry 2800 of FIG. 28 structured to perform operations corresponding to the machine readable instructions. Additionally or alternatively, the green data management circuitry 1040 may be instantiated by any other combination of hardware, software, and/or firmware. For example, the green data management circuitry 1040 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples in which a node is a first node, the means for reducing is to determine a first resource utilization of the first node, and, in response to a determination that the first resource utilization satisfies a threshold, reduce the first resource utilization of the node through at least one of a reduction in ingesting new data or a rerouting of processing the new data to a second node with a second resource utilization less than the first resource utilization. In some examples, the means for reducing is to, in response to a determination that a resource utilization of a second node does not satisfy a threshold, identify the second node to be transitioned to a reduced power state to effectuate green data management.

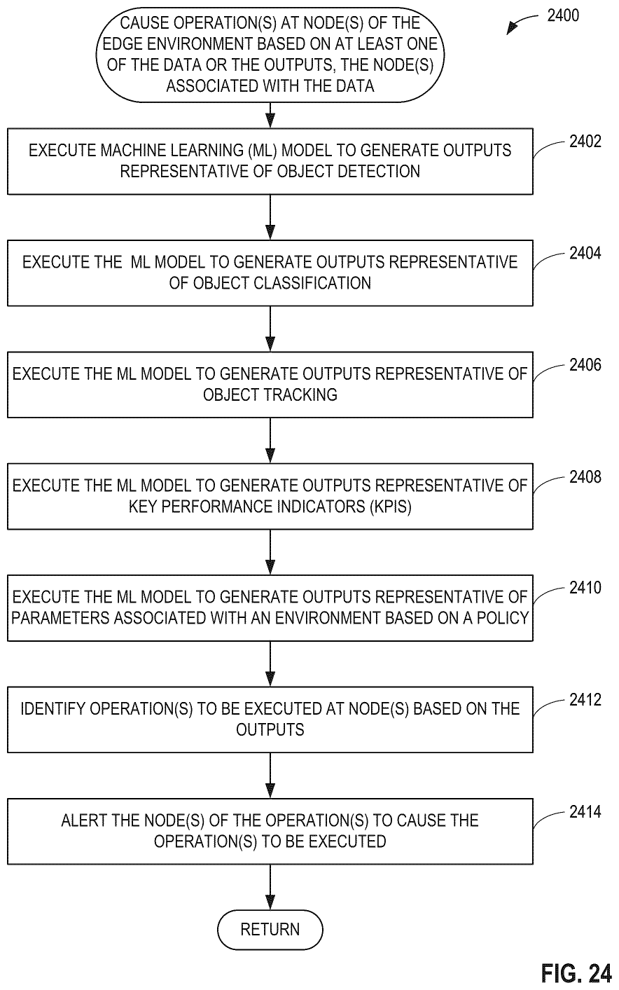

In some examples, the apparatus includes means for causing an operation at a node of an edge environment based on at least one of data (e.g., ingested data) or outputs (e.g., outputs from an ML model). In some examples, the data is associated with the node. For example, the means for causing may be implemented by the operation execution circuitry 1050. In some examples, the operation execution circuitry 1050 may be instantiated by processor circuitry such as the example processor circuitry 2512 of FIG. 25 and/or the example processor circuitry 2612 of FIG. 26. For instance, the operation execution circuitry 1050 may be instantiated by the example general purpose processor circuitry 2700 of FIG. 27 executing machine executable instructions such as that implemented by at least block 1610 of FIG. 16 and/or blocks 2412, 2414 of FIG. 24. In some examples, the operation execution circuitry 1050 may be instantiated by hardware logic circuitry, which may be implemented by an ASIC, XPU, or the FPGA circuitry 2800 of FIG. 28 structured to perform operations corresponding to the machine readable instructions. Additionally or alternatively, the operation execution circuitry 1050 may be instantiated by any other combination of hardware, software, and/or firmware. For example, the operation execution circuitry 1050 may be implemented by at least one or more hardware circuits (e.g., processor circuitry, discrete and/or integrated analog and/or digital circuitry, an FPGA, an ASIC, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the ADM system 600 of FIG. 6 is illustrated in FIG. 10, one or more of the elements, processes, and/or devices illustrated in FIG. 10 may be combined, divided, re-arranged, omitted, eliminated, and/or implemented in any other way. Further, the example interface circuitry 1010, the example resource orchestration circuitry 1020, the example ML circuitry 1030, the example green data management circuitry 1040, the example operation execution circuitry 1050, the example datastore 1060, the example bus 1070, and/or, more generally, the example ADM system 600 of FIG. 6, may be implemented by hardware alone or by hardware in combination with software and/or firmware. Thus, for example, any of the example interface circuitry 1010, the example resource orchestration circuitry 1020, the example ML circuitry 1030, the example green data management circuitry 1040, the example operation execution circuitry 1050, the example datastore 1060, the example bus 1070, and/or, more generally, the example ADM system 600 of FIG. 6, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example ADM system 600 of FIG. 6 may include one or more elements, processes, and/or devices in addition to, or instead of, those illustrated in FIG. 10, and/or may include more than one of any or all of the illustrated elements, processes and devices.

FIG. 11 is an illustration of a first example graph model 1102 and a second example graph model 1104 for depicting groups of related data (e.g., ingested data, stored data, etc.) and metadata connected linked via example strength vectors 1105, 1107. In some examples, at least one of the first graph model 1102 or the second graph model 1104 can implement the data graph model 1066, or portion(s) thereof. In some examples, the first graph model 1102 and the second graph model 1104 are part of a third example graph model 1100.

In some examples, the first graph model 1102 and/or the second graph model 1104 is/are contextual data graph model(s). The first graph model 1102 includes a first example major node 1106, a first example adjacent node 1108, and a second example adjacent node 1110. The second graph model 1104 includes a second example major node 1112, a third example adjacent node 1114, a fourth example adjacent node 1116, and an example adjacent node grouping 1118. The patterns (e.g., solid, dotted, striped, hashed, etc.) of the various major nodes and adjacent nodes illustrated in FIG. 11 depict the various descriptors (e.g., keywords) of the metadata associated with raw data, ingested data, stored data, etc. stored in the distributed datastore 644 of FIG. 6, the datastore 1060 of FIG. 10, etc. The example adjacent nodes illustrated in FIG. 11 represent the metadata (e.g., the metadata 1064) associated with the ingested data, stored data, raw data etc. stored in the distributed datastore 644 of FIG. 6, the datastore 1060 of FIG. 10, etc. Additionally and/or alternatively, the graph models 1102, 1104 of metadata descriptors illustrated in FIG. 11 can represent raw data, ingested data, stored data, etc., stored in other memory or other storage devices in a cloud (e.g., the edge cloud 110, the cloud data center 130, etc.).

The lines connecting the major nodes 1106, 1112 to the adjacent nodes or the adjacent nodes to each other represent the strength vectors 1105, 1107 between the two nodes. In some examples, the strength vectors 1105, 1107 are of a single dimension and/or multiple dimensions and includes descriptors (e.g., keywords, similarity ratings (e.g., 1 through 5 with 1 being relatively not similar and 5 being substantially similar and/or identical, low/medium/high, etc.), characters, strings, numerical values, etc.) that represent how strongly the metadata of the raw data, ingested data, stored data, etc., match. In some examples, the length of the strength vectors 1105, 1107 shown in the illustrated example of FIG. 11 symbolize the level of commonality, similarity, association, etc., two connected nodes share with one another. In other words, the strength vector length can depict the correlation between two connected nodes based on how frequently descriptors (e.g., keywords, terms, numerical values, data types, data categories, etc.) appear in both connected nodes. For example, the metadata of the first adjacent node 1108 can have fewer matching data (e.g., descriptors, data blocks, etc.) with the metadata of the first major node 1106 than the metadata of the third adjacent node 1114 has with the second major node 1112. In some examples, the ML circuitry 1030, the green data management circuitry 1040, and/or, more generally, the sustainable storage circuitry 1000, can determine the number of matching metadata (e.g., metadata descriptors) that exists between adjacent nodes. The sustainable storage circuitry 1000 can the strength vector 1105, 1107 based on the amount of metadata descriptors that match (e.g., fully matching, partially matching, and/or not matching) between the adjacent nodes. The graph models described herein (e.g., the data graph model 1066, the first graph model 1102, the second graph model 1104, etc.) are formed and/or predicted based on the metadata descriptions (e.g., the metadata descriptors) because parsing through the contents of the raw data to find similarities would consume much more processing resources, memory bandwidth, and compute time than parsing through the metadata.

In some examples, the first major node 1106 and the second major node 1112 have the same metadata descriptors. In some examples, the weighting of (e.g., length of the strength vectors 1105, 1107 between) the adjacent nodes (e.g., the first adjacent node 1108, the third adjacent node 1114, etc.) provide context and associated metadata descriptors. In some examples, the provided context of the graph models 1102, 1104 are tailored to a particular department and/or discipline within a company, an organization, a group, etc. For example, the first major node 1106 and the second major node 1112 can both include metadata that describe the associated raw data as belonging to the design engineering department of a bicycle company. In some examples, the first adjacent node 1108 and the third adjacent node 1114 can both include metadata that describe the raw data as belonging to the gear design segment of the design engineering department. However, since the strength vector connecting the second major node 1112 to the third adjacent node 1114 is shorter than the strength vector connecting the first major node 1106 and the first adjacent node 1108, it can be inferred that and/or otherwise be indicative of the second graph model 1104 having a stronger association with the gear design segment of the design engineering department than does the first graph model 1102.

In some examples, the first major node 1106 and the second major node 1112 have different metadata descriptors but are connected to adjacent nodes with similar metadata. In some examples, there is an implication that the first major node 1106 and the second major node 1112 have the same contextual definition. A user and/or operator can establish the example contextual definitions prescriptively depending on the metadata associations in the graph model(s). Additionally or alternatively, the sustainable storage circuitry 1000 can perform predictions/operations/insights on the graph models 1102, 11104 to determine the contextual definitions based on events, task, and/or objects in common among adjacent nodes. In some examples, nodes of the graph models 1102, 1104 are grouped together such as an example grouping 1118 of the second graph model 1104. Example groupings of nodes can reinforce the contextual definition(s), descriptor(s), subject area(s), etc. of the major node (e.g., the second major node 1112).

In some examples, the term “to associate” is defined as to correlate, link, couple, and/or connect two or more datasets, data points, raw data, metadata, etc., in the form of a strength vector (e.g., the strength vectors 1105, 1107) based on similarities between the two or more datasets, data points, raw data, metadata, etc. By way of example, if a first metadata set has a sufficient number of same terms (e.g., over half of the total number of terms) as a second metadata set, then the strength vector is said to associate the first metadata and the second metadata. For example, if first raw data that the first metadata describes gets copied into storage on a different node, then the strength vector that associates the first metadata and the second metadata indicates to the sustainable storage circuitry 1000 that second raw data is also to be copied into the same storage on the same node as the first raw data.

In some examples, a dataset, data point, raw data, metadata, etc. are associated with the factors the sustainable storage circuitry 1000 determines as inputs to executed algorithms (e.g., one(s) of the algorithms 638 of FIG. 6, the ML model 1068 of FIG. 10, etc.). For example, if the sustainable storage circuitry 1000 recognizes a cyclical trend of cyclical events (e.g., a recurring usage (e.g., file opening, reading, manipulating, etc.) every month) of a raw dataset, then the sustainable storage circuitry 1000 can associate the cyclical trend with the raw dataset. In some examples, the sustainable storage circuitry 1000 can represent the cyclical trend in the form of a data block (e.g., a cyclical trend metadata block that includes a time (e.g., “monthly”, “30 days”, etc.) and an action (e.g., “read from”, “write new”, “remove data”, “manipulate existing”, etc.)) included in metadata of the raw dataset. Therefore, in some examples, if the sustainable storage circuitry 1000 analyzes the metadata of the raw data for a retention decision, the sustainable storage circuitry 1000 can factor the cyclical trend associated with the metadata/raw data into the analysis, prediction, learning, and/or retention decision.

In some examples, the term “association” refers to a correlation, linkage, coupling, and/or connection between two or more datasets, data points, raw data, metadata, etc. In some examples, a strength vector associating two adjacent nodes of a graph model can represent and/or define the association between the two adjacent nodes. In some examples, the sustainable storage circuitry 1000 determines factor(s) (e.g., uniqueness, retention cost, cyclical event, etc.) of ingested data and/or stored data, and the factor(s) is/are associated with the ingested data and/or the stored data for which the factor(s) were determined. By way of example, if first stored data (with associated first metadata) is found to have a uniqueness relative to second stored data (e.g., 1:2 ratio or 50 percent uniqueness), then the uniqueness associated with the first stored data is written into the first metadata (along with a storage location and/or an identifier of the stored data with which the uniqueness of the first data is compared (e.g., the second stored data)).

In some examples, the ML circuitry 1030, the green data management circuitry 1040, and/or, more generally, the sustainable storage circuitry 1000 can receive a stream of first metadata and/or first raw data and a stream of second metadata and/or second raw data to generate a first graph model (e.g., the data graph model 1066, the first graph model 1102, the second graph model 1104, etc.) and a second graph model (e.g., the data graph model 1066, the first graph model 1102, the second graph model 1104, etc.). The sustainable storage circuitry 1000 can contextually compress the first metadata and/or the second metadata that have correlating metadata and/or raw data content. In some examples, the sustainable storage circuitry 1000 can perform context and variance calculations on the adjacent node(s) of the first graph model and/or the second graph model (e.g., the data graph model 1066, the first graph model 1102, the second graph model 1104, etc.) to contextually compress (e.g., further reduce the number of nodes in) the graph model(s). The sustainable storage circuitry 1000 can convert the representative graph model(s) into first index table(s). The first index table(s) of the graph model representation(s) tabulate the raw data and/or the metadata that are depicted in the graph model(s). The sustainable storage circuitry 1000 can also generate second index table(s) including correlation factors between the first graph model and the second graph model. The sustainable storage circuitry 1000 can use the first index table(s) and/or the second index table(s) to execute learning, predictions, insights, operations, etc. on the ingested data, stored data, raw data, metadata, etc. that retain, move, modify, and/or discard the data being analyzed.

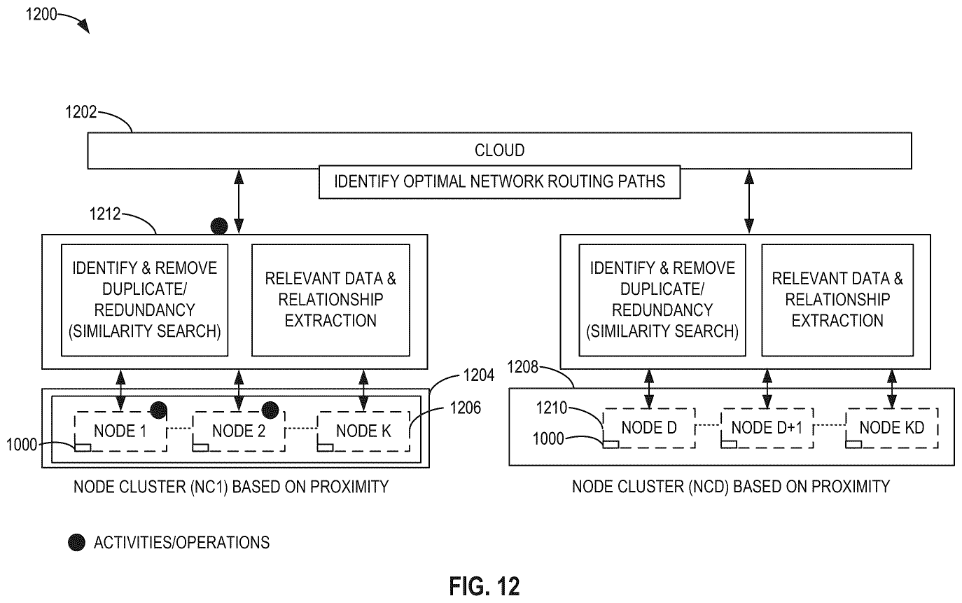

FIG. 12 is an illustration of a first example system 1200 to identify optimal network routing paths. The first system 1200 includes an example cloud 1202, a first example node cluster 1204 including first example nodes 1206, a second example node cluster 1208 including second example nodes 1210. In the illustrated example, the first nodes 1206 are arranged and/or otherwise associated with each other in the first cluster 1204 based on proximity (e.g., a physical location, a network location, etc.) to each other. Additionally and/or alternatively, the first nodes 1206 can be arranged in the first cluster 1204 based on any other factor. In some examples, one(s) of the first nodes 1206 can be implemented by the logical entity 601 of FIG. 6, or a node of the edge network environment 800 of FIG. 8. One(s) of the first nodes 1206 is/are in communication with one(s) of each other via any type of connection, such as a wired connection, a wireless connection, etc., and/or any combination(s) thereof. One(s) of the first nodes 1206 is/are in communication with the cloud 1202 via any type of connection, such as a wired connection, a wireless connection, etc., and/or any combination(s) thereof.

In the illustrated example, the second nodes 1210 are arranged and/or otherwise associated with each other in the second cluster 1208 based on proximity (e.g., a physical location, a network location, etc.) to each other. Additionally and/or alternatively, the second nodes 1210 can be arranged in the second cluster 1208 based on any other factor. In some examples, one(s) of the second nodes 1210 can be implemented by the logical entity 601 of FIG. 6, or a node of the edge network environment 800 of FIG. 8. One(s) of the second nodes 1210 is/are in communication with one(s) of each other via any type of connection, such as a wired connection, a wireless connection, etc., and/or any combination(s) thereof. One(s) of the second nodes 1210 is/are in communication with the cloud 1202 via any type of connection, such as a wired connection, a wireless connection, etc., and/or any combination(s) thereof.

In the illustrated example, each of the first nodes 1206 and the second nodes 1210 can include, implement, execute, and/or instantiate the sustainable storage circuitry 1000 of FIG. 10, or portion(s) thereof. In the illustrated example, the first nodes 1206 and the second nodes 1210 can execute example operations 1212. In the illustrated example, the operations 1212 include identifying and/or removing duplicate or redundant data based on a similarity search (e.g., a similarity search of the graph models 1102, 1104 of FIG. 11). The operations 1212 of the illustrated example include extracting relevant data and/or relationships. For example, the sustainable storage circuitry 1000 of a first one of the first nodes 1206 (identified by NODE 1) can identify and/or remove duplicate/redundant data, extract relevant data and/or data relationship(s), etc., and/or any combination(s) thereof.

By way of example, the first one of the first nodes 1206 and/or a second one of the first nodes 1206 (identified by NODE 2) can obtain sensor data, such as video data from the first monitoring sensor 828 of FIG. 8, and provide the sensor data to an ML model (e.g., the ML model 1068 of FIG. 10) to generate an output. For example, the output can be an identification of a specific object (e.g., a face of a person, a car, etc.), a detection of an anomaly or aberration, a tracking of an object (e.g., a pedestrian crossing, an animal walking, etc.), a determination of a parameter associated with an object (e.g., a vehicle speeding or committing a traffic violation), a parameter associated with an environment (e.g., a level of congestion of a road or highway, a hazard on or proximate to the road or highway, a person screaming in response to an adverse event, etc.), etc., and/or any combination(s) thereof.

In example operation, the first and/or the second one of the first nodes 1206 can execute and/or instantiate the sustainable storage circuitry 1000 to process the output via one(s) of the operations 1212. For example, the first and/or the second one of the first nodes 1206 can execute and/or instantiate the sustainable storage circuitry 1000 to identify and/or remove duplicative data (e.g., the video data may indicate a stale or unchanging scene or environment and is not needed for storage), extract relevant data and/or relationships (e.g., the video data may indicate that a detection of a pedestrian on a sidewalk is relevant to a moving vehicle approaching the pedestrian by way of a road near the sidewalk, etc.), etc., and/or any combination(s) thereof. In example operation, the first and/or the second one of the first nodes 1206 can execute and/or instantiate the sustainable storage circuitry 1000 can transmit the output at least one of the cloud 1202 or one(s) of the second nodes 1210 of the second cluster 1208.

In example operation, the first and/or the second one of the first nodes 1206 can execute and/or instantiate the sustainable storage circuitry 1000 to identify optimal network routing paths based on the output. For example, the first and/or the second one of the first nodes 1206 can execute and/or instantiate the sustainable storage circuitry 1000 to determine that the output is not associated and/or otherwise relevant to one(s) of the second nodes 1210 and thereby may prevent the transmission of the output and associated data to the one(s) of the second nodes 1210 to reduce network resources. In some examples, the first and/or the second one of the first nodes 1206 can execute and/or instantiate the sustainable storage circuitry 1000 to represent the output using symbolic representation (e.g., placeholder representation, filler representation, etc.) to reduce a size of data to be transmitted to the cloud 1202 and/or one(s) of the second nodes 1210. Advantageously, the first and/or the second one of the first nodes 1206 can execute and/or instantiate the sustainable storage circuitry 1000 to tie contextually relevant and supportive data together through a graph representation (e.g., the data graph model 1066, the graph models 1102, 1104, etc.). Advantageously, the first and/or the second one of the first nodes 1206 can execute and/or instantiate the sustainable storage circuitry 1000 to use these relationships to stage content proximity across a network and identify optimal network routing paths based on data traffic (e.g., nominal data traffic) by identifying most and least used routes and selecting the least used routes to reduce network bottlenecks when propagating data through a network.

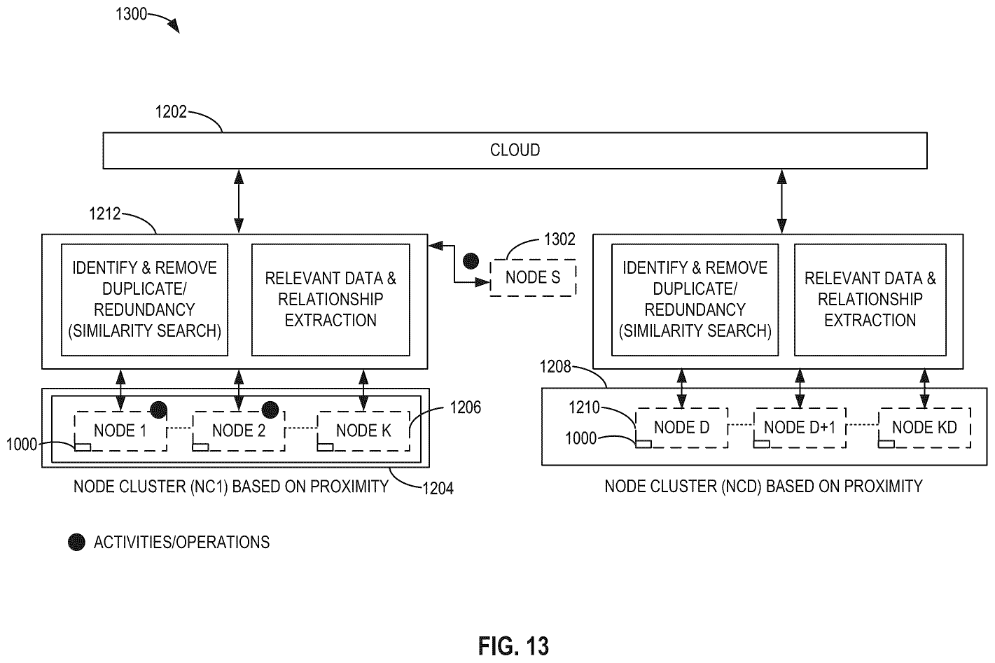

FIG. 13 is an illustration of a second example system 1300 to effectuate contextualized optimized data locality. The second system 1300 includes the cloud 1202, the first node cluster 1204, the first nodes 1206, the second node cluster 1208, the second nodes 1210, and the operations 1212 of FIG. 12. In example operation, the sustainable storage circuitry 1000 can multi-pass process raw sensor data (e.g., instrument measurements, video data, etc.) ingested at a node to generate outputs, which can include generations of bounding boxes surrounding people, fixtures, equipment, etc. In example operation, the sustainable storage circuitry 1000 can provide the outputs to relevant nodes associated with the outputs.

By way of example, the first one of the first nodes 1206 can capture and/or otherwise ingest video data from the first monitoring sensor 828 of FIG. 8. The first one of the first nodes 1206 can provide the video data to an ML model, such as the ML model 1068, to generate an output, which can be a detection of an unauthorized person in a factory. The first one of the first nodes 1206 can map first metadata of the video data to second metadata of a graph model (e.g., the data graph model 1066, the graph models 1102, 1104, etc.). In some examples, the first one of the first nodes 1206 can determine that the second metadata is associated with an example supervisor node 1302 (identified by NODE S). For example, the second metadata can identify a human resources (HR) personnel, a security officer, an IT manager, etc., based on the second metadata, or portion(s) thereof. In some examples, the first one of the first nodes 1206 can transmit the output, such as the detection of the unauthorized person in the factory, to the supervisor node 1302 to cause the supervisor node 1302 to perform one or more actions, activities, operations, etc., in connection with the output.

Advantageously, the first nodes 1206 and/or the second nodes 1210 can execute and/or instantiate the sustainable storage circuitry 1000 to carry out processing of locally generated data (e.g., process data at a node of a cluster that is generated by the node or a different node of the same cluster) to generate outputs of interest, identify events of interest, etc., that are relevant to the local nodes that generated the data. Advantageously, the first nodes 1206 and/or the second nodes 1210 can execute and/or instantiate the sustainable storage circuitry 1000 can store the outputs, events, etc., in their local data pools (e.g., memory, mass storage disks or devices, etc., of the local nodes) for improved data privacy and/or compliance with internal requirements (e.g., an organizational policy) and/or external requirements (e.g., regulatory requirements).

In some examples, the first nodes 1206 and/or the second nodes 1210 can execute and/or instantiate the sustainable storage circuitry 1000 to reassemble previously deconstructed datasets. For example, the first one of the first nodes 1206 can store a first portion of data, the second one of the first nodes 1206 can store a second portion of data, etc., and, in response to a request for the data, the ones of the first nodes 1206 can reassemble the data based on combining their respective portion(s).

Flowcharts representative of example hardware logic circuitry, machine readable instructions, hardware implemented state machines, and/or any combination thereof for implementing the sustainable storage circuitry 1000 of FIG. 10 and/or, more generally, the ADM system 600 of FIG. 6, is shown in FIGS. 7 and 14-24. The machine readable instructions may be one or more executable programs or portion(s) of an executable program for execution by processor circuitry, such as the processor circuitry 2512 shown in the example processor platform 2500 discussed below in connection with FIG. 25, the processor circuitry 2612 shown in the example processor platform 2600 discussed below in connection with FIG. 26, and/or the example processor circuitry discussed below in connection with FIGS. 27 and/or 28. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 7 and 14-24, many other methods of implementing the example sustainable storage circuitry 1000, and/or, more generally, the example ADM system 600 of FIG. 6, may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7 and 14-24 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

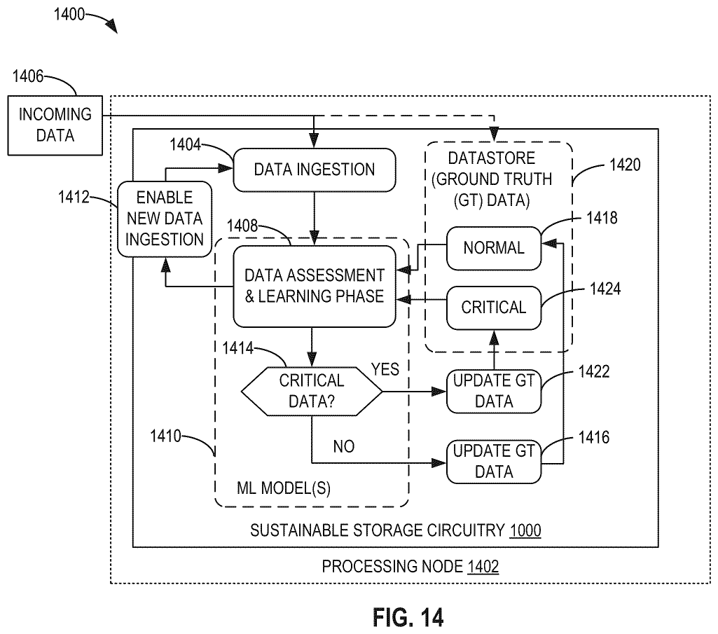

FIG. 14 is a flowchart representative of example machine readable instructions and/or example operations 1400 that may be executed and/or instantiated by processor circuitry to implement an example data assessment and learning phase at an example processing node 1402. In some examples, the processing node 1402 can be implemented by the logical entity 601 of FIG. 6, one(s) of the nodes of the edge network environment 800 of FIG. 8, one(s) of the first nodes 1206 and/or the second nodes 1210 of FIGS. 12-13, etc.

The processing node 1402 of the illustrated example includes, implements, executes, and/or instantiates the sustainable storage circuitry 1000 of FIG. 10. The example machine readable instructions and/or the example operations 1400 of FIG. 14 begin at block 1404, at which the sustainable storage circuitry 1000 ingests example incoming data 1406 (e.g., data from a sensor, a data producer, etc.).

At block 1408, the sustainable storage circuitry 1000 can execute example ML model(s) 1410 to execute a data assessment and learning phase on the incoming data 1406. For example, the ML model(s) 1410 can correspond to one(s) of the algorithms 638 of FIG. 6, the ML model 1068 of FIG. 10, etc. At block 1408, the sustainable storage circuitry 1000 can determine a value of data criticality during the learning or training phase. The sustainable storage circuitry 1000 can enable new data ingestion at block 1412.

At block 1414, the sustainable storage circuitry 1000 can determine whether the incoming data 1406, or portion(s) thereof, is/are critical data. For example, the sustainable storage circuitry 1000 can determine whether the value of the data criticality is equal to and/or greater than a threshold (e.g., a data criticality threshold) and thereby satisfies the threshold.

If, at block 1414, the sustainable storage circuitry 1000 determines that the data is not critical, control proceeds to block 1416 to update example normal or non-critical ground truth (GT) data 1418 stored in an example datastore 1420. For example, the sustainable storage circuitry 1000 can perform a green data management operation on the incoming data 1406, such as discarding the incoming data 1406, compressing the incoming data 1406, replacing the incoming data 1406 with a symbolic representation (e.g., a replacement of the incoming data 1406 with one or more symbols, placeholder datums, filler labels or indicia, etc.), etc., and/or any combination(s) thereof. In some examples, the datastore 1420 can correspond to the distributed datastore 644 of FIG. 6, the datastore 1060 of FIG. 10, etc.

If, at block 1414, the sustainable storage circuitry 1000 determines that the data is critical, control proceeds to block 1422 to update example critical ground truth data 1424 stored in the datastore 1420. For example, the sustainable storage circuitry 1000 can store the incoming data 1406 as the critical data 1424, update portion(s) of the critical data 1424 based on the incoming data 1406, etc. In example operation, the sustainable storage circuitry 1000 can execute the data assessment and learning phase at block 1408 based on at least one of the normal data 1418 or the critical data 1424. For example, the sustainable storage circuitry 1000 can tag the incoming data 1406 with first metadata and compare the first metadata to second metadata associated with at least one of the normal data 1418 or the critical data 1424. In some examples, the sustainable storage circuitry 1000 can determine whether the incoming data 1406, or portion(s) thereof, is/are critical data based on the comparison of the first metadata and the second metadata.

In response to updating the ground truth data at block 1416 or 1422, the example machine readable instructions and/or the example operations 1400 can conclude. Alternatively, the sustainable storage circuitry 1000 can execute (e.g., iteratively execute) the example machine readable instructions and/or the example operations 1400 in response to new data ingestion (e.g., an availability or receipt of new data to be ingested, processed, etc.).

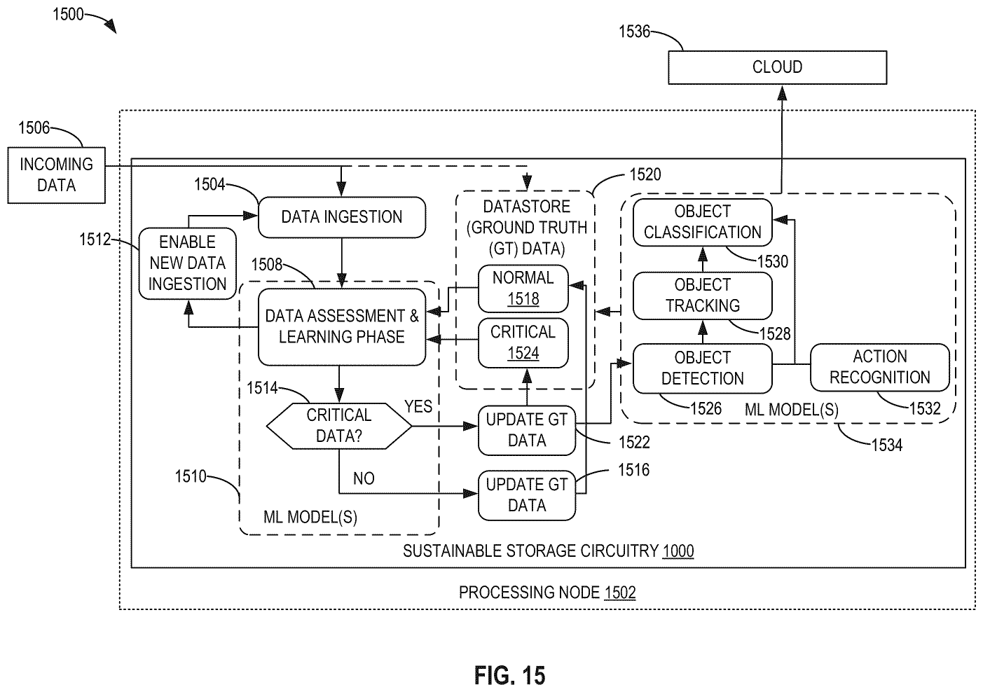

FIG. 15 is a flowchart representative of example machine readable instructions and/or example operations 1500 that may be executed and/or instantiated by processor circuitry to implement a first and second example data assessment and learning phase at an example processing node 1502. In some examples, the processing node 1502 can be implemented by the logical entity 601 of FIG. 6, one(s) of the nodes of the edge network environment 800 of FIG. 8, one(s) of the first nodes 1206 and/or the second nodes 1210 of FIGS. 12-13, etc.

The processing node 1502 of the illustrated example includes, implements, executes, and/or instantiates the sustainable storage circuitry 1000 of FIG. 10. The example machine readable instructions and/or the example operations 1500 of FIG. 15 begin at block 1504, at which the sustainable storage circuitry 1000 ingests example incoming data 1506 (e.g., data from a sensor, a data producer, etc.).

At block 1508, the sustainable storage circuitry 1000 can execute first example ML model(s) 1510 to execute a first data assessment and learning phase on the incoming data 1506. For example, the first ML model(s) 1510 can correspond to one(s) of the algorithms 638 of FIG. 6, the ML model 1068 of FIG. 10, etc. At block 1508, the sustainable storage circuitry 1000 can determine a value of data criticality during the learning or training phase. The sustainable storage circuitry 1000 can enable new data ingestion at block 1512. For example, block 1512 can be executed and/or instantiated at periodic intervals.

At block 1514, the sustainable storage circuitry 1000 can determine whether the incoming data 1506, or portion(s) thereof, is/are critical data. For example, the sustainable storage circuitry 1000 can determine whether the value of the data criticality is equal to and/or greater than a threshold (e.g., a data criticality threshold) and thereby satisfies the threshold.

If, at block 1514, the sustainable storage circuitry 1000 determines that the data is not critical, control proceeds to block 1516 to update example normal or non-critical ground truth (GT) data 1518 stored in an example datastore 1520. For example, the sustainable storage circuitry 1000 can perform a green data management operation on the incoming data 1506, such as discarding the incoming data 1506, compressing the incoming data 1506, replacing the incoming data 1506 with a symbolic representation, etc., and/or any combination(s) thereof. In some examples, the datastore 1520 can correspond to the distributed datastore 644 of FIG. 6, the datastore 1060 of FIG. 10, etc. In some examples, the normal data 1518 corresponds to baseline data, such as normal or non-critical baseline data associated with an environment and/or node(s) thereof.

If, at block 1514, the sustainable storage circuitry 1000 determines that the data is critical, control proceeds to block 1522 to update example critical ground truth data 1524 stored in the datastore 1520. For example, the sustainable storage circuitry 1000 can store the incoming data 1506 as the critical data 1524, update portion(s) of the critical data 1524 based on the incoming data 1506, etc. In some examples, the critical data 1524 corresponds to baseline data, such as critical baseline data associated with an environment and/or node(s) thereof.

In example operation, the sustainable storage circuitry 1000 can execute the first data assessment and learning phase at block 1508 based on at least one of the normal data 1518 or the critical data 1524. For example, the sustainable storage circuitry 1000 can tag the incoming data 1506 with first metadata and compare the first metadata to second metadata associated with at least one of the normal data 1518 or the critical data 1524. In some examples, the sustainable storage circuitry 1000 can determine whether the incoming data 1506, or portion(s) thereof, is/are critical data based on the comparison of the first metadata and the second metadata.

In response to updating the ground truth data at block 1516 or 1522, the example machine readable instructions and/or the example operations 1500 can conclude. Alternatively, the sustainable storage circuitry 1000 can execute (e.g., iteratively execute) the example machine readable instructions and/or the example operations 1500 in response to new data ingestion (e.g., an availability or receipt of new data to be ingested, processed, etc.).

In the illustrated example of FIG. 15, in response to updating the ground truth data at block 1522, control proceeds to execute a second data assessment and learning phase at blocks 1526, 1528, 1530, 1532 by executing second example ML model(s) 1534. For example, the second ML model(s) 1534 can correspond to one(s) of the algorithms 638 of FIG. 6, the ML model 1068 of FIG. 10, etc.

At block 1526, the sustainable storage circuitry 1000 executes object detection by providing the incoming data 1506 to the second ML model(s) 1534 as input(s) to generate output(s), which can include a detection of one or more objects. In response to executing object detection at block 1526, the sustainable storage circuitry 1000 can execute object tracking at block 1528 and/or object classification at block 1530. For example, the sustainable storage circuitry 1000 can execute object tracking at block 1528 on an object in response to receiving a detection of the object. In some examples, the sustainable storage circuitry 1000 can execute object classification at block 1530 of an object in response to receiving a detection of the object.

In response to executing the object detection at block 1526, the sustainable storage circuitry 1000 executes action recognition at block 1532. For example, the sustainable storage circuitry 1000 can identify and/or otherwise recognize one or more actions based on the object detection. For example, the one or more actions can include an identification of a specific object (e.g., a face of a person, a car, etc.), a detection of an anomaly or aberration, a tracking of an object (e.g., a pedestrian crossing, an animal walking, etc.), a determination of a parameter associated with an object (e.g., a vehicle speeding or committing a traffic violation), a parameter associated with an environment (e.g., a level of congestion of a road or highway, a hazard on or proximate to the road or highway, a person screaming in response to an adverse event, etc.), etc., and/or any combination(s) thereof.

In response to executing at least one of the object detection at block 1526, the object tracking at block 1528, the object classification at block 1530, or the action recognition at block 1532, the output(s) from blocks 1526, 1528, 1530, and/or 1532 can be stored in the datastore 1520 as the normal data 1518 and/or the critical data 1524. In response to executing at least one of the object detection at block 1526, the object tracking at block 1528, the object classification at block 1530, or the action recognition at block 1532, the output(s) from blocks 1526, 1528, 1530, and/or 1532 can be provided to an example cloud 1536. For example, the cloud 1536 can correspond to the edge cloud 110 of FIG. 1, the cloud data center 130 of FIG. 1, etc. In some examples, the cloud 1536 can store the output(s), provide the output(s) to different edge network environments and/or node(s) thereof, etc., and/or any combination(s) thereof.

FIG. 16 is a flowchart representative of example machine readable instructions and/or example operations 1600 that may be executed and/or instantiated by processor circuitry to effectuate data collection balancing for sustainable storage. The example machine readable instructions and/or the example operations 1600 of FIG. 16 begin at block 1602, at which the sustainable storage circuitry 1000 ingests data from a data source. For example, the interface circuitry 1010 (FIG. 10) can obtain data from one(s) of the data sources 604 of FIG. 6, the first monitoring sensor 828 of FIG. 8, etc. In some examples, the interface circuitry 1010 can extract data of interest from the data. In some examples, the interface circuitry 1010 can effectuate and/or facilitate green data management by ingesting data that can be provided as input(s) to one or more nodes to cause the one or more nodes to generate output(s) representative of achievements in reducing environment impacts of edge environments. An example process that may be executed and/or instantiated by processor circuitry to implement block 1602 is described below in connection with FIG. 17.

At block 1604, the sustainable storage circuitry 1000 orchestrates resources in an edge environment based on the data ingested from the data source. For example, the resource orchestration circuitry 1020 (FIG. 10) can instantiate hardware, software, and/or firmware resources in the ADM system 600 of FIG. 6, the edge network environment 800 of FIG. 8, etc. In some examples, the resource orchestration circuitry 1020 can effectuate green data management by reducing utilization of resource(s) and/or deployment of resource(s) to accomplish green objectives while complying with the policy 1062 and/or otherwise satisfying the policy 1062. An example process that may be executed and/or instantiated by processor circuitry to implement block 1604 is described below in connection with FIG. 18.

At block 1606, the sustainable storage circuitry 1000 executes a machine learning (ML) model based on the data to generate outputs, the outputs including at least one of a first value representative of data criticality or a second value representative of data quality of the data. For example, the ML circuitry 1030 (FIG. 10) can execute the ML model 1068 (FIG. 10) using the ingested data from the data sources 604 as inputs to generate outputs, which can include values (e.g., data values, numerical values, alphanumerical values, etc.) indicative of and/or otherwise representative of data criticality and/or data quality associated with the ingested data. In some examples, the ML circuitry 1030 can facilitate green data management by generating outputs that may indirectly cause a node to achieve reduced environment impacts (e.g., the node may utilize the outputs as inputs to another model, algorithm, routine, process, etc., that may lead to reduced environment impacts). In some examples, the ML circuitry 1030 can effectuate green data management by generating outputs that may directly cause a node to achieve reduced environment impacts (e.g., the node may take action(s) based on the outputs). An example process that may be executed and/or instantiated by processor circuitry to implement block 1606 is described below in connection with FIGS. 19, 20, 21, and/or 22.

At block 1608, the sustainable storage circuitry 1000 reduces resource requirements associated with the resources of the edge environment to effectuate green data management based on the outputs. For example, the green data management circuitry 1040 (FIG. 10) can reduce resources, such as compute, storage, network, etc., resources, based on the data criticality and/or the data quality of the ingested data. In some examples, the green data management circuitry 1040 can effectuate green data management by reducing a number of resources to achieve green goals or objectives, such as reduced environment impact. An example process that may be executed and/or instantiated by processor circuitry to implement block 1608 is described below in connection with FIG. 23.

At block 1610, the sustainable storage circuitry 1000 causes operation(s) at node(s) of the edge environment based on at least one of the data or the outputs, the node(s) associated with the data. For example, the operation execution circuitry 1050 (FIG. 10) can cause and/or otherwise invoke a node of the edge network environment 800 to perform one or more operations based on the ingested data. In some examples, the operations can include controlling an action or motion of an autonomous vehicle, equipment, etc., based on ingested sensor data associated with the autonomous vehicle, equipment, etc. An example process that may be executed and/or instantiated by processor circuitry to implement block 1610 is described below in connection with FIG. 24. In response to causing operation(s) at the node(s) of the edge environment based on the data at block 1610, the example machine readable instructions and/or the example operations 1600 of FIG. 16 conclude.

FIG. 17 is a flowchart representative of example machine readable instructions and/or example operations 1700 that may be executed and/or instantiated by processor circuitry to ingest data from a data source. In some examples, the machine readable instructions and/or the operations 1700 of FIG. 17 can be executed and/or instantiated by processor circuitry to implement block 1602 of the machine readable instructions and/or the operations 1600 of FIG. 16. The example machine readable instructions and/or the example operations 1700 of FIG. 17 begin at block 1702, at which the sustainable storage circuitry 1000 ingests data from a data source at a node. For example, the interface circuitry 1010 (FIG. 10) of the edge cloud 810 can ingest data, such as video data, from the first monitoring sensor 828.

At block 1704, the sustainable storage circuitry 1000 tags portion(s) of the data with metadata. For example, the interface circuitry 1010 can tag, assign, and/or otherwise embed metadata into portion(s) of the video data. In some examples, the interface circuitry 1010 (e.g., the interface circuitry 1010 of the edge cloud 810) can generate metadata including an IP address, a MAC address, a device type of the first monitoring sensor 828, etc., and/or any combination(s) thereof, and associate the metadata with the portion(s) of the video data.

At block 1706, the sustainable storage circuitry 1000 queries an orchestrator to identify a machine learning (ML) model as associated with the metadata. For example, the interface circuitry 1010 (e.g., the interface circuitry 1010 of the edge cloud 810) can query the resource manager/orchestration agent 642 of FIG. 6, the edge cloud 110, the cloud data center 130, etc., for one(s) of the algorithms 638, the ML model 1068, etc., that is/are associated with the metadata.

At block 1708, the sustainable storage circuitry 1000 executes ML model(s) at the node to determine at least one of the first value of the data criticality or the second value of the data quality of the data. For example, the ML circuitry 1030 (FIG. 10) (e.g., the ML circuitry 1030 of the edge cloud 810) can execute the one(s) of the algorithms 638, the ML model 1068, etc., that correspond(s) to the metadata. In some examples, the ML circuitry 1030 can execute the algorithms 638, the ML model 1068, etc., using the metadata and/or the portion(s) of the video data as inputs to generate outputs, which can include the first value of the data criticality of the data and/or the second value of the data quality of the data.

In response to executing ML model(s) at the node to determine at least one of the first value of the data criticality or the second value of the data quality of the data at block 1708, the example machine readable instructions and/or the example operations 1700 of FIG. 17 conclude. For example, the machine readable instructions and/or the operations 1700 of FIG. 17 can return to block 1604 of the machine readable instructions and/or the operations 1600 of FIG. 16 to orchestrate resources in an edge environment based on the data.

FIG. 18 is a flowchart representative of example machine readable instructions and/or example operations 1800 that may be executed and/or instantiated by processor circuitry to orchestrate resources in an edge environment based on data ingested from a data source. In some examples, the machine readable instructions and/or the operations 1800 of FIG. 18 can be executed and/or instantiated by processor circuitry to implement block 1604 of the machine readable instructions and/or the operations 1600 of FIG. 16.

The example machine readable instructions and/or the example operations 1800 of FIG. 18 begin at block 1802, at which the sustainable storage circuitry 1000 obtains an orchestration policy indicative of at least one of a quantity or a type of workload(s) to be executed in the edge environment. For example, the resource orchestration circuitry 1020 (FIG. 10) can obtain the policy 1062 (FIG. 10) associated with the edge network environment 800 of FIG. 8. In some examples, the policy 1062 associated with the edge network environment 800 can include a quantity of workloads expected to be executed during a time period (e.g., every minute, hour, day, week, month, etc.) and/or a type of workload (e.g., types of workloads including acceleration, compute, memory, storage, network, security, etc., workloads) to be executed with resources of the edge network environment 800. In some examples, the resource orchestration circuitry 1020 can identify an intention of the policy 1062 to satisfy parameters of an SLA, QoS policy, etc., while achieving overarching goals of reducing environment impact.

At block 1804, the sustainable storage circuitry 1000 instantiates resources in the edge environment to execute workload(s) based on the orchestration policy. For example, the resource orchestration circuitry 1020 can allocate, deploy, and/or launch hardware, software, and/or firmware resources at a node, such as the edge cloud 810 of FIG. 8. In some examples, the edge cloud 810 can execute the workloads with the instantiated resources.

At block 1806, the sustainable storage circuitry 1000 generates a topology associated with the resources to at least one of execute a workload or route data in the edge environment with the resources. For example, the resource orchestration circuitry 1020 can generate a topology (e.g., a resource topology, a network topology, etc.) associated with resources of the edge network environment 800. In some examples, the topology can be a network topology including network connections (e.g., connections using IP addresses and ports, MAC addresses, logical addresses, etc.) to one(s) of the first monitoring sensor 828, the second monitoring sensor 830, the first industrial machine 816, the edge cloud 810, etc., of FIG. 8.

At block 1808, the sustainable storage circuitry 1000 identifies node(s) as preferred node(s) in the edge environment based on the topology, the preferred node(s) to generate local determinations associated with the data. For example, the resource orchestration circuitry 1020 can identify the edge cloud 810 as one of the preferred node(s) in the preferred nodes table 624 of FIG. 6. In some examples, the resource orchestration circuitry 1020 can identify the edge cloud 810 to generate local determinations, such as outputs from the ML model 1068, based on locally generated data, such as data ingested from nodes local to the edge network environment 800, which can include the first monitoring sensor 828, the second monitoring sensor 830, the first industrial machine 816, etc.

At block 1810, the sustainable storage circuitry 1000 deploys machine learning (ML) model(s) to the node(s) in response to identification(s) of the node(s) as the preferred node(s). For example, the resource orchestration circuitry 1020 can provide, transmit, and/or otherwise deliver the ML model 1068 to the edge cloud 810 in response to an identification of the edge cloud 810 as a preferred node in the edge network environment 800.

In response to deploying ML model(s) to the node(s) in response to identification(s) of the node(s) as the preferred node(s) at block 1810, the example machine readable instructions and/or the example operations 1800 of FIG. 18 conclude. For example, the machine readable instructions and/or the operations 1800 of FIG. 18 can return to block 1606 of the machine readable instructions and/or the operations 1600 of FIG. 16 to execute an ML model based on the data to generate outputs including at least one of a first value representative of data criticality or a second value representative of data quality of the data.

FIG. 19 is a flowchart representative of example machine readable instructions and/or example operations 1900 that may be executed and/or instantiated by processor circuitry to execute a machine learning (ML) model based on data to generate outputs. In some examples, the machine readable instructions and/or the operations 1900 of FIG. 19 can be executed and/or instantiated by processor circuitry to implement block 1606 of the machine readable instructions and/or the operations 1600 of FIG. 16.

The example machine readable instructions and/or the example operations 1900 of FIG. 19 begin at block 1902, at which the sustainable storage circuitry 1000 determines whether to execute the ML model in a training phase or an inference phase. For example, the ML circuitry 1030 (FIG. 10) can determine whether to execute the ML model 1068 in a training phase (e.g., to train the ML model 1068 based on training data) or an inference phase (e.g., to execute the ML model 1068 using live or real-world data).

If, at block 1902, the sustainable storage circuitry 1000 determines to execute the ML model in a training phase, control proceeds to block 1904. At block 1904, the sustainable storage circuitry 1000 obtains training data for an observation period. For example, the ML circuitry 1030 can obtain training data, such as labeled sensor data, for an observation period (e.g., labeled sensor data captured for a particular hour, week, day, etc.). In some examples, the ML circuitry 1030 can obtain training data, such as labeled intentions or desires of green goals of reducing environment impact, to be used to train the ML model 1068.

At block 1906, the sustainable storage circuitry 1000 executes the ML model using the training data to generate outputs representative of baseline data for data criticality and data quality. For example, the ML circuitry 1030 can execute the ML model 1068 (FIG. 10) to determine at least one of a first baseline value of data criticality or a second baseline value of data quality associated with the training data that can be used for the inference phase. An example process that may be executed and/or instantiated by processor circuitry to implement block 1906 is described below in connection with FIG. 20. In response to executing the ML model using the training data to generate outputs representative of baseline data for data criticality and data quality at block 1906, control proceeds to block 1910.

If, at block 1902, the sustainable storage circuitry 1000 determines to execute the ML model in an inference phase, control proceeds to block 1908. At block 1908, the sustainable storage circuitry 1000 executes the ML model using the ingested data to generate outputs representative of data criticality and data quality of the ingested data. For example, the ML circuitry 1030 can execute the ML model 1068, based on the training data, to determine at least one of a first value of data criticality or a second value of data quality associated with data ingested at a node. An example process that may be executed and/or instantiated by processor circuitry to implement block 1908 is described below in connection with FIG. 21. In response to executing the ML model using the ingested data to generate outputs representative of data criticality and data quality of the ingested data at block 1908, control proceeds to block 1910.

At block 1910, the sustainable storage circuitry 1000 determines whether to update the baseline data based on the outputs. For example, the ML circuitry 1030 can determine that ingested data is critical data and thereby the ML circuitry 1030 can determine to update stored baseline data.

If, at block 1910, the sustainable storage circuitry 1000 determines to update the baseline data based on the outputs, control proceeds to block 1912. At block 1912, the sustainable storage circuitry 1000 updates the baseline data in a datastore based on the outputs. For example, in response to a determination that the incoming data 1406 of FIG. 14 is critical data, the ML circuitry 1030 can determine to update the critical data 1424 stored in the datastore 1420 of FIG. 14. In response to updating the baseline data in a datastore based on the outputs at block 192, the example machine readable instructions and/or the example operations 1900 of FIG. 19 conclude. For example, the machine readable instructions and/or the operations 1900 of FIG. 19 can return to block 1608 of the machine readable instructions and/or the operations 1600 of FIG. 16 to reduce resource requirements associated with the resources of the edge environment to effectuate green data management based on the outputs.

If, at block 1910, the sustainable storage circuitry 1000 determines not to update the baseline data based on the outputs, control proceeds to block 1914. At block 1914, the sustainable storage circuitry 1000 tags the ingested data for green data management operations. For example, the ML circuitry 1030 can append metadata to the ingested data to cause the ingested data to undergo green data management operation(s), such as being compressed, discarded, and/or otherwise modified. In response to tagging the ingested data for green data management operations at block 1914, the example machine readable instructions and/or the example operations 1900 conclude. For example, the machine readable instructions and/or the operations 1900 of FIG. 19 can return to block 1608 of the machine readable instructions and/or the operations 1600 of FIG. 16 to reduce resource requirements associated with the resources of the edge environment to effectuate green data management based on the outputs.

FIG. 20 is a flowchart representative of example machine readable instructions and/or example operations 2000 that may be executed and/or instantiated by processor circuitry to execute an ML model to generate outputs representative of data criticality and data quality. In some examples, the machine readable instructions and/or the operations 2000 of FIG. 20 can be executed and/or instantiated by processor circuitry to implement block 1906 and/or block 1908 of the machine readable instructions and/or the operations 1900 of FIG. 19.

The example machine readable instructions and/or the example operations 2000 of FIG. 20 begin at block 2002, at which the sustainable storage circuitry 1000 determines a value of data criticality based on at least one of training data or ingested data. For example, the ML circuitry 1030 can execute the ML model 1068 (FIG. 10) to determine a first value of data criticality associated with training data during a training phase, a second value of data criticality associated with data ingested at the logical entity 601 of FIG. 1 during an inference phase, etc. An example process that may be executed and/or instantiated by processor circuitry to implement block 2002 is described below in connection with FIG. 21.

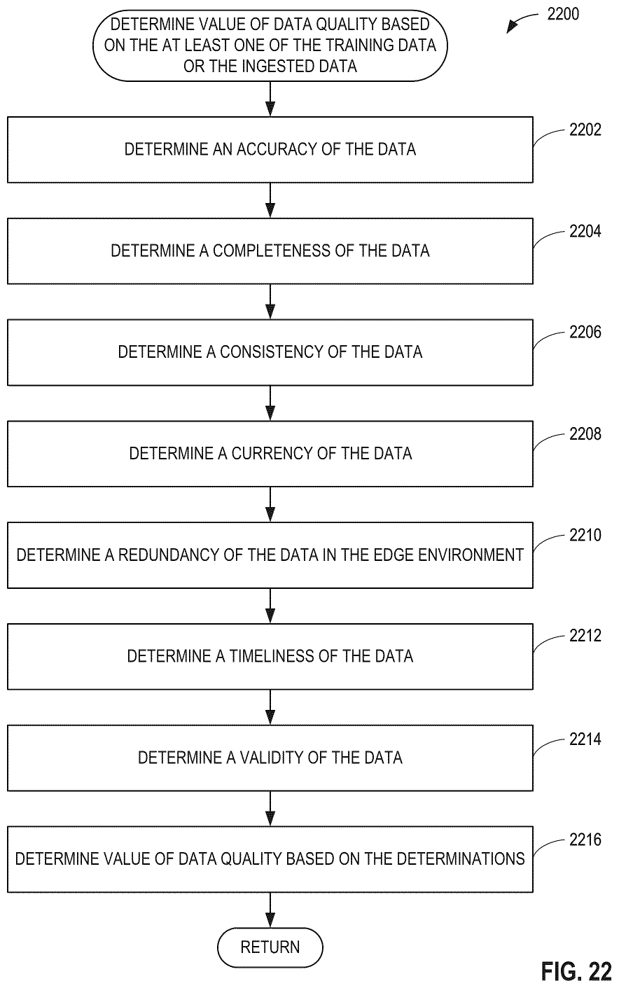

At block 2004, the sustainable storage circuitry 1000 determines a value of data quality based on the at least one of the training data or the ingested data. For example, the ML circuitry 1030 can execute the ML model 1068 to determine a first value of data quality associated with training data during a training phase, a second value of data quality associated with data ingested at the logical entity 601 of FIG. 1 during an inference phase, etc. An example process that may be executed and/or instantiated by processor circuitry to implement block 2004 is described below in connection with FIG. 22.

At block 2006, the sustainable storage circuitry 1000 determines whether at least one of the values of the data criticality or the data quality satisfy a threshold. For example, the ML circuitry 1030 can execute the ML model 1068 to determine that the first value of the data criticality satisfies a first threshold (e.g., a data criticality threshold, a data criticality threshold associated with a training phase, etc.), the second value of the data criticality satisfies a second threshold (e.g., a data criticality threshold, a data criticality threshold associated with an inference phase, etc.), etc., and/or any combination(s) thereof. In some examples, the ML circuitry 1030 can execute the ML model 1068 to determine that the first value of the data quality satisfies a third threshold (e.g., a data quality threshold, a data quality threshold associated with a training phase, etc.), the second value of the data quality satisfies a fourth threshold (e.g., a data quality threshold, a data quality threshold associated with an inference phase, etc.), etc., and/or any combination(s) thereof.

If, at block 2006, the sustainable storage circuitry 1000 determines that at least one of the values of the data criticality or the data quality do not satisfy a threshold, the example machine readable instructions and/or the example operations 2000 conclude. For example, the machine readable instructions and/or the example operations 2000 can return to block 1910 of the machine readable instructions and/or the operations 1900 of FIG. 19 to determine whether to update the baseline data based on the outputs.

If, at block 2006, the sustainable storage circuitry 1000 determines that at least one of the values of the data criticality or the data quality satisfy a threshold, control proceeds to block 2008. At block 2008, the sustainable storage circuitry 1000 stores the data in a datastore. For example, the ML circuitry 1030 can store the training data, or portion(s) thereof, as the normal data 1418, the critical data 1424, etc., of FIG. 14, and/or any combination(s) thereof. In some examples, the ML circuitry 1030 can store the ingested data, or portion(s) thereof, as the normal data 1418, the critical data 1424, etc., of FIG. 14, and/or any combination(s) thereof.

At block 2010, the sustainable storage circuitry 1000 generates an alert. For example, the ML circuitry 1030 can generate an alert indicative of the training data, the ingested data, etc., being representative of data to be surfaced to a user, another electronic system in the edge network environment 800 of FIG. 8, etc. In some examples, the ML circuitry 1030 can generate the alert to be indicative of a detection of an unauthorized person in the edge network environment 800, and the alert can be provided to a user (e.g., an HR, IT, security, etc., personnel), an electronic device associated with the user, an electronic device of the edge network environment 800 (e.g., an electronic security system, an alarm, etc.). In some examples, the ML circuitry 1030 can generate the alert to be indicative of a detection of a hazard on a roadway, and the alert can be provided to a vehicle (e.g., a user-operated vehicle, an autonomous vehicle, etc.) to cause the vehicle to avoid the hazard in substantially real time.

In response to generating an alert at block 2010, the example machine readable instructions and/or the example operations 2000 conclude. For example, the machine readable instructions and/or the example operations 2000 can return to block 1910 of the machine readable instructions and/or the operations 1900 of FIG. 19 to determine whether to update the baseline data based on the outputs.

FIG. 21 is a flowchart representative of example machine readable instructions and/or example operations 2100 that may be executed and/or instantiated by processor circuitry to determine a value of data criticality based on at least one of training data or ingested data. In some examples, the machine readable instructions and/or the operations 2100 of FIG. 21 can be executed and/or instantiated by processor circuitry to implement block 2002 of the machine readable instructions and/or the operations 2000 of FIG. 20.

The example machine readable instructions and/or the example operations 2100 of FIG. 21 begin at block 2102, at which the sustainable storage circuitry 1000 identifies a potential consequence if the data is not processed or stored. For example, the ML circuitry 1030 (FIG. 10) can generate an output (e.g., an output based on ingested data from the data sources 604), which can be an identification of a concern or consequence, such as violating a regulatory requirement, if data from the data sources 604 is not processed and/or stored. For example, the consequence can be violating a government regulation regarding citizen privacy if biometric data associated with a person is not processed to randomize and/or otherwise obfuscate the biometric data. In some examples, the ML circuitry 1030 can identify a consequence, such as an adverse or undesirable event occurring, if data from the data sources 604 is not processed and/or stored. For example, the undesirable event can be a collision in a warehouse between a hazard (e.g., a person, an object, etc.) and the first industrial machine 816 of FIG. 8 if video data from the first monitoring sensor 828 is not processed and/or stored. In some examples, a consequence can be an increase in environment impacts, such as an increase in resources (e.g., compute, storage, security, acceleration, etc., resources) required to process ingested data. Additionally and/or alternatively, the ML circuitry 1030 can determine that the ingested data includes metadata that corresponds to and/or otherwise identifies the concern or consequence.

At block 2104, the sustainable storage circuitry 1000 identifies a service level agreement (SLA) associated with the data. For example, the ML circuitry 1030 can generate an output (e.g., an output based on ingested data from the data sources 604), which can be a determination that the data includes metadata associated with the policy 1062, which can be an SLA that defines bandwidth, latency, throughput, etc., requirements to process data from the data sources 604. Additionally and/or alternatively, the ML circuitry 1030 can determine that the ingested data includes metadata that corresponds to and/or otherwise identifies the SLA associated with the data.

At block 2106, the sustainable storage circuitry 1000 determines a number of nodes in the edge environment that are associated with the data. For example, the ML circuitry 1030 can generate an output (e.g., an output based on ingested data from the data sources 604), which can be a determination that data from the data sources 604 is associated with a plurality of nodes and thereby the data can have increased data criticality because a significant number of nodes may request the data. Additionally and/or alternatively, the ML circuitry 1030 can determine that the ingested data includes metadata that corresponds to and/or otherwise identifies the number of nodes in the edge environment.

At block 2108, the sustainable storage circuitry 1000 identifies at least one of a purpose or a size of a workload associated with the data. For example, the ML circuitry 1030 can generate an output (e.g., an output based on ingested data from the data sources 604), which can be a determination that the data from the data sources 604 is associated with a mission critical task or workload, such as autonomous driving, navigation, high-precision manufacturing, etc., and thereby the data can have increased data criticality because of an importance or significance of the data to perform the mission critical task or workload. In some examples, the ML circuitry 1030 can generate an output (e.g., an output based on ingested data from the data sources 604), which can be a determination of a size of a workload requesting resources (e.g., storage resources). Additionally and/or alternatively, the ML circuitry 1030 can determine that the ingested data includes metadata that corresponds to and/or otherwise identifies the purpose and/or the size of the workload associated with the data.

At block 2110, the sustainable storage circuitry 1000 determines a priority of the data. For example, the ML circuitry 1030 can generate an output (e.g., an output based on ingested data from the data sources 604), which can be a determination that the data from the data producers 604 has metadata representative of increased priority for processing and/or storage. In some examples, the ML circuitry 1030 can determine that the data has increased priority based on mapping first metadata of the data to second metadata of the policy 1062, which can define the priority for data having the first metadata. Additionally and/or alternatively, the ML circuitry 1030 can determine that the ingested data includes metadata that corresponds to and/or otherwise identifies priority of the data.

At block 2112, the sustainable storage circuitry 1000 identifies a regulatory requirement associated with the data. For example, the ML circuitry 1030 can generate an output (e.g., an output based on ingested data from the data sources 604), which can be an identification of whether the data is to conform to regulatory requirements (e.g., state or local, country, government, etc., regulations, ordinances, laws, etc.), and thereby the data can have increased data criticality to conform to the regulatory requirements and/or avoid violating the regulatory requirements. Additionally and/or alternatively, the ML circuitry 1030 can determine that the ingested data includes metadata that corresponds to and/or otherwise identifies the regulatory requirement associated with the data.

At block 2114, the sustainable storage circuitry 1000 determines a value of data criticality based on the identifications and determinations. For example, the ML circuitry 1030 can generate an output (e.g., an output based on ingested data from the data sources 604) by executing the data graph model 1066, the ML model 1068, etc., and/or any combination(s) thereof, to determine a value of data criticality of data from the data sources 604 based on at least one of the potential consequence, the SLA, the number of nodes in the edge environment that are associated with the data, the purpose of the workload, the priority of the data, or the regulatory requirement associated with the data. In some examples, the ML circuitry 1030 can determine the value of data criticality to be a numerical value (e.g., a value in a range of 0 to 1, where 0 is not critical and 1 is critical). In some examples, the ML circuitry 1030 can determine the value of data criticality to be a numerical identifier (e.g., a numerical identifier of 0 for not critical and a numerical identifier of 1 is critical). In some examples, the ML circuitry 1030 can determine the value of data criticality to be a label or text identifier (e.g., a label of “not critical” for not critical, a label of “critical” for critical, a label of “discard” to discard not critical data, a label of “retain” or “store” to store critical data, etc., and/or any combination(s) thereof).

In response to determining the value of the data criticality based on the identifications and determinations at block 2114, the example machine readable instructions and/or the example operations 2100 conclude. For example, the machine readable instructions and/or the example operations 2100 can return to block 2004 of the machine readable instructions and/or the operations 2000 of FIG. 20 to determine a value of data quality based on the at least one of the training data or the ingested data.

FIG. 22 is a flowchart representative of example machine readable instructions and/or example operations 2200 that may be executed and/or instantiated by processor circuitry to determine a value of data quality based on the at least one of the training data or the ingested data. In some examples, the machine readable instructions and/or the operations 2200 of FIG. 22 can be executed and/or instantiated by processor circuitry to implement block 2004 of the machine readable instructions and/or the operations 2000 of FIG. 20.

The example machine readable instructions and/or the example operations 2200 of FIG. 22 begin at block 2202, at which the sustainable storage circuitry 1000 determines an accuracy of the data. For example, the ML circuitry 1030 (FIG. 10) can execute one(s) of the algorithms 638 of FIG. 6, the ML model 1068, etc., to generate outputs. In some examples, the ML circuitry 1030 can execute the ML model 1068 using the ingested data as inputs to generate outputs, which can include an accuracy of the ingested data. For example, the ML circuitry 1030 can determine whether the data has an accuracy above a threshold (e.g., an accuracy threshold), and thereby satisfies the threshold, based on a comparison of the data, or portion(s) thereof, to data associated with the data graph model 1066 (FIG. 10), baseline data as described herein, etc., and/or any combination(s) thereof. For example, the ML circuitry 1030 can determine that the outputs include a decision, a determination, an insight, etc., that comports and/or otherwise aligns with labeled training data or another source of ground truth data.

At block 2204, the sustainable storage circuitry 1000 determines a completeness of the data. For example, the ML circuitry 1030 can execute the ML model 1068 using the ingested data as inputs to generate outputs, which can include a completeness of the ingested data. In some examples, the ML circuitry 1030 can determine that the ingested data has a completeness above a threshold (e.g., a completeness threshold) and thereby satisfies the threshold. For example, the ML circuitry 1030 can determine that the ingested data is not missing one or more data fields and thereby determine that the ingested data is complete. In some examples, the ML circuitry 1030 can determine that the ingested data is incomplete or has a completeness less than 100% complete based on the ingested data not including one or more data fields that are expected to be included in the ingested data.

At block 2206, the sustainable storage circuitry 1000 determines a consistency of the data. For example, the ML circuitry 1030 can execute the ML model 1068 using the ingested data as inputs to generate outputs, which can include a consistency of the ingested data. In some examples, the ML circuitry 1030 can determine that the ingested data has a consistency above a threshold (e.g., a consistency threshold) and thereby satisfies the threshold. For example, the ML circuitry 1030 can determine that the data is not consistent with respect to previously ingested data, previously stored data values that are associated with metadata of the ingested data, etc., and/or any combination(s) thereof.

At block 2208, the sustainable storage circuitry 1000 determines a currency of the data. For example, the ML circuitry 1030 can execute the ML model 1068 using the ingested data as inputs to generate outputs, which can include a currency of the ingested data. In some examples, the ML circuitry 1030 can determine that the ingested data has a currency above a threshold (e.g., a currency threshold) and thereby satisfies the threshold. For example, the ML circuitry 1030 can determine that the ingested data is stale and/or otherwise has a timestamp that is too far removed timewise from a mission critical task to be usable, does not comport or satisfy with an SLA or QoS requirements, etc.

At block 2210, the sustainable storage circuitry 1000 determines a redundancy of the data in the edge environment. For example, the ML circuitry 1030 can execute the ML model 1068 using the ingested data as inputs to generate outputs, which can include a redundancy of the ingested data in the edge network environment 800 of FIG. 8. In some examples, the ML circuitry 1030 can determine that the ingested data has a redundancy above a threshold (e.g., a redundancy threshold) and thereby satisfies the threshold. For example, the ML circuitry 1030 can determine that the ingested data includes data values that are already stored at one or more nodes of the edge network environment 800 and thereby determine that the ingested data can undergo green data management operations.

At block 2212, the sustainable storage circuitry 1000 determines a timeliness of the data. For example, the ML circuitry 1030 can execute the ML model 1068 using the ingested data as inputs to generate outputs, which can include a timeliness of the ingested data. In some examples, the ML circuitry 1030 can determine that the ingested data has a timeliness above a threshold (e.g., a timeliness threshold) and thereby satisfies the threshold. For example, the ML circuitry 1030 can determine that the ingested data is produced and/or received by the interface circuitry 1010 (FIG. 10) within a time limit, duration, or other period of time that comports or satisfies a time limit, duration, or other period of time as defined in an SLA or QoS requirement.

At block 2214, the sustainable storage circuitry 1000 determines a validity of the data. For example, the ML circuitry 1030 can execute the ML model 1068 using the ingested data as inputs to generate outputs, which can include a validity of the ingested data. In some examples, the ML circuitry 1030 can determine that the ingested data has a validity above a threshold (e.g., a validity threshold) and thereby satisfies the threshold.

At block 2216, the sustainable storage circuitry 1000 determines a value of data quality based on the determinations. For example, the ML circuitry 1030 can determine a value of data quality associated with the ingested data, or portion(s) thereof, based on at least one of the accuracy, the completeness, the consistency, the currency, the redundancy, the timeliness, or the validity of the data.

In response to determining the value of the data quality based on the determinations at block 2216, the example machine readable instructions and/or the example operations 2200 conclude. For example, the machine readable instructions and/or the example operations 2200 can return to block 2006 of the machine readable instructions and/or the operations 2000 of FIG. 20 to determine whether at least one of the values of the data criticality or the data quality satisfy a threshold.

FIG. 23 is a flowchart representative of example machine readable instructions and/or example operations 2300 that may be executed and/or instantiated by processor circuitry to reduce resource requirements of the edge environment to effectuate green data management based on the outputs. In some examples, the machine readable instructions and/or the operations 2300 of FIG. 23 can be executed and/or instantiated by processor circuitry to implement block 1608 of the machine readable instructions and/or the operations 1600 of FIG. 16.

The example machine readable instructions and/or the example operations 2300 of FIG. 23 begin at block 2302, at which the sustainable storage circuitry 1000 aggregates data at node(s) based on at least one of filtering or correlation using data graph model(s). For example, the green data management circuitry 1040 (FIG. 10) can collect and/or otherwise aggregate data at one(s) of the first nodes 1206. In some examples, the green data management circuitry 1040 can filter the data using one or more filter parameters (e.g., a type of data, a type of device that produced the data, a timestamp or range of timestamps associated with the data, metadata associated with the data, etc.) to identify a subset of the data. In some examples, the green data management circuitry 1040 can correlate the data at one(s) of the first nodes 1206 by analyzing vector lengths, angles, etc., of the data graph model 1066 of FIG. 11, the graph models 1102, 1104 of FIG. 11, etc.

At block 2304, the sustainable storage circuitry 1000 removes duplicate data based on the data graph model(s). For example, the green data management circuitry 1040 can determine that data at and/or otherwise ingested at one(s) of the first nodes 1206 is/are duplicative based on comparing first metadata of the data with second metadata of the data graph model 1066, the graph models 1102, 1104. For example, the green data management circuitry 1040 can determine that the data has previously been analyzed and/or stored based on a presence of the first metadata, or portion(s) thereof, in the data graph model 1066, the graph models 1102, 1104, etc., as part of the second metadata.

At block 2306, the sustainable storage circuitry 1000 retains relevant and critical data based on the data graph model(s) to reduce storage requirements. For example, the green data management circuitry 1040 can execute the ML model 1068 (FIG. 10) to determine whether the data one(s) of the first nodes 1206 is relevant and/or critical data based on values of data criticality and/or data quality. In some examples, the green data management circuitry 1040 can execute the ML model 1068 with the data and/or the data graph model 1066 as model input(s) to generate model output(s), which can include the values of the data criticality and/or the data quality associated with the data at the first nodes 1206. For example, the green data management circuitry 1040 can reduce storage requirements of a system, such as the edge network environment 800 of FIG. 8, by retaining relevant and/or critical data and discarding, compressing, etc., non-relevant and/or non-critical data. In some examples, the green data management circuitry 1040 can reduce storage requirements by reducing a quantity and/or type of storage resources needed (and/or other associated resources like compute, network, security, etc.) because the non-relevant and/or non-critical data may not need to be stored or stored in its original form.

At block 2308, the sustainable storage circuitry 1000 identifies a resource utilization of node(s). For example, the green data management circuitry 1040 can determine a compute utilization (e.g., a quantity or percentage of compute resources that are utilized), a storage utilization (e.g., a quantity or percentage of storage resources that are utilized), etc., at a first one of the first nodes 1206. In some examples, the green data management circuitry 1040 can determine that the storage utilization at the first one of the first nodes 1206 is 80% based on a determination that 80% of storage resources of the first one of the first nodes 1206 are utilized and/or otherwise busy executing storage associated workloads.

At block 2310, the sustainable storage circuitry 1000 determines whether one(s) of the node(s) have a resource utilization above a threshold. For example, the green data management circuitry 1040 can determine that the storage utilization of 80% is greater than a threshold of 75% and thereby satisfies the threshold.

If, at block 2310, the sustainable storage circuitry 1000 determines that one(s) of the node(s) have a resource utilization above a threshold, control proceeds to block 2312. At block 2312, the sustainable storage circuitry 1000 reduces a resource utilization through at least one of a reduction in redundant data processing or a rerouting of data processing to underutilized node(s). For example, the green data management circuitry 1040 can reduce the storage utilization of the first one of the first nodes 1206 by compressing existing data stored at the first one of the first nodes 1206, discarding and/or otherwise deleting non-relevant and/or non-critical data at the first one of the first nodes 1206, etc., and/or any combination(s) thereof. In some examples, the green data management circuitry 1040 can instruct the first one of the first nodes 1206 to cease data ingestion and/or cause another one of the first nodes 1206 to ingest data in place of the first one of the first nodes 1206. In response to reducing the resource utilization at block 2312, the example machine readable instructions and/or the example operations 2300 conclude. For example, the machine readable instructions and/or the example operations 2300 can return to block 1610 of the machine readable instructions and/or the operations 1600 of FIG. 16 to cause operation(s) at node(s) of the edge environment based on the data.

If, at block 23110, the sustainable storage circuitry 1000 determines that one(s) of the node(s) have a resource utilization that is not above a threshold, control proceeds to block 2314. At block 2314, the sustainable storage circuitry 1000 identifies one(s) of the node(s) to be transitioned to a reduced power state. For example, in response to a determination that the first one of the first nodes 1206 has a storage utilization of 10%, which is less than a storage utilization threshold of 15%, the green data management circuitry 1040 can instruct the first one of the first nodes 1206 to transition to a reduced power state such as a sleep state, an unpowered state, a disabled state, etc. In some examples, the green data management circuitry 1040 can transfer data stored at the first one of the first nodes 1206 to a different node that has a storage utilization greater than the storage utilization of the first one of the first nodes 1206. For example, in response to the transfer, the green data management circuitry 1040 can spin or wind down the first one of the first nodes 1206 by releasing its resources to an available pool of resources. In some examples, the green data management circuitry 1040 can identify the released resources to be utilized by other one(s) of the first nodes 1206 for additional workloads.

In response to identifying one(s) of the node(s) to be transitioned to a reduced power state at block 2314, the example machine readable instructions and/or the example operations 2300 conclude. For example, the machine readable instructions and/or the example operations 2300 can return to block 1610 of the machine readable instructions and/or the operations 1600 of FIG. 16 to cause operation(s) at node(s) of the edge environment based on the data.

FIG. 24 is a flowchart representative of example machine readable instructions and/or example operations 2400 that may be executed and/or instantiated by processor circuitry to cause operation(s) at node(s) of the edge environment based on at least one of the data or the outputs, the node(s) associated with the data. In some examples, the machine readable instructions and/or the operations 2400 of FIG. 24 can be executed and/or instantiated by processor circuitry to implement block 1610 of the machine readable instructions and/or the operations 1600 of FIG. 16.

The example machine readable instructions and/or the example operations 2400 of FIG. 24 begin at block 2402, at which the sustainable storage circuitry 1000 executes a machine learning (ML) model to generate outputs representative of object detection. For example, the ML circuitry 1030 (FIG. 10) can execute the ML model 1068 (FIG. 10) using ingested data at a node, such as the first monitoring sensor 828 of FIG. 8, as inputs to the ML model 1068 to cause the ML model 1068 to generate outputs. In some examples, the ingested data can be video data that captures the first industrial machine 816 within a field of view of the first monitoring sensor 828. For example, the ML circuitry 1030 can execute and/or instantiate the ML model 1068 to generate outputs, which can be representative of and/or otherwise include a detection of the first industrial machine 816. In some examples, the operation execution circuitry 1050 (FIG. 10) can instruct, invoke, and/or otherwise cause the ML circuitry 1030 to execute and/or instantiate the ML model 1068.

At block 2404, the sustainable storage circuitry 1000 executes the ML model to generate outputs representative of object classification. For example, the ML circuitry 1030 can execute and/or instantiate the ML model 1068 to generate outputs, which can be representative of and/or otherwise include a classification of the first industrial machine 816 as a type of industrial machine, such as a lifting industrial machine, an autonomous lifting industrial machine or robot, etc.

At block 2406, the sustainable storage circuitry 1000 executes the ML model to generate outputs representative of object tracking. For example, the ML circuitry 1030 can execute and/or instantiate the ML model 1068 to generate outputs, which can be representative of and/or otherwise include motion tracking (e.g., a location or position, a position vector, a velocity vector, etc.) of the first industrial machine 816.

At block 2408, the sustainable storage circuitry 1000 executes the ML model to generate outputs representative of key performance indicators (KPIs). For example, the ML circuitry 1030 can execute and/or instantiate the ML model 1068 to generate outputs, which can be representative of and/or otherwise include a key performance indicator such as a number of items moved by the first industrial machine 816, an accuracy and/or efficiency associated with a completed task by the first industrial machine 816, etc.

At block 2410, the sustainable storage circuitry 1000 executes the ML model to generate outputs representative of parameters associated with an environment based on a policy. For example, the ML circuitry 1030 can execute and/or instantiate the ML model 1068 to generate outputs, which can be representative of and/or otherwise include a parameter (e.g., a value of the parameter) associated with the edge network environment 800. In some examples, the parameter can be a first resource utilization of the first monitoring sensor 828, a second resource utilization of the first industrial machine 816, a network resource utilization of network resources of the edge network environment 800, etc., and/or any combination(s) thereof.

At block 2412, the sustainable storage circuitry 1000 identifies operation(s) to be executed at node(s) based on the outputs. For example, the operation execution circuitry 1050 (FIG. 10) can identify an operation to be executed at a node, such as the first industrial machine 816, the edge cloud 810, etc., and/or any combination(s) thereof. In some examples, the operation execution circuitry 1050 can identify an operation at the first industrial machine 816, such as a change in position and/or velocity of the first industrial machine 816 based on at least one of the object detection, the object classification, the object tracking, the KPIs, or the parameters. In some examples, the operation execution circuitry 1050 can identify an operation based on data ingested at one(s) of the data sources 604 to cause the one(s) of the data sources 604 to achieve reduced environment impact. For example, the one(s) of the data sources 604 can generate sensor data; the operation execution circuitry 1050 can identify an operation to reduce resources associated with the one(s) of the data sources 604 based on the sensor data; and the one(s) of the data sources 604 can operate with reduced environment impact in response to execution of the operation.

At block 2414, the sustainable storage circuitry 1000 alerts the node(s) of the operation(s) to cause the operation(s) to be executed. For example, the operation execution circuitry 1050 can generate an alert indicative of an operation associated with the first industrial machine 816, such as performing a lift task or operation. In some examples, the operation execution circuitry 1050 can generate the alert to include a command, an instruction, etc., to cause the first industrial machine 816 to perform the operation. For example, the operation execution circuitry 1050 can transmit the alert to a controller, processor circuitry, etc., of the first industrial machine 816 to move to a different position in the edge network environment 800 (e.g., a different aisle, section, etc.) at a specified velocity to perform a lifting task or operation based on a determination that the first industrial machine 816 completed a previous lifting task or operation.

In response to alerting the node(s) of the operation(s) to cause the operation(s) to be executed at block 2414, the example machine readable instructions and/or the example operations 2400 conclude. For example, the machine readable instructions and/or the example operations 2400 can return to the machine readable instructions and/or the operations 1600 of FIG. 16.

FIG. 25 is a block diagram of an example processor platform 2500 structured to execute and/or instantiate the machine readable instructions and/or the operations of FIGS. 7 and/or 14-24 to implement the logical entity 601 of FIG. 6, and/or, more generally, the ADM system 600 of FIG. 6. The processor platform 2500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 2500 of the illustrated example includes processor circuitry 2512. The processor circuitry 2512 of the illustrated example is hardware. For example, the processor circuitry 2512 can be implemented by one or more integrated circuits, logic circuits, FPGAs, microprocessors, CPUs, GPUs, XPUs, DSPs, and/or microcontrollers from any desired family or manufacturer. The processor circuitry 2512 may be implemented by one or more semiconductor based (e.g., silicon based) devices. In this example, the processor circuitry 2512 implements the data ingestion manager 606, the data query manager 610, the data publishing manager 618 (identified by DATA PUBLISH MANAGER), the node manager 622, the data security manager 632, the algorithm manager/recommender 634 (identified by ALGORITHM MANAGER/REC), and the analytics manager 636 of FIG. 6.

The processor circuitry 2512 of the illustrated example includes a local memory 2513 (e.g., a cache, registers, etc.). The processor circuitry 2512 of the illustrated example is in communication with a main memory including a volatile memory 2514 and a non-volatile memory 2516 by a bus 2518. The volatile memory 2514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2516 may be implemented by flash memory and/or any other desired type of memory device. Access to the main memory 2514, 2516 of the illustrated example is controlled by a memory controller 2517.

The processor platform 2500 of the illustrated example also includes interface circuitry 2520. The interface circuitry 2520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2522 are connected to the interface circuitry 2520. The input device(s) 2522 permit(s) a user to enter data and/or commands into the processor circuitry 2512. The input device(s) 2522 can be implemented by, for example, a sensor (e.g., a light sensor, a humidity sensor, a motion sensor, a temperature sensor, etc.), an audio sensor, a microphone, a camera (still or video), a keyboard, a button, a mouse, a touchscreen, a track-pad, a trackball, an isopoint device, and/or a voice recognition system.

One or more output devices 2524 are also connected to the interface circuitry 2520 of the illustrated example. The output device(s) 2524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2520 of the illustrated example, thus, typically includes a graphics driver card, a graphics driver chip, and/or graphics processor circuitry such as a GPU.

The interface circuitry 2520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2500 of the illustrated example also includes one or more mass storage devices 2528 to store software and/or data. Examples of such mass storage devices 2528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the one or more mass storage devices 2528 implement the distributed datastore 644, the metadata datastore 646, and the raw datastore 648 of FIG. 6.

The machine executable instructions 2532, which may be implemented by the machine readable instructions of FIGS. 7 and/or 14-24, may be stored in the mass storage device 2528, in the volatile memory 2514, in the non-volatile memory 2516, and/or on a removable non-transitory computer readable storage medium such as a CD or DVD.

The processor platform 2500 of the illustrated example of FIG. 25 includes example acceleration circuitry 2540, which includes an example graphics processing unit (GPU) 2542, an example vision processing unit (VPU) 2544, and an example neural network processor 2546. In this example, the GPU 2542, the VPU 2544, and the neural network processor 2546 are in communication with different hardware of the processor platform 2500, such as the volatile memory 2514, the non-volatile memory 2516, etc., via the bus 2518. In this example, the neural network processor 2546 may be implemented by one or more integrated circuits, logic circuits, microprocessors, GPUs, DSPs, or controllers from any desired family or manufacturer that can be used to execute an AI model, such as a neural network, which may be implemented by the algorithms 638 of FIG. 6. In some examples, one or more of the data ingestion manager 606, the data query manager 610, the data publishing manager 618, the node manager 622, the data security manager 632, the algorithm manager/recommender 634, and/or the analytics manager 636 of FIG. 6 can be implemented in or with at least one of the GPU 2542, the VPU 2544, or the neural network processor 2546 instead of or in addition to the processor circuitry 2512.

FIG. 26 is a block diagram of an example processor platform 2600 structured to execute and/or instantiate the machine readable instructions and/or the operations of FIGS. 7 and/or 14-24 to implement the sustainable storage circuitry 1000 of FIG. 10. The processor platform 2600 can be, for example, a server, a personal computer, a workstation, a self-learning machine (e.g., a neural network), a mobile device (e.g., a cell phone, a smart phone, a tablet such as an iPad™), a PDA, an Internet appliance, a DVD player, a CD player, a digital video recorder, a Blu-ray player, a gaming console, a personal video recorder, a set top box, a headset (e.g., an AR headset, a VR headset, etc.) or other wearable device, or any other type of computing device.

The processor platform 2600 of the illustrated example includes processor circuitry 2612. The processor circuitry 2612 of the illustrated example is hardware. For example, the processor circuitry 2612 can be implemented by one or more integrated circuits, logic circuits, FPGAs, microprocessors, CPUs, GPUs, XPUs, DSPs, and/or microcontrollers from any desired family or manufacturer. The processor circuitry 2612 may be implemented by one or more semiconductor based (e.g., silicon based) devices. In this example, the processor circuitry 2612 implements the resource orchestration circuitry 1020 (identified by RESOURCE ORCH CIRCUITRY), the ML circuitry 1030, the green data management circuitry 1040 (identified by GREEN DATA MGMT CIRCUITRY), and the operation execution circuitry 1050 (identified by OPERATION EXE CIRCUITRY) of FIG. 10.

The processor circuitry 2612 of the illustrated example includes a local memory 2613 (e.g., a cache, registers, etc.). The processor circuitry 2612 of the illustrated example is in communication with a main memory including a volatile memory 2614 and a non-volatile memory 2616 by a bus 2618. The volatile memory 2614 may be implemented by SDRAM, DRAM, RDRAM®, and/or any other type of RAM device. The non-volatile memory 2616 may be implemented by flash memory and/or any other desired type of memory device. Access to the main memory 2614, 2616 of the illustrated example is controlled by a memory controller 2617.

The processor platform 2600 of the illustrated example also includes interface circuitry 2620. The interface circuitry 2620 may be implemented by hardware in accordance with any type of interface standard, such as an Ethernet interface, a USB interface, a Bluetooth® interface, a NFC interface, a PCI interface, and/or a PCIe interface. In this example, the interface circuitry 2620 implements the interface circuitry 1010 of FIG. 10.

In the illustrated example, one or more input devices 2622 are connected to the interface circuitry 2620. The input device(s) 2622 permit(s) a user to enter data and/or commands into the processor circuitry 2612. The input device(s) 2622 can be implemented by, for example, a sensor (e.g., a light sensor, a humidity sensor, a motion sensor, a temperature sensor, etc.), an audio sensor, a microphone, a camera (still or video), a keyboard, a button, a mouse, a touchscreen, a track-pad, a trackball, an isopoint device, and/or a voice recognition system.

One or more output devices 2624 are also connected to the interface circuitry 2620 of the illustrated example. The output device(s) 2624 can be implemented, for example, by display devices (e.g., an LED, an OLED, an LCD, a CRT display, an IPS display, a touchscreen, etc.), a tactile output device, a printer, and/or speaker. The interface circuitry 2620 of the illustrated example, thus, typically includes a graphics driver card, a graphics driver chip, and/or graphics processor circuitry such as a GPU.

The interface circuitry 2620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2626. The communication can be by, for example, an Ethernet connection, a DSL connection, a telephone line connection, a coaxial cable system, a satellite system, a line-of-site wireless system, a cellular telephone system, an optical connection, etc.

The processor platform 2600 of the illustrated example also includes one or more mass storage devices 2628 to store software and/or data. Examples of such mass storage devices 2628 include magnetic storage devices, optical storage devices, floppy disk drives, HDDs, CDs, Blu-ray disk drives, RAID systems, solid state storage devices such as flash memory devices and/or SSDs, and DVD drives. In this example, the one or more mass storage devices 2628 implement the datastore 1060, the policy 1062, the metadata 1064, the data graph model 1066, and the ML model 1068 of FIG. 10.

The machine executable instructions 2632, which may be implemented by the machine readable instructions of FIGS. 7 and/or 14-24, may be stored in the mass storage device 2628, in the volatile memory 2614, in the non-volatile memory 2616, and/or on a removable non-transitory computer readable storage medium such as a CD or DVD.

The processor platform 2600 of the illustrated example of FIG. 26 includes example acceleration circuitry 2640, which includes an example graphics processing unit (GPU) 2642, an example vision processing unit (VPU) 2644, and an example neural network processor 2646. In this example, the GPU 2642, the VPU 2644, and the neural network processor 2646 are in communication with different hardware of the processor platform 2600, such as the volatile memory 2614, the non-volatile memory 2616, etc., via the bus 2618. In this example, the neural network processor 2646 may be implemented by one or more integrated circuits, logic circuits, microprocessors, GPUs, DSPs, or controllers from any desired family or manufacturer that can be used to execute an AI model, such as a neural network, which may be implemented by the ML model 1068 of FIG. 10. In some examples, one or more of the resource orchestration circuitry 1020, the ML circuitry 1030, the green data management circuitry 1040, and/or the operation execution circuitry 1050 can be implemented in or with at least one of the GPU 2642, the VPU 2644, or the neural network processor 2646 instead of or in addition to the processor circuitry 2612.

FIG. 27 is a block diagram of an example implementation of the processor circuitry 2512 of FIG. 25 and/or the processor circuitry 2612 of FIG. 26. In this example, the processor circuitry 2512 of FIG. 25 and/or the processor circuitry 2612 of FIG. 26 is implemented by a general purpose microprocessor 2700. The general purpose microprocessor circuitry 2700 executes some or all of the machine readable instructions of the flowcharts of FIGS. 7 and/or 14-24 to effectively instantiate the sustainable storage circuitry 1000 of FIG. 10 as logic circuits to perform the operations corresponding to those machine readable instructions. In some such examples, the sustainable storage circuitry 1000 of FIG. 10 is instantiated by the hardware circuits of the microprocessor 2700 in combination with the instructions. For example, the microprocessor 2700 may implement multi-core hardware circuitry such as a CPU, a DSP, a GPU, an XPU, an ASIC, etc. Although it may include any number of example cores 2702 (e.g., 1 core), the microprocessor 2700 of this example is a multi-core semiconductor device including N cores. The cores 2702 of the microprocessor 2700 may operate independently or may cooperate to execute machine readable instructions. For example, machine code corresponding to a firmware program, an embedded software program, or a software program may be executed by one of the cores 2702 or may be executed by multiple ones of the cores 2702 at the same or different times. In some examples, the machine code corresponding to the firmware program, the embedded software program, or the software program is split into threads and executed in parallel by two or more of the cores 2702. The software program may correspond to a portion or all of the machine readable instructions and/or operations represented by the flowcharts of FIGS. 7 and/or 14-24.

The cores 2702 may communicate by a first example bus 2704. In some examples, the first bus 2704 may implement a communication bus to effectuate communication associated with one(s) of the cores 2702. For example, the first bus 2704 may implement at least one of an Inter-Integrated Circuit (I2C) bus, a Serial Peripheral Interface (SPI) bus, a PCI bus, or a PCIe bus. Additionally or alternatively, the first bus 2704 may implement any other type of computing or electrical bus. The cores 2702 may obtain data, instructions, and/or signals from one or more external devices by example interface circuitry 2706. The cores 2702 may output data, instructions, and/or signals to the one or more external devices by the interface circuitry 2706. Although the cores 2702 of this example include example local memory 2720 (e.g., Level 1 (L1) cache that may be split into an L1 data cache and an L1 instruction cache), the microprocessor 2700 also includes example shared memory 2710 that may be shared by the cores (e.g., Level 2 (L2_cache)) for high-speed access to data and/or instructions. Data and/or instructions may be transferred (e.g., shared) by writing to and/or reading from the shared memory 2710. The local memory 2720 of each of the cores 2702 and the shared memory 2710 may be part of a hierarchy of storage devices including multiple levels of cache memory and the main memory (e.g., the main memory 2514, 2516 of FIG. 25, the main memory 2614, 2616 of FIG. 26, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2702 may be referred to as a CPU, DSP, GPU, etc., or any other type of hardware circuitry. Each core 2702 includes control unit circuitry 2714, arithmetic and logic (AL) circuitry (sometimes referred to as an ALU) 2716, a plurality of registers 2718, the L1 cache 2720, and a second example bus 2722. Other structures may be present. For example, each core 2702 may include vector unit circuitry, single instruction multiple data (SIMD) unit circuitry, load/store unit (LSU) circuitry, branch/jump unit circuitry, floating-point unit (FPU) circuitry, etc. The control unit circuitry 2714 includes semiconductor-based circuits structured to control (e.g., coordinate) data movement within the corresponding core 2702. The AL circuitry 2716 includes semiconductor-based circuits structured to perform one or more mathematic and/or logic operations on the data within the corresponding core 2702. The AL circuitry 2716 of some examples performs integer based operations. In other examples, the AL circuitry 2716 also performs floating point operations. In yet other examples, the AL circuitry 2716 may include first AL circuitry that performs integer based operations and second AL circuitry that performs floating point operations. In some examples, the AL circuitry 2716 may be referred to as an Arithmetic Logic Unit (ALU). The registers 2718 are semiconductor-based structures to store data and/or instructions such as results of one or more of the operations performed by the AL circuitry 2716 of the corresponding core 2702. For example, the registers 2718 may include vector register(s), SIMD register(s), general purpose register(s), flag register(s), segment register(s), machine specific register(s), instruction pointer register(s), control register(s), debug register(s), memory management register(s), machine check register(s), etc. The registers 2718 may be arranged in a bank as shown in FIG. 27. Alternatively, the registers 2718 may be organized in any other arrangement, format, or structure including distributed throughout the core 2702 to shorten access time. The second bus 2722 may implement at least one of an I2C bus, a SPI bus, a PCI bus, or a PCIe bus

Each core 2702 and/or, more generally, the microprocessor 2700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 28 is a block diagram of another example implementation of the processor circuitry 2512 of FIG. 25 and/or the processor circuitry 2612 of FIG. 26. In this example, the processor circuitry 2512 and/or the processor circuitry 2612 is implemented by FPGA circuitry 2800. The FPGA circuitry 2800 can be used, for example, to perform operations that could otherwise be performed by the example microprocessor 2700 of FIG. 27 executing corresponding machine readable instructions. However, once configured, the FPGA circuitry 2800 instantiates the machine readable instructions in hardware and, thus, can often execute the operations faster than they could be performed by a general purpose microprocessor executing the corresponding software.

More specifically, in contrast to the microprocessor 2700 of FIG. 27 described above (which is a general purpose device that may be programmed to execute some or all of the machine readable instructions represented by the flowcharts of FIGS. 7 and/or 14-24 but whose interconnections and logic circuitry are fixed once fabricated), the FPGA circuitry 2800 of the example of FIG. 28 includes interconnections and logic circuitry that may be configured and/or interconnected in different ways after fabrication to instantiate, for example, some or all of the machine readable instructions represented by the flowcharts of FIGS. 7 and/or 14-24. In particular, the FPGA 2800 may be thought of as an array of logic gates, interconnections, and switches. The switches can be programmed to change how the logic gates are interconnected by the interconnections, effectively forming one or more dedicated logic circuits (unless and until the FPGA circuitry 2800 is reprogrammed). The configured logic circuits enable the logic gates to cooperate in different ways to perform different operations on data received by input circuitry. Those operations may correspond to some or all of the software represented by the flowcharts of FIGS. 7 and/or 14-24. As such, the FPGA circuitry 2800 may be structured to effectively instantiate some or all of the machine readable instructions of the flowcharts of FIGS. 7 and/or 14-24 as dedicated logic circuits to perform the operations corresponding to those software instructions in a dedicated manner analogous to an ASIC. Therefore, the FPGA circuitry 2800 may perform the operations corresponding to the some or all of the machine readable instructions of FIGS. 7 and/or 14-24 faster than the general purpose microprocessor can execute the same.

In the example of FIG. 28, the FPGA circuitry 2800 is structured to be programmed (and/or reprogrammed one or more times) by an end user by a hardware description language (HDL) such as Verilog. The FPGA circuitry 2800 of FIG. 28, includes example input/output (I/O) circuitry 2802 to obtain and/or output data to/from example configuration circuitry 2804 and/or external hardware (e.g., external hardware circuitry) 2806. For example, the configuration circuitry 2804 may implement interface circuitry that may obtain machine readable instructions to configure the FPGA circuitry 2800, or portion(s) thereof. In some such examples, the configuration circuitry 2804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2806 may implement the microprocessor 2700 of FIG. 27. The FPGA circuitry 2800 also includes an array of example logic gate circuitry 2808, a plurality of example configurable interconnections 2810, and example storage circuitry 2812. The logic gate circuitry 2808 and interconnections 2810 are configurable to instantiate one or more operations that may correspond to at least some of the machine readable instructions of FIGS. 7 and/or 14-24 and/or other desired operations. The logic gate circuitry 2808 shown in FIG. 28 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2808 to enable configuration of the electrical structures and/or the logic gates to form circuits to perform desired operations. The logic gate circuitry 2808 may include other electrical structures such as look-up tables (LUTs), registers (e.g., flip-flops or latches), multiplexers, etc.

The interconnections 2810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2808 to program desired logic circuits.

The storage circuitry 2812 of the illustrated example is structured to store result(s) of the one or more of the operations performed by corresponding logic gates. The storage circuitry 2812 may be implemented by registers or the like. In the illustrated example, the storage circuitry 2812 is distributed amongst the logic gate circuitry 2808 to facilitate access and increase execution speed.

The example FPGA circuitry 2800 of FIG. 28 also includes example Dedicated Operations Circuitry 2814. In this example, the Dedicated Operations Circuitry 2814 includes special purpose circuitry 2816 that may be invoked to implement commonly used functions to avoid the need to program those functions in the field. Examples of such special purpose circuitry 2816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2800 may also include example general purpose programmable circuitry 2818 such as an example CPU 2820 and/or an example DSP 2822. Other general purpose programmable circuitry 2818 may additionally or alternatively be present such as a GPU, an XPU, etc., that can be programmed to perform other operations.

Although FIGS. 27 and 28 illustrate two example implementations of the processor circuitry 2712 of FIG. 27 and/or the processor circuitry 2818 of FIG. 28, many other approaches are contemplated. For example, as mentioned above, modern FPGA circuitry may include an on-board CPU, such as one or more of the example CPU 2820 of FIG. 28. Therefore, the processor circuitry 2512 of FIG. 25 and/or the processor circuitry 2612 of FIG. 26 may additionally be implemented by combining the example microprocessor 2700 of FIG. 27 and the example FPGA circuitry 2800 of FIG. 28. In some such hybrid examples, a first portion of the machine readable instructions represented by the flowcharts of FIGS. 7 and/or 14-24 may be executed by one or more of the cores 2702 of FIG. 27, a second portion of the machine readable instructions represented by the flowcharts of FIGS. 7 and/or 14-24 may be executed by the FPGA circuitry 2800 of FIG. 28, and/or a third portion of the machine readable instructions represented by the flowcharts of FIGS. 7 and/or 14-24 may be executed by an ASIC. It should be understood that some or all of the sustainable storage circuitry 1000 of FIG. 10 may, thus, be instantiated at the same or different times. Some or all of the circuitry may be instantiated, for example, in one or more threads executing concurrently and/or in series. Moreover, in some examples, some or all of the sustainable storage circuitry 1000 of FIG. 10 may be implemented within one or more virtual machines and/or containers executing on the microprocessor.

In some examples, the processor circuitry 2512 of FIG. 25 and/or the processor circuitry 2612 of FIG. 26 may be in one or more packages. For example, the processor circuitry 2700 of FIG. 27 and/or the FPGA circuitry 2800 of FIG. 28 may be in one or more packages. In some examples, an XPU may be implemented by the processor circuitry 2512 of FIG. 25 and/or the processor circuitry 2612 of FIG. 26, which may be in one or more packages. For example, the XPU may include a CPU in one package, a DSP in another package, a GPU in yet another package, and an FPGA in still yet another package.

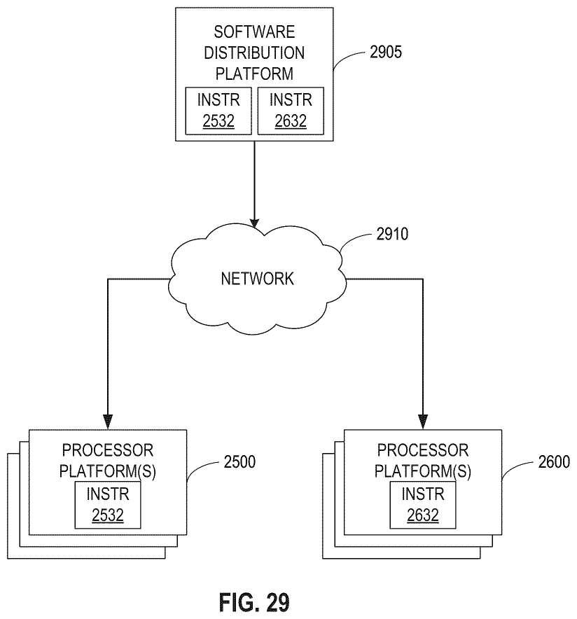

A block diagram illustrating an example software distribution platform 2905 to distribute software such as the example machine readable instructions 2532 of FIG. 25 and/or the example machine readable instructions 2632 of FIG. 26 to hardware devices owned and/or operated by third parties is illustrated in FIG. 29. The example software distribution platform 2905 may be implemented by any computer server, data facility, cloud service, etc., capable of storing and transmitting software to other computing devices. The third parties may be customers of the entity owning and/or operating the software distribution platform 2905. For example, the entity that owns and/or operates the software distribution platform 2905 may be a developer, a seller, and/or a licensor of software such as the example machine readable instructions 2532 of FIG. 25 and/or the example machine readable instructions 2632 of FIG. 26. The third parties may be consumers, users, retailers, OEMs, etc., who purchase and/or license the software for use and/or re-sale and/or sub-licensing. In the illustrated example, the software distribution platform 2905 includes one or more servers and one or more storage devices. The storage devices store the machine readable instructions 2532, which may correspond to the example machine readable instructions 700, 1400, 1500, 1600, 1700, 1800, 1900, 2000, 2100, 2200, 2300, 2400 of FIGS. 7 and/or 14-24, as described above. The one or more servers of the example software distribution platform 2905 are in communication with a network 2910, which may correspond to any one or more of the Internet and/or any of the example networks 110, 806, 808, 2526, 2626 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 2532, 2632 from the software distribution platform 2905. For example, the software, which may correspond to the example machine readable instructions 700, 1400, 1500, 1600, 1700, 1800, 1900, 2000, 2100, 2200, 2300, 2400 of FIGS. 7 and/or 14-24, may be downloaded to (i) the example processor platform 2500, which is to execute the machine readable instructions 2532 to implement the logical entity 601, and/or, more generally, the ADM system 600 of FIG. 6, and/or (ii) the example processor platform 2600, which is to execute the machine readable instructions 2632 to implement the sustainable storage circuitry 1000 of FIG. 10. In some examples, one or more servers of the software distribution platform 2905 periodically offer, transmit, and/or force updates to the software (e.g., the example machine readable instructions 2532 of FIG. 25, the example machine readable instructions 2632 of FIG. 26, etc.) to ensure improvements, patches, updates, etc., are distributed and applied to the software at the end user devices.

From the foregoing, it will be appreciated that example systems, methods, apparatus, and articles of manufacture have been disclosed for data collection balancing for sustainable storage. Disclosed systems, methods, apparatus, and articles of manufacture identify measures of data criticality and/or data quality associated with data at one or more nodes. Disclosed systems, methods, apparatus, and articles of manufacture can determine to reduce resources, such as storage resources, associated with the data based on the measures of data criticality and/or the data quality. Disclosed systems, methods, apparatus, and articles of manufacture can reduce the storage resources by compressing the data, discarding the data, etc., based on whether the data is identified as being critical and/or otherwise relevant to the one or more nodes. Disclosed systems, methods, apparatus, and articles of manufacture improve the efficiency of using a computing device by reducing the resources that may be required to effectuate completion of workload(s) at the one or more nodes by storing less data compared to prior data management techniques and, thus, less computational workloads may be needed to maintain, upkeep, and/or otherwise process stored data. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for data collection balancing for sustainable storage are disclosed herein. Further examples and combinations thereof include the following:

Example 1 includes an apparatus for data collection balancing, the apparatus comprising at least one memory, machine executable instructions, and processor circuitry to at least one of execute or instantiate the machine executable instructions to orchestrate resources in an edge environment based on data ingested from a data source, execute a machine learning model based on the data to generate outputs, the outputs including at least one of a first value representative of data criticality or a second value representative of data quality of the data, reduce resource requirements associated with the resources of the edge environment based on the outputs to effectuate green data management of the edge environment, and cause an operation at a node of the edge environment based on at least one of the data or the outputs, the node associated with the data.

In Example 2, the subject matter of Example 1 can optionally include that the processor circuitry is to determine at least one of a potential consequence if the data is not processed or stored, a latency requirement associated with the data, a number of nodes in the edge environment that are associated with the data, a purpose of a workload associated with the data, a size of the workload, a priority of the data, or a regulatory requirement associated with the data, and execute the machine learning model to determine the first value of the data criticality of the data based on the at least one of the potential consequence, the latency requirement, the number of nodes, the purpose, the priority, or the regulatory requirement.

In Example 3, the subject matter of Examples 1-2 can optionally include that the processor circuitry is to determine at least one of an accuracy of the data, a completeness of the data, a consistency of the data, a currency of the data, a redundancy of the data in the edge environment, a timeliness of the data, or a validity of the data, and execute the machine learning model to determine the second value of the data quality of the data based on at least one of the accuracy, the completeness, the consistency, the currency, the redundancy, the timeliness, or the validity.

In Example 4, the subject matter of Examples 1-3 can optionally include that the processor circuitry is to ingest the data from a plurality of data sources at the node, the plurality of the data sources including the data source, tag a portion of the data with metadata, query an orchestrator to identify the machine learning model as associated with the metadata, and execute the machine learning model at the node to determine the at least one of the first value of the data criticality or the second value of the data quality of the data.

In Example 5, the subject matter of Examples 1-4 can optionally include that the processor circuitry is to obtain an orchestration policy indicative of at least one of a quantity or a type of workloads to be executed in the edge environment, instantiate resources in the edge environment to execute a workload based on the orchestration policy, the resources including at least one of compute resources or network resources, generate a topology associated with the resources to at least one of execute the workload with one or more of the compute resources or route the data in the edge environment with one or more of the network resources, identify the node as a preferred node in the edge environment based on the topology, the preferred node to generate local determinations associated with the data, and deploy the machine learning model to the node in response to an identification of the node as the preferred node.

In Example 6, the subject matter of Examples 1-5 can optionally include that the processor circuitry is to, in response to a determination that at least one of the first value or the second value satisfies a threshold, update at least one of baseline data or ground truth data stored in a datastore based on the data.

In Example 7, the subject matter of Examples 1-6 can optionally include that the processor circuitry is to, in response to a determination that the first value and the second value do not satisfy a threshold, tag the data for a green data management operation to effectuate green data management, the green data management operation including at least one of a discard of one or more portions of the data or a replacement of the one or more portions of the data with a symbolic representation to reduce the resource requirements associated with the one or more portions of the data.

In Example 8, the subject matter of Examples 1-7 can optionally include that the node is a first node, and the processor circuitry is to determine a first resource utilization of the first node, and in response to a determination that the first resource utilization satisfies a threshold, reduce the first resource utilization of the node through at least one of a reduction in ingesting new data or a rerouting of processing the new data to a second node with a second resource utilization less than the first resource utilization.

In Example 9, the subject matter of Examples 1-8 can optionally include that the node is a first node, and the processor circuitry is to, in response to a determination that a resource utilization of a second node does not satisfy a threshold, identify the second node to be transitioned to a reduced power state to effectuate green data management.

Example 10 includes at least one non-transitory computer readable storage medium comprising instructions that, when executed, cause processor circuitry to at least instantiate resources in an edge environment based on data obtained from a data source, execute a machine learning model based on the data to generate outputs, the outputs including at least one of a first value representative of data criticality or a second value representative of data quality of the data, reduce resource requirements associated with the resources of the edge environment to facilitate green data management based on the outputs, and cause an operation at a node of the edge environment based on at least one of the data or the outputs, the node associated with the data.

In Example 11, the subject matter of Example 10 can optionally include that the instructions, when executed, cause the processor circuitry to determine at least one of a potential consequence if the data is not processed or stored, a latency requirement associated with the data, a number of nodes in the edge environment that are associated with the data, a purpose of a workload associated with the data, a size of the workload, a priority of the data, or a regulatory requirement associated with the data, and execute the machine learning model to determine the first value of the data criticality of the data based on the at least one of the potential consequence, the latency requirement, the number of nodes, the purpose, the priority, or the regulatory requirement.

In Example 12, the subject matter of Examples 10-11 can optionally include that the instructions, when executed, cause the processor circuitry to determine at least one of an accuracy of the data, a completeness of the data, a consistency of the data, a currency of the data, a redundancy of the data in the edge environment, a timeliness of the data, or a validity of the data, and execute the machine learning model to determine the second value of the data quality of the data based on at least one of the accuracy, the completeness, the consistency, the currency, the redundancy, the timeliness, or the validity.

In Example 13, the subject matter of Examples 10-12 can optionally include that the instructions, when executed, cause the processor circuitry to obtain the data from the data source at the node, assign metadata to a portion of the data, request an orchestrator to identify the machine learning model as associated with the metadata, and execute the machine learning model at the node to determine the at least one of the first value of the data criticality or the second value of the data quality of the data.

In Example 14, the subject matter of Examples 10-13 can optionally include that the instructions, when executed, cause the processor circuitry to obtain an orchestration policy indicative of at least one of a quantity or a type of workloads to be executed in the edge environment, cause resources in the edge environment to execute a workload based on the orchestration policy, the resources including at least one of compute resources or network resources, create a topology associated with the resources to at least one of execute the workload with one or more of the compute resources or route the data in the edge environment with one or more of the network resources, label the node as a preferred node in the edge environment based on the topology, the preferred node to generate local determinations associated with the data, and provide the machine learning model to the node in response to an identification of the node as the preferred node.

In Example 15, the subject matter of Examples 10-14 can optionally include that the instructions, when executed, cause the processor circuitry to, in response to a determination that at least one of the first value or the second value satisfies a threshold, update baseline data stored in a datastore based on the data.

In Example 16, the subject matter of Examples 10-15 can optionally include that the instructions, when executed, cause the processor circuitry to, in response to a determination that the first value and the second value do not satisfy a threshold, tag the data for a green data management operation to effectuate green data management, the green data management operation including at least one of a discard of one or more portions of the data or a replacement of the one or more portions of the data with a symbolic representation to reduce the resource requirements associated with the one or more portions of the data.

In Example 17, the subject matter of Examples 10-16 can optionally include that the node is a first node, and the instructions, when executed, cause the processor circuitry to determine a first resource utilization of the first node, and in response to a determination that the first resource utilization satisfies a threshold, reduce the first resource utilization of the node through at least one of a reduction in ingesting new data or a rerouting of processing the new data to a second node with a second resource utilization less than the first resource utilization.

In Example 18, the subject matter of Examples 10-17 can optionally include that the node is a first node, and the instructions, when executed, cause the processor circuitry to, in response to a determination that a resource utilization of a second node does not satisfy a threshold, identify the second node to be transitioned to a reduced power state to effectuate green data management.

Example 19 includes an apparatus for data collection balancing, the apparatus comprising means for orchestrating resources in an edge environment based on data ingested from a data source, means for executing a machine learning model based on the data to generate outputs, the outputs including at least one of a first value representative of data criticality or a second value representative of data quality of the data, means for reducing resource requirements associated with the resources of the edge environment to effectuate green data management based on the outputs, and means for causing an operation at a node of the edge environment based on at least one of the data or the outputs, the node associated with the data.

In Example 20, the subject matter of Example 19 can optionally include that the means for executing is to determine at least one of a potential consequence if the data is not processed or stored, a latency requirement associated with the data, a number of nodes in the edge environment that are associated with the data, a purpose of a workload associated with the data, a size of the workload, a priority of the data, or a regulatory requirement associated with the data, and execute the machine learning model to determine the first value of the data criticality of the data based on the at least one of the potential consequence, the latency requirement, the number of nodes, the purpose, the priority, or the regulatory requirement.

In Example 21, the subject matter of Examples 19-20 can optionally include that the means for executing is to determine at least one of an accuracy of the data, a completeness of the data, a consistency of the data, a currency of the data, a redundancy of the data in the edge environment, a timeliness of the data, or a validity of the data, and execute the machine learning model to determine the second value of the data quality of the data based on at least one of the accuracy, the completeness, the consistency, the currency, the redundancy, the timeliness, or the validity.

In Example 22, the subject matter of Examples 19-21 can optionally include means for ingesting to ingest the data from multiple ones of data sources at the node, the multiple ones of the data sources including the data source, tag a portion of the data with metadata, query an orchestrator to identify the machine learning model as associated with the metadata, and execute the machine learning model at the node to determine the at least one of the first value of the data criticality or the second value of the data quality of the data.

In Example 23, the subject matter of Examples 19-22 can optionally include that the means for orchestrating is to obtain an orchestration policy indicative of at least one of a quantity or a type of workloads to be executed in the edge environment, instantiate resources in the edge environment to execute a workload based on the orchestration policy, the resources including at least one of compute resources or network resources, generate a topology associated with the resources to at least one of execute the workload with one or more of the compute resources or route the data in the edge environment with one or more of the network resources, identify the node as a preferred node in the edge environment based on the topology, the preferred node to generate local determinations associated with the data, and deploy the machine learning model to the node in response to an identification of the node as the preferred node.

In Example 24, the subject matter of Examples 19-23 can optionally include that the means for executing is to, in response to a determination that at least one of the first value or the second value satisfies a threshold, update baseline data stored in a datastore based on the data.

In Example 25, the subject matter of Examples 19-24 can optionally include that the means for executing is to, in response to a determination that the first value and the second value do not satisfy a threshold, tag the data for a green data management operation to effectuate green data management, the green data management operation including at least one of a discard of one or more portions of the data or a replacement of the one or more portions of the data with a symbolic representation to reduce the resource requirements associated with the one or more portions of the data.

In Example 26, the subject matter of Examples 19-25 can optionally include that the node is a first node, and the means for reducing is to determine a first resource utilization of the first node, and in response to a determination that the first resource utilization satisfies a threshold, reduce the first resource utilization of the node through at least one of a reduction in ingesting new data or a rerouting of processing the new data to a second node with a second resource utilization less than the first resource utilization.

In Example 27, the subject matter of Examples 19-26 can optionally include that the node is a first node, and the means for reducing is to, in response to a determination that a resource utilization of a second node does not satisfy a threshold, identify the second node to be transitioned to a reduced power state to effectuate green data management.

Example 28 includes a method for data collection balancing, the method comprising orchestrating resources in an edge environment based on data ingested from a data source, executing a machine learning model based on the data to generate outputs, the outputs including at least one of a first value representative of data criticality or a second value representative of data quality of the data, reducing resource requirements associated with the resources of the edge environment to effectuate green data management based on the outputs, and causing an operation at a node of the edge environment based on at least one of the data or the outputs, the node associated with the data.

In Example 29, the subject matter of Example 28 can optionally include determining at least one of a potential consequence if the data is not processed or stored, a latency requirement associated with the data, a number of nodes in the edge environment that are associated with the data, a purpose of a workload associated with the data, a size of the workload, a priority of the data, or a regulatory requirement associated with the data, and executing the machine learning model to determine the first value of the data criticality of the data based on the at least one of the potential consequence, the latency requirement, the number of nodes, the purpose, the priority, or the regulatory requirement.

In Example 30, the subject matter of Examples 28-29 can optionally include determining at least one of an accuracy of the data, a completeness of the data, a consistency of the data, a currency of the data, a redundancy of the data in the edge environment, a timeliness of the data, or a validity of the data, and executing the machine learning model to determine the second value of the data quality of the data based on at least one of the accuracy, the completeness, the consistency, the currency, the redundancy, the timeliness, or the validity.

In Example 31, the subject matter of Examples 28-30 can optionally include ingesting the data from the data source at the node, tagging a portion of the data with metadata, querying an orchestrator to identify the machine learning model as associated with the metadata, and executing the machine learning model at the node to determine the at least one of the first value of the data criticality or the second value of the data quality of the data.

In Example 32, the subject matter of Examples 28-31 can optionally include obtaining an orchestration policy indicative of at least one of a quantity or a type of workloads to be executed in the edge environment, instantiating resources in the edge environment to execute a workload based on the orchestration policy, the resources including at least one of compute resources or network resources, generating a topology associated with the resources to at least one of execute the workload with one or more of the compute resources or route the data in the edge environment with one or more of the network resources, identifying the node as a preferred node in the edge environment based on the topology, the preferred node to generate local determinations associated with the data, and deploying the machine learning model to the node in response to an identification of the node as the preferred node.

In Example 33, the subject matter of Examples 28-32 can optionally include, in response to a determination that at least one of the first value or the second value satisfies a threshold, update baseline data or ground truth data stored in a datastore based on the data.

In Example 34, the subject matter of Examples 28-33 can optionally include, in response to a determination that the first value and the second value do not satisfy a threshold, tagging the data for a green data management operation to effectuate green data management, the green data management operation including at least one of a discard of one or more portions of the data or a replacement of the one or more portions of the data with a symbolic representation to reduce the resource requirements associated with the one or more portions of the data.

In Example 35, the subject matter of Examples 28-34 can optionally include that the node is a first node, and the method further including determining a first resource utilization of the first node, and in response to a determination that the first resource utilization satisfies a threshold, reducing the first resource utilization of the node through at least one of a reduction in ingesting new data or a rerouting of processing the new data to a second node with a second resource utilization less than the first resource utilization.

In Example 36, the subject matter of Examples 28-35 can optionally include that the node is a first node, and the method further including, in response to a determination that a resource utilization of a second node does not satisfy a threshold, identifying the second node to be transitioned to a reduced power state to effectuate green data management.

Example 37 is at least one computer readable medium comprising instructions to perform the method of any of Examples 28-36.

Example 38 is an apparatus comprising processor circuitry to perform the method of any of Examples 28-36.

Example 39 is edge server processor circuitry to perform the method of any of Examples 28-36.

Example 40 is edge cloud processor circuitry to perform the method of any of Examples 28-36.

Example 41 is edge node processor circuitry to perform the method of any of Examples 28-36.

Example 42 is edge gateway processor circuitry to perform the method of any of Examples 28-36.

Example 43 is edge switch processor circuitry to perform the method of any of Examples 28-36.

Example 44 is an apparatus comprising network interface circuitry to perform the method of any of Examples 28-36.

Example 45 is an XPU to perform the method of any of Examples 28-36.

Example 46 is an Infrastructure Processing Unit to perform the method of any of Examples 28-36.

Example 47 is an apparatus comprising one or more edge gateways to perform the method of any of Examples 28-36.

Example 48 is an apparatus comprising one or more edge switches to perform the method of any of Examples 28-36.

Example 49 is an apparatus comprising at least one of one or more edge gateways or one or more edge switches to perform the method of any of Examples 28-36.

Example 50 is an apparatus comprising acceleration circuitry to perform the method of any of Examples 28-36.

Example 51 is an apparatus comprising one or more graphics processor units to perform the method of any of Examples 28-36.

Example 51 is an apparatus comprising one or more vision processor units to perform the method of any of Examples 28-36.

Example 52 is an apparatus comprising one or more Artificial Intelligence processors to perform the method of any of Examples 28-36.

Example 53 is an apparatus comprising one or more machine learning processors to perform the method of any of Examples 28-36.

Example 54 is an apparatus comprising one or more neural network processors to perform the method of any of Examples 28-36.

Example 55 is an apparatus comprising one or more digital signal processors to perform the method of any of Examples 28-36.

Example 56 is an apparatus comprising one or more general purpose processors to perform the method of any of Examples 28-36.

Example 57 is a sensor comprising processor circuitry to perform the method of any of Examples 28-36.

Example 58 is an electronic device comprising processor circuitry to perform the method of any of Examples 28-36.

Example 59 is a processor platform comprising processor circuitry to perform the method of any of Examples 28-36.

Example 60 is an autonomous device comprising processor circuitry to perform the method of any of Examples 28-36.

Example 61 is autonomous equipment comprising processor circuitry to perform the method of any of Examples 28-36.

Example 62 is an adaptive data management system comprising processor circuitry to perform the method of any of Examples 28-36.

Example 63 is a computer program comprising the instructions of Example 37.

Example 64 is an Application Programming Interface defining functions, methods, variables, data structures, and/or protocols for the computer program of Example 63.

Example 65 is an apparatus comprising circuitry loaded with the instructions of Example 37.

Example 66 is an apparatus comprising circuitry operable to run the instructions of Example 37.

Example 67 is an integrated circuit comprising one or more of the processor circuitry of Example 37 and the at least one computer readable medium of Example 37.

Example 68 is a computing system comprising the at least one computer readable medium and the processor circuitry of Example 37.

Example 69 is an apparatus comprising means for executing the instructions of Example 37.

Example 70 is a signal generated as a result of executing the instructions of Example 37.

Example 71 is a data unit generated as a result of executing the instructions of Example 37.

In Example 72, the subject matter of Example 71 can optionally include that the data unit is a datagram, network packet, data frame, data segment, a Protocol Data Unit (PDU), a Service Data Unit (SDU), a message, or a database object.

In Example 73, the subject matter of Examples 71-72 can optionally include a signal encoded with the data unit.

Example 74 is an electromagnetic signal carrying the instructions of Example 37.

Example 75 is an apparatus comprising means for performing the method of Examples 28-36.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1.-41. (canceled)

42. An apparatus for data collection balancing, the apparatus comprising:
interface circuitry;
machine readable instructions; and
programmable circuitry to utilize the machine readable instructions to:
orchestrate resources in an edge environment based on data ingested from a data source;
execute a machine learning model based on the data to generate outputs, the outputs including at least one of a first value representative of data criticality or a second value representative of data quality of the data;
reduce resource requirements associated with the resources of the edge environment to effectuate green data management based on the outputs; and
cause an operation at a node of the edge environment based on at least one of the data or the outputs, the node associated with the data.

43. The apparatus of claim 42, wherein the programmable circuitry is to:
determine at least one of a potential consequence if the data is not processed or stored, a latency requirement associated with the data, a number of nodes in the edge environment that are associated with the data, a purpose of a workload associated with the data, a size of the workload, a priority of the data, or a regulatory requirement associated with the data; and
execute the machine learning model to determine the first value of the data criticality of the data based on the at least one of the potential consequence, the latency requirement, the number of nodes, the purpose, the priority, or the regulatory requirement.

44. The apparatus of claim 42, wherein the programmable circuitry is to:
determine at least one of an accuracy of the data, a completeness of the data, a consistency of the data, a currency of the data, a redundancy of the data in the edge environment, a timeliness of the data, or a validity of the data; and
execute the machine learning model to determine the second value of the data quality of the data based on at least one of the accuracy, the completeness, the consistency, the currency, the redundancy, the timeliness, or the validity.

45. The apparatus of claim 42, wherein the programmable circuitry is to, in response to a determination that the first value and the second value do not satisfy a threshold, tag the data for a green data management operation to effectuate the green data management, the green data management operation including at least one of a discard of one or more portions of the data or a replacement of the one or more portions of the data with a symbolic representation to reduce the resource requirements associated with the one or more portions of the data.

46. The apparatus of claim 42, wherein the node is a first node, and the programmable circuitry is to:
determine a first resource utilization of the first node; and
in response to a determination that the first resource utilization satisfies a threshold, reduce the first resource utilization of the node through at least one of a reduction in ingesting new data or a rerouting of processing the new data to a second node with a second resource utilization less than the first resource utilization.

47. The apparatus of claim 42, wherein the node is a first node, and the programmable circuitry is to, in response to a determination that a resource utilization of a second node does not satisfy a threshold, identify the second node to be transitioned to a reduced power state to effectuate the green data management.

48. The apparatus of claim 42, wherein the programmable circuitry is to:
determine an intent of a policy to reduce environment impact, the intent associated with a threshold value of environment impact;
determine a value of environment impact associated with the operation; and
in response to determining that the value satisfies the threshold value, select the operation to be performed at the node.

49. A non-transitory computer readable medium comprising instructions to cause programmable circuitry to:
orchestrate resources in an edge environment based on data ingested from a data source;
process the data with a machine learning model to generate outputs, the outputs including at least one of a first value representative of data criticality or a second value representative of data quality of the data;
reduce resource requirements associated with the resources of the edge environment to effectuate green data management based on the outputs; and
cause an operation at a node of the edge environment based on at least one of the data or the outputs, the node associated with the data.

50. The computer readable medium of claim 49, wherein the instructions cause the programmable circuitry to:
determine at least one of a potential consequence if the data is not processed or stored, a latency requirement associated with the data, a number of nodes in the edge environment that are associated with the data, a purpose of a workload associated with the data, a size of the workload, a priority of the data, or a regulatory requirement associated with the data; and
execute the machine learning model to determine the first value of the data criticality of the data based on the at least one of the potential consequence, the latency requirement, the number of nodes, the purpose, the priority, or the regulatory requirement.

51. The computer readable medium of claim 49, wherein the instructions cause the programmable circuitry to:
determine at least one of an accuracy of the data, a completeness of the data, a consistency of the data, a currency of the data, a redundancy of the data in the edge environment, a timeliness of the data, or a validity of the data; and
execute the machine learning model to determine the second value of the data quality of the data based on at least one of the accuracy, the completeness, the consistency, the currency, the redundancy, the timeliness, or the validity.

52. The computer readable medium of claim 49, wherein the instructions cause the programmable circuitry to, in response to a determination that the first value and the second value do not satisfy a threshold, tag the data for a green data management operation to effectuate the green data management, the green data management operation including at least one of a discard of one or more portions of the data or a replacement of the one or more portions of the data with a symbolic representation to reduce the resource requirements associated with the one or more portions of the data.

53. The computer readable medium of claim 49, wherein the node is a first node, and the instructions cause the programmable circuitry to:
determine a first resource utilization of the first node; and
in response to a determination that the first resource utilization satisfies a threshold, reduce the first resource utilization of the node through at least one of a reduction in ingesting new data or a rerouting of processing the new data to a second node with a second resource utilization less than the first resource utilization.

54. The computer readable medium of claim 49, wherein the node is a first node, and the instructions cause the programmable circuitry to, in response to a determination that a resource utilization of a second node does not satisfy a threshold, identify the second node to be transitioned to a reduced power state to effectuate the green data management.

55. The computer readable medium of claim 49, wherein the instructions cause the programmable circuitry to:
determine an intent of a policy to reduce environment impact, the intent associated with a threshold value of environment impact;
determine a value of environment impact associated with the operation; and
in response to determining that the value satisfies the threshold value, select the operation to be performed at the node.

56. A method for data collection balancing, the method comprising:
orchestrating, by executing an instruction with programmable circuitry, resources in an edge environment based on data ingested from a data source;
executing, with the programmable circuitry, a machine learning model based on the data to generate outputs, the outputs including at least one of a first value representative of data criticality or a second value representative of data quality of the data;
reducing, by executing an instruction with the programmable circuitry, resource requirements associated with the resources of the edge environment to effectuate green data management based on the outputs; and
causing, by executing an instruction with the programmable circuitry, an operation at a node of the edge environment based on at least one of the data or the outputs, the node associated with the data.

57. The method of claim 56, further including:
determining at least one of a potential consequence if the data is not processed or stored, a latency requirement associated with the data, a number of nodes in the edge environment that are associated with the data, a purpose of a workload associated with the data, a size of the workload, a priority of the data, or a regulatory requirement associated with the data; and
executing the machine learning model to determine the first value of the data criticality of the data based on the at least one of the potential consequence, the latency requirement, the number of nodes, the purpose, the priority, or the regulatory requirement.

58. The method of claim 56, further including:
determining at least one of an accuracy of the data, a completeness of the data, a consistency of the data, a currency of the data, a redundancy of the data in the edge environment, a timeliness of the data, or a validity of the data; and
executing the machine learning model to determine the second value of the data quality of the data based on at least one of the accuracy, the completeness, the consistency, the currency, the redundancy, the timeliness, or the validity.

59. The method of claim 56, further including, in response to a determination that the first value and the second value do not satisfy a threshold, tagging the data for a green data management operation to effectuate the green data management, the green data management operation including at least one of a discard of one or more portions of the data or a replacement of the one or more portions of the data with a symbolic representation to reduce the resource requirements associated with the one or more portions of the data.

60. The method of claim 56, wherein the node is a first node, and the method further including:
determining a first resource utilization of the first node; and
in response to a determination that the first resource utilization satisfies a threshold, reducing the first resource utilization of the node through at least one of a reduction in ingesting new data or a rerouting of processing the new data to a second node with a second resource utilization less than the first resource utilization.

61. The method of claim 56, wherein the node is a first node, and the method further including, in response to a determination that a resource utilization of a second node does not satisfy a threshold, identifying the second node to be transitioned to a reduced power state to effectuate the green data management.
